(19) United States
(12) Patent Application Publication
(10) Pub. No.: US 2024/0235984 A1
(43) Pub. Date: Jul. 11, 2024

(54) TRAFFIC ENGINEERING IN FABRIC TOPOLOGIES WITH DETERMINISTIC SERVICES

(71) Applicant: Intel Corporation, Santa Clara, CA (US)

(72) Inventor: Uma S. CHUNDURI, Fremont, CA (US)

(21) Appl. No.: 18/562,694

(22) PCT Filed: Oct. 21, 2022
(86) PCT No.: PCT/US2022/047495

§ 371 Date: Nov. 20, 2023

Related U.S. Application Data
(60) Provisional application No. 63/270,801, filed on Oct. 22, 2021.

(51) Int. Cl. H04L 45/12; H04L 45/00; H04L 45/02

(52) U.S. Cl. CPC H04L 45/124; H04L 45/02; H04L 45/22

(57) ABSTRACT

The present disclosure is generally related to edge computing, cloud computing, data centers, network communication, network topologies, traffic engineering, data packet routing techniques, switch fabric technologies, and communication system implementations, and in particular, to preferred path routing techniques and traffic engineering in fabric switch topologies with deterministic services.

### RELATED APPLICATIONS

The present disclosure claims priority to U.S. Provisional App. No. 63/270,801 filed on Oct. 22, 2021, the contents of which is hereby incorporated by reference in its entirety.

### TECHNICAL FIELD

The present disclosure is generally related to edge computing, cloud computing, data centers, network communication, network topologies, traffic engineering, data packet and/or network routing techniques, switch fabric technologies, communication system implementations, and in particular, to the preferred path routing (PPR) framework and traffic engineering in fabric topologies with deterministic services.

### BACKGROUND

Packet routing (or simply “routing”) is a fundamental concept in packet networks, which involves selecting a network path for traffic (e.g., a set of data packets) in a network or across multiple networks. In packet switching networks, routing involves higher-level decision making that directs network packets from a source node toward a destination node through a set of intermediate nodes.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an example cellular transport network. FIG. 2 depicts an example Interior Gateway Protocol (IGP) Network. FIG. 3 depicts a network with Loose Path.

FIG. 4 depicts services along the Preferred Path. FIG. 5 depicts an example network with a graph structure PPR TREE. FIG. 6 depicts an example Multi-Domain Network with PPR. FIG. 7 depicts an example network topology.

FIG. 8 depicts a 3-stage CLOS fabric as a cellular and/or edge fabric. FIG. 9 depicts an Srv6 based pinned TE path in the CLOS Fabric. FIG. 10 depicts a PPR based pinned TE path in the CLOS Fabric. FIG. 11 depicts a TE aware Edge CLOS Fabric.

FIG. 12 depicts an example network topology. FIG. 13 depicts an example PPR-PDE Sub-Type Length Value (TLV) format. FIGS. 14 and 15 depict example PPR-PDE Flags Format. FIG. 16 depicts an example PDE format. FIG. 17 depicts an PPR-PDE processing process. FIG. 18 depicts a CLOS fabric with TE paths with link and node protecting alternatives. FIG. 19 shows an example of a 3-stage clos network. FIG. 20 depicts an example of adding an nth connection.

FIG. 21 illustrates an example edge computing environment. FIG. 22 illustrates an example network architecture. FIG. 23 illustrates an example software distribution platform. FIG. 24 depict example components of various compute nodes, which may be used in edge computing system(s).

### DETAILED DESCRIPTION

The present disclosure generally relates to edge computing technologies, cloud computing technologies, data centers and data center networks, network communication, network topologies, traffic engineering, data packet routing techniques, switch fabric technologies, and communication system implementations, and in particular, to the preferred path routing (PPR) framework and traffic engineering in fabric topologies with deterministic services.

Preferred Path Routing (PPR) is an extensible method of providing path based dynamic routing for a number of packet types including Internet Protocol version 4 (IPv4), Internet Protocol version 6 (IPv6), and Multi-Protocol Label Switching (MPLS). PPR uses a simple encapsulation to add the path identity to the packet. PPR can also be used to mitigate the Maximum Transferable Unit (MTU) and data plane processing issues that may result from Segment Routing (SR) packet overhead; and also supports further extensions along the paths

Conventional routing protocols commonly use Shortest Path routing algorithms in order to determine how to route packets. Here, a metric is used to determine the “shortest” (or least-cost) path towards any given destination, which nodes along the path then base their forwarding decisions on in order to route packets to their destination. While highly robust and sufficient for most uses, there can be circumstances under which network operators want to exert greater control over the path that is actually taken by packets. For example, a network operator might want to route packets not based on which path is of the least cost but which path offers the least possibility of loss, that provides the shortest delay, or that avoids a certain geography.

Those are some of the considerations that led to the introduction of Segment Routing (SR) (see e.g., Filsfils et al., “The Segment Routing Architecture”, 2015 IEEE Global Communications Conference (GLOBECOM 2015), San Diego, CA, USA, pp. I-6 (Dec. 2015) (“[1]”)), which is a routing technology that is currently being standardized by the Internet Engineering Task Force (IETF) and that leverages the concept of source routing. Contrary to conventional routing protocols, SR allows a controller to compute the path that a packet should take, decomposing the path into a sequence of network segments along which packets are to be routed, with each segment identifier (SID) referring to a segment node that terminates the particular segment. The sequence is carried within the packet itself, encoding SIDs as labels, depending on data plane using either MPLS label or IPv6 address format (see e.g., [RFC8660] and [RFC8754]). The packet's path is accordingly represented by a stack of labels that identify a sequence of segment nodes/links (Adjacency SID). Each node in the network then forwards the packet to the next segment node, as identified by the top label on the stack. When receiving the packet, the segment node pop its SID off the stack and forwards the packet on to the next segment. The fact that SR leverages existing MPLS technology facilitates deployment and migration because existing infrastructure can be reused. At the same time, SR promises to reap many of the benefits promised by SDN such as, for example, the ability to deploy optimized routing algorithms that can be programmed using conceptually centralized controllers.

SR reintroduces source routing to networking. While SR has been defined for MPLS and IPv6 data planes, there are considerable problems with respect to increased path overhead in various deployments. One problem that SR shares with other source routing technologies is that paths are encoded within the packet. In SR, paths are encoded as a series of labels or IPv6 addresses that express the sequence of SIDs that need to be traversed. This introduces processing and network/signaling overhead (referred to herein as a “network layer tax”) for each packet which grows with path length, as additional octets need to be carried in each packet for each added segment. For many applications, this overhead is negligible, however, it can lead to problems in cases where bandwidth comes at a premium, specifically in cases where the overhead of the packet is high relative to the packet's payload. It can also lead to problems in cases that are highly sensitive to service level parameters such as delay due to the additional time needed to send and receive longer packets. This makes SR detrimental to deployment for many future applications and services, such as augmented reality (AR) or virtual reality (VR) gaming, autonomous robotics and/or autonomous vehicles, tactile applications, industrial Internet and/or industrial IoT, and/or other applications and/or services.

The present disclosure discusses a new framework that is designed to overcome the challenges and shortcomings of SR. Specifically, the present disclosure discusses a new routing paradigm referred to as preferred path routing (PPR). PPR is an enabler for next generation source routing by minimizing the data plane overhead caused in SR-based systems/networks, which includes the network layer tax and processing overhead that is imposed on packets, critical specifically for small packets that are characteristic to many 5G applications. PPR extends SR for IP data planes without needing to replace existing hardware or even to upgrade the data plane. In addition, PPR allows dynamic path QoS reservations based on, for example, bandwidth, resources for providing deterministic queuing latency, and/or other QoS relevant metrics/measurements.

PPR uses the concept of labels that can be computed by a controller (e.g., a path manager or the like), which are inserted into packets to guide their forwarding by nodes. However, unlike SR, the labels refer not to SIDs of segments of which the path is composed, but to an identifier (ID) of a path that is deployed on network nodes. In some examples, the PPR labels computed by the controller are path IDs with associated path description elements (PDEs).

In some implementations, the path management function that computes the PPR labels is a network function in a cellular core network; a distributed unit (DU), centralized unit (CU), and/or other radio access network (RAN) function of a RAN; an edge application and/or a platform manager of an edge compute node; an edge orchestrator of an edge computing network; a cloud orchestrator or cloud compute cluster of a cloud computing service; a software defined networking (SDN) controller; and/or some other like controller, entity, or element. Additionally or alternatively, multiple path management functions that compute the PPR labels can be placed at multiple (hierarchical) levels throughout a network. For example, a first path management function can be placed at or within a RAN to manage PPE for multiple CUs, DUs, and/or radio units (RUs) in a next generation (NG)—RAN split architecture; a second path management function can be placed or implemented at an interworking (e.g., inter-domain) gateway that manages PPR functionality between two or more networks; and/or a third path management function can be placed and/or implemented at a global level to manage PPR functionality at a global level. Management of PPR functionality at a global level can involve managing other path management functions placed at other levels in one or more networks or directly managing the PPR functionality of all nodes in one or more networks.

The fact that paths and path IDs can be computed and controlled by a controller, not a routing protocol, allows the deployment of any path that network operators prefer, not necessarily shortest paths. Like SR, PPR avoids problems with conventional routing protocols. However, because packets refer to a path towards a given destination and nodes make their forwarding decision based on the path ID of a path, not the SID of a next segment node, it is no longer necessary to carry a sequence of labels that introduce extensive overhead. As a result, PPR is much better suited for future networking applications such as the ones mentioned herein. Like SR, PPR can be used in conjunction with different data planes such as, for example, IPv6 (e.g., “PPRv6”), MPLS (e.g., “PPR-MPLS”), and the like.

Example implementations specify various conditions or inequalities to enhance the folded Clos fabric to be shared with deterministic traffic. Some example implementations provide methodologies to achieve deterministic Clos fabric with SRv6 data plane. Some example implementations provide methodologies to achieve deterministic Clos fabric with PPR based routing control plane. The aforementioned implementations build on IGP based distributed routing and centralized controller technologies in mixed mode paradigm in the Clos fabrics to serve high value traffic alongside best effort traffic.

Additionally or alternatively, some example implementations provide mechanisms to advertise one or more set PDEs of a preferred path in a primary path advertisement. In these implementations, a first PDE in a list of PDEs is indicated using a first flag or bit in a path advertisement message; one or more second PDEs in the list of PDEs are indicated using a second flag or bit; and one or more third PDEs in the list of PDEs are indicated using a third flag or bit. In some examples, the first flag/bit is a set flag (S bit), and the first PDE is a set PDE or a current PDE. Additionally or alternatively, the second bit/flag is a link protecting (LP) bit/flag, and the one or more second PDEs are subsequent PDEs (e.g., subsequent to the first (set) PDE and/or NP PDEs discussed infra) that are link protecting alternate paths to the next element(s) in the path description. In these implementations, a procedure to install efficient and traffic engineering (TE)-aware link protecting path is used to implement the LP alternate paths. Additionally or alternatively, the third bit/flag is a node protecting (NP) bit/flag, and the one or more third PDEs are subsequent PDEs (e.g., subsequent to the first (set) PDE and/or the LP PDEs) that are node protecting alternate paths to the next element(s) in the path description. In these implementations, a procedure to install efficient and TE aware node protecting path is used to implement the NP alternate paths. In some implementations, the procedure(s) to install the TE-aware LP and/or NP path alternatives are carried by the PDE TLV/packet itself. Additionally or alternatively any of the aforementioned mechanisms can be implemented by individual network nodes and/or the aforementioned path management functions.

Some implementations involve TE in edge computing networks/topologies with deterministic services. In some implementations, edge computing network(s) is/are implemented as a single domain but is/are configured to handle data from multiple domains. For example, some edge compute deployment underlays are predominantly IP based. If IGP based underlay control plane is in use, PPR can provide the required flexibility for creating TE paths, where native IP data planes are used. PPR can help operators to mitigate the congestion in the underlay and path related services for critical servers in the edge networks dynamically.

In some implementations, the path information (e.g., the aforementioned PDEs, and the like) carried in the TLVs/packets can include security information and/or topology information. For example, the security information informs each node/hop in the network about the security protocols and/or policies to be applied before forwarding the packet to a next hop/node, as well as other relevant security (e.g., public keys, digital certificate, and/or the like) information or references to such information. Additionally or alternatively, the topology information informs the node on how the packet should be routed toward a destination node. Here, the topology information may include the PDEs discussed previously. These and other aspects are discussed infra.

### 1. Routing Aspects

### 1.1. Shortest-Path Routing

Much of today's packet routing techniques are based on the concept of Shortest Path Routing (SPF), which attempts to route packets along a path that is the “shortest” or of the least cost. The SPF algorithm and SPF variations/modifications are widely deployed with link state protocols or IGPs (see e.g., Moy, OSPF Version 2, IETF RFC 2328 (Apr. 1998) (“[OSPFv2]”), Information technology Telecommunications and information exchange between systems Intermediate System to Intermediate System intra-domain routing information exchange protocol for use in conjunction with the protocol for providing the connectionless-mode networkservice (ISO 8473), ISO/IEC 10589:2002, Ed. 2, (Nov. 2002) (“[IS-IS]”), and Coltun et al., OSPFfor IPv6, IETF RFC 5340 (Jul. 2008) (“[OSPFv3]”), the contents of each of which are hereby incorporated by reference in their entireties). In IGPs, a directed graph is computed with flooded link state information (LSA/LSP DB) with links having configured weights/metrics. SPF Algorithm calculates a tree of shortest path from self to all other nodes in the network with candidate list of nodes kept sorted by weight. Shortest (best) value in the candidate and downloaded to the routing table with the computed immediate Next-Hop (NH). IP routing tables only need NH to each advertised prefix from all the nodes while LSA/LSP trees have all the paths.

One drawback of shortest-path routing is that it is not always the shortest path that may be preferred, as there may be different cost metrics and other considerations such as, for example, load balancing, ease of failover service levels, or robustness of path). As a result, other technology has begun to appear that allows to route on paths other than shortest paths. One such technology is Segment Routing (see clause 4.3 of ETSI GR NGP 014 V1.1.1 (2019-10) (“[NGP014]”), the contents of which is hereby incorporated by reference in its entirety).

### 1.2. Segment Routing

Segment Routing (SR) is a source routing approach, which enables packet steering with a specified path in the packet itself. SR leverages the source routing paradigm, where a node steers a packet through an ordered list of instructions, called “segments”. A segment can represent any instruction, topological or service based. A segment can have a semantic local to an SR node or global within an SR domain. SR provides a mechanism that allows a flow to be restricted to a specific topological path, while maintaining per-flow state only at the ingress node(s) to the SR domain (see e.g., Filsfils et al., Segment Routing Architecture, IETF RFC 8402 (Jul. 2018) (“[RFC8402]”), the contents of which is hereby incorporated by reference in its entirety). Additionally, entropy labels (ELs) can also be used to improve load-balancing (see e.g., Kini et al., Entory Label for Source Packet Routing in Networking (SPRING) Tunnels, IETF RFC 8662 (Dec. 2019) (“[RFC8662]”), the contents of which is hereby incorporated by reference in its entirety).

SR is defined for Multi-Protocol Label Switching (MPLS) with a set of stacked labels, and for IPv6 where a path is described as list of IPv6 addresses in an SRHeader.

Data planes called Segment Routing with MPLS data plane (SR-MPLS) (see e.g., Bashandy et al., “Segment Routing with MPLS data plane”, IETF draft-ietf-spring-segment-routing-mpls-13 (Apr. 2018)) and Segment Routing with IPv6 (SRv6) data plane with SRH (see e.g., Previdi et al., IPv6 Segment Routing Header (SRH), IETF draft-ietf-6man-segment-routing-header-12 (Apr. 2018) and Filsfils et al., IPv6 Segment Routing Header (SRH), IETF RFC 8754 (Mar. 2020) (“[RFC8754]”), the contents of each of which are hereby incorporated by reference in their entireties) are defined for MPLS and SR, respectively.

SR simplifies the MPLS control plane by distributing Segment Identifiers (SIDs) for routing prefixes, which are constitute MPLS global labels into Interior Gateway Protocols. This allows source routing to be achieved by representing the network path with stacked SIDs on the data packet without any changes to the MPLS data plane. In addition to MPLS, as specified above, SR also introduces an IPv6 Extension Header (EH) for use with the IPv6 data plane, resulting in SRv6. In SRv6, a segment is encoded as an IPv6 address, with a new type of IPv6 Routing Header (EH) called SRH. A set of segments is encoded as an ordered list of IPv6 addresses in SRH to represent the path of the data packet.

Segments and source routes can be computed by a controller with knowledge of the network topology and subsequently provision the network with end-to-end (e2e) SR paths. A controller could include e.g., a Path Computation Element (PCE) or another type of SDN controller. Using a controller allows to perform different optimization and customizations to paths that take into account different constraints. This also obviates the need for traditional MPLS control plane protocols like LDP and RSVP, reducing the number of protocols that need to be deployed in a network. However there are some issues/drawbacks with SR:
(1) The additional path overhead with complete path using SIDS on the data packet in various SR deployments may cause the following issues: HW Capabilities (not all nodes in the path can support the ability to push or read label stack needed Maximum SID Depth (MSD) to satisfy user/operator requirements; alternate paths which meet these user/operator requirements may not be available); Line Rate (potential performance issues in deployments, which use SRH data plane with the increased size of the SRH with 16 byte SIDs); MTU (larger SID stacks on the data packet can cause potential MTU/fragmentation issues); and Header Tax (some deployments, such as 5G, require minimal packet overhead in order to conserve network resources. Carrying 40 or 50 octets of data in a packet with hundreds of octet of header would be an unacceptable use of available bandwidth).
(2) Another limitation of SR concerns the fact that while it allows a data packet to steer through a custom path, by itself it cannot guarantee that proper QoS along the path needed. The ability to manage resource reservations or to provide traffic engineering attributes are not in SR's scope.
(3) A more subtle issue concerns the ability to conduct performance measurements and collect traffic accounting statistics using SR-MPLS. Because labels on data packets refer only to individual path segments, attributing statistics of any particular packet to a path or flow is inhibited and difficult to perform efficiently.
(4) SR cannot be applied to native IPv4/IPv6 data planes. While SR can be supported with MPLS without any changes in the data plane, use with IPv6 requires an SRH extension header, whose support requires hardware upgrades across the network. While SR is considered as a potential alternative for backhaul transport networks (like 5G), non-support for native IP data planes imposes a significant hurdle on SR adoption, as many cellular networks around the world still use native IPv4 and IPv6 data planes. As path steering capability is an essential component for network slicing in 5G backhaul transport, lack of this capability forces operators to upgrade the hardware for SRH support.
(5) Last but not least SR also defines complex FRR approach with Topology Independent LFA (TI-LFA). Here, the post convergent backup path does not reflect the original SR path QoS characteristics. This is because alternative path is computed in a distributed fashion by the network nodes using LFA/RLFA algorithms which can only give a loop free shortest path to the destination.

### 1.3. Preferred Path Routing (Ppr) Concepts and Architectures

PPR is a source routing paradigm where a prefix is signaled in a routing domain (control plane) along with a data plane identifier as well as path description on how the packets has to be forwarded when actual data traffic with the data plane identifier is seen. This builds on existing IGPs and fits well with SDN paradigm as the needed path can be crafted dynamically based on various inputs from a central entity.

Traditionally routing in network is based on shortest path computations (through Interior Gateway Protocols or IGPs (see e.g., [OSPFv2], [OSPFv3], [IS-IS])) for all prefixes in the network. As explained, Segment Routing allows to compute custom paths (other than shortest paths) that are subsequently represented by a sequence of segment identifiers in a packet, leading to another set of problems.

Preferred Path Routing (PPR) enables route computation based on a specific path described along with the prefix as opposed to shortest path towards the prefix. The key change that is required concerns how the next hop is computed for the prefix. Instead of using the next hop of the shortest path towards the destination, the next hop towards the next node in the path description is used. PPR is a novel architecture to signal explicit path and per-hop processing requirement and optionally including QoS or resources to be reserved along the path.

PPR is concerned with the creation of a routing path as specified in the PPR-Path which is advertised in IGPs along with a data plane (path) identifier (PPR-ID). The PPR-ID enables data plane extensibility as the type of the data plane. With this, any packet destined to the PPR-ID would use the PPR-Path instead of the IGP computed shortest path to the destination indicated by the PPR-ID. In other words, packets destined to the PPR-ID may use the PPR-Path instead of the IGP computed shortest path. This works as follows: IGP nodes process the PPR-Path. If an IGP node finds itself in the PPR-Path, it sets the next-hop towards the PPR-ID according to the PPR-Path.

Ingress nodes (or head-nodes) may be configured to receive TE or explicit source routed path information from a central entity (e.g., a Path Computation Element (PCE) or Controller). The received path comprises PPR information. A PPR is identified using a PPR-ID, which can also relate to sources that are attached to a head-node: traffic from those sources may have to use a specific PPR-ID. It is also possible to have a PPR provisioned locally for non-TE needs (e.g., for purposes of Fast ReRoute (FRR) and/or to chain services). The PPR path information is encoded as an ordered list of PPR-PDEs from a source to a destination node in the network. The PPR-PDE information represents both topological and non-topological segments and specifies the actual path towards a Forwarding Equivalence Class (FEC) or Prefix by an egress or a head-end node. Additional PPR aspects are discussed in [NGP014].

Once the path and PPR-ID are signaled in an underlying IGP as a PPR, only nodes that find themselves in the path description have to act on this path. For example, after completing its shortest path computation as usual, a node finds that its node information is encoded as PPR-PDE in the path. As a result, this node adds an entry to its Routing Information Base (RIB) and/or Forwarding Information Base (FIB) with the PPR-ID as the incoming label (assuming the data plane type in PPR TLV is MPLS) and sets the NH as the shortest path NH towards the next PPR-PDE (node). If instead, that node had added a shortest path route entry in the FIB for a destination node, it would have added it by setting NH as link towards a node with a shortest path metric to reach the destination node. This process continues on every node as represented in the PPR path description.

There are two variants according to which paths can be specified: loose and strict. In case of a strict path, every node along the path is defined and aware of the PPR-ID. This means that the PPR-ID itself is sufficient for forwarding decisions and is the only label that needs to be carried. In case of a loose path, some nodes along the path are specified and aware of the PPR-ID. In that case, there are intermediate path segments on which nodes are not aware of the PPR-ID; forwarding decisions are then based on the next node on the path that can be reached. In this case, the Segment ID defining the next node on the path is added to the packet (in addition to the PPR-ID), which is popped as the next node on the path is reached.

The path type (loose or strict) is explicitly indicated in the PPR-ID description. A node acts on this flag, and in the case of a loose path, the node programs the local hardware with two labels/SIDs, using PPR-ID as a bottom label and node SID as a top label. Intermediate nodes do not need to be aware of PPR and the fact that data packets are being transported along a PPR path. Intermediate nodes just forward the packet based on the top label. However, if the path described were a strict path, in an MPLS data plane the actual data packet would require only a single label (e.g., PPR-ID 100).

Some of the services can be encoded as non-topologicalPDEs and can be part of the overall path. These services would be applied at the respective nodes along the path. For SR-MPLS and SRv6 data planes, these are simply SIDs. When the data packet with PPR-ID 100 is delivered to node-1, the packet is delivered with context-1. Similarly on node-x, service-xi is applied and function-xi is executed. These service and functions are pre-provisioned on the particular nodes and can be advertised in IGPs. These should be known to the central entity/controller along with Link State Database of IGP that is used in the underlying network.

This gives the basic and light weight service chaining capability with PPR without incurring any additional overhead on the data packet. However this is limited to fixed functions/services for a particular path and all data packets using the path will be applied with these services. Flow levels exclusions using the same path or differentiated services that need to be applied with in a flow cannot be supported with this mechanism and one has to resort to full-blown NSH/SFC [RFC8300] data plane for the same.

One advantage of PPR is the ability to provide source routing and path steering capabilities to legacy IP networks without having to change hardware or even upgrade the data planes. The PPR-ID enables data plane extensibility as the type of the data plane.

PPR is also fully backward compatible with SR as PDEs can be extensible and particular data plane identifiers can be expressed to describe the path and in SR case PDEs can contain the SR SIDs (topological like nodal and adjacency SIDs or non-topological SR SIDs). One benefit PPR offers for SR data planes (e.g., SR-MPLS, SRv6) is providing the same benefits (e.g., of source routing based on a predefined path) with an optimized data plane with at most one or two labels on the packet for strict and loose cases respectively (as specified in clause 5.3 of [NGP014]).

In addition to determining the nodes to traverse, there may be other aspects that need to be set up for a path. Most notably, this concerns the allocation and reservation of resources along the path in order to help ensure the service levels, the Quality of Service that is delivered across the path, will be acceptable for the traffic routed across the path.

Resource Reservation Protocol (RSVP) (see e.g., Adams, The Simple Public-Key GSS-API Mechanism (SPKM), IETF RFC 2025 (Oct. 1996)) allows out of band signaling along a specified path for resource reservations. This is done by sending PATH/RESV message with flow spec/filter spec. Awduche et al., “RSVP-TE: Extensions to RSVP for LSP Tunnels”, IETF RFC 3209 (Dec. 2001), builds on RSVP protocol and defines new objects, modifies existing objects for MPLS LSP establishment. This is not considered as dynamic and requires provisioning along the path with out of band signaling. Also it relies on periodic refreshes for state synchronization between neighbors.

SR enables packet steering with a specified path in the packet itself. This is defined for MPLS (with stacked labels) and IPv6 (path described as list of IPv6 addresses in SRHeader) data planes. Generally a controller computes the path and installs the same at ingress nodes with path description and as per local policy data flows are mapped to these paths. While this allows packet steering on a specified path, it does not have any notion of QoS or resources reserved along the path. The determination of which resources to allocate and reserve on nodes across the path, like the determination of the path itself, can in many cases be made by a controller. Accordingly, PPR includes extensions that allow to manage those reservations, in addition to the path itself.

The resources to be reserved along the preferred path can be specified through path attributes TLVs. Reservations are expressed in terms of required resources (bandwidth), traffic characteristics (burst size), and service level parameters (expected maximum latency at each hop) based on the capabilities of each node and link along the path. The second part of the solution is providing mechanism to indicate the status of the reservations requested, for example, if these have been honored by individual node/links in the path. This is done by defining a new TLV/Sub-TLV in respective IGPS. Another aspect is additional node level TLVs and extensions to Previdi et al., IS-IS Traffic Engineering (TE) Metric Extensions, IETF RFC 7810 (May 2016) (“[RFC7810]”), Ginsberg et al., IS-IS Traffic Engineering (TE) Metric Extensions, IETF RFC 8570 (Mar. 2019) (“[RFC8570]”), and Giacalone et al., OSPF Traffic Engineering (TE) MetricExtensions, IETF RFC 7471 (Mar. 2015) (“[RFC7471]”), the contents of each of which are hereby incorporated by reference in their entireties, to provide accounting/usage statistics that have to be maintained at each node per preferred path. All the above is specified for [IS-IS], [OSPFv2], and [OSPFv3] protocols.

In the following discussion, section 2 provides a brief overview of the PPR framework, section 3 discusses various techniques for creating deterministic network (e.g., cellular, edge, cloud, and/or other networks) fabrics using Interior Gateway Protocols (IGPs) and controller frameworks, and section 4 discusses techniques for building deterministic alternate paths for TE'd pinned paths.

### 2. Preferred Path Routing Framework

Capacity demands, traffic engineering (TE), and determinism are some of the key requirements for various cellular, edge and industrial deployments. These deployments span from many underlying data pane technologies including native IPv4, native IPv6 along with MPLS and Segment Routing (SR). The present disclosure provides a framework for Preferred Path Routing (PPR). PPR is a method of providing path based dynamic routing for a number of packet types including IPv4, IPv6, MPLS, among many others such as any of those discussed herein. This seamlessly works with a controller plane (e.g., including path management function(s) and/or other like elements), which holds both complete network view and operator policies while providing self-healing benefits in a distributed fashion in near-real time.

PPR uses a relatively simple encapsulation techniques and/or uses existing encapsulation mechanisms to add a path identity to individual packets. This reduces the per packet overhead required for path steering when compared to SR, and therefore, has a smaller impact on packet MTU and data plane processing, and provides an overall goodput for small payload packets. A number of extensions that allow expansion of use beyond simple point-to-point-paths is also are described herein.

### 2.1. Introduction

With the deployments of more advanced services, such as 5G and beyond, the need for Traffic Engineering (TE) with deterministic services become more important, especially in edge networks where stringent requirements must be met in terms of latency, throughput, packet loss, and packet error rate. Traffic steering provides a base to build some of these capabilities to serve various radio access network (e.g., cellular), edge computing, and vertical industries. Additionally, diverse data planes are used in various deployments and parts of the network, including Ethernet, MPLS, and native IP (e.g., IPv4, IPv6) can use some or all of these capabilities.

The present disclosure provides a framework for Preferred Path Routing (PPR). PPR is a method of adding explicit paths to a network using link-state routing protocols. Such a path, which may be a strict or loose and can be any loop-free path between two points in the network. A node makes an on-path check to determine if it is on the path, and, if so, adds a Forwarding Information Base (FIB) entry with NextHop (NH) (computed from the Shortest Path First (SPF) tree) set to the next element in the path description.

The Preferred Path Route Identifier (PPR-ID) in the packet is used to map the packet to the PPR path, and hence to identify resources and the NH. In other word, PPR-ID is the path identity to the packet and routing and forwarding happens based on this identifier while providing various services to all the flows mapped to the path.

As described herein, PPR is forwarding plane agnostic, and may be used with any packet technology in which the packet carries an identifier that is unique within the PPR domain. PPR may hence be used to add explicit path and resource mapping functionality with inherent traffic engineering (TE) properties in IPv4, IPv6, MPLS, Ethernet, and/or other networks, access technologies, and/or protocols. PPR also has a smaller impact on both packet MTU and data plane processing. PPR uses an IGP control plane based approach for dynamic path steering.

### 2.1.1. Relation to Segment Routing

Segment Routing (SR) (see e.g., [RFC8402]) enables packet steering by including set of Segment Identifiers (SIDs) in the packet that the packet must traverse or be processed by. In an MPLS network this is done by mapping the SIDs to MPLS labels and then pushing the required labels on the packet (see e.g., Bashandy et al., Segment Routing with MPLS data plane, IETF RFC 8660 (Dec. 2019) (“[RFC8660]”), the contents of which is hereby incorporated by reference in its entirety. In SRv6 (see e.g., [RFC8754]), defines a segment routing extension header (SRH) (also referred to as “Segment Routing Header” or “IPv6 routing Extension header”) to be carried in the packet which contains a list of the segments. The usefulness of PPR with SR and inter-working scenarios are described in Section 2.3.1.2 and Section 2.3.1.3.

SR also defines Binding SIDs (BSIDs) [RFC8402], which are SIDs pre-positioned in the network to either allow the number of SIDs in the packet to be reduced, or provide a method of translating from an edge imposed SID to a SID that the network prefers. One use of BSIDs is to define a path by associating an out-bound SID on every node along the path in which case the packet can be steered by swapping the incoming active SID on the packet with a BSID. For both SR-MPLS and SRv6, PPR can reduce the number of touch points needed with BSIDs by dynamically signaling the path and associating the path with an abstract data plane identifier.

With PPR as a data packet carries a PPR-ID Section 2.3.1 instead of individual SIDs, it avoids exposing the path; thus it avoids revealing topology, traffic flow and service usage, if a packet is snooped. This is described as “Topology Disclosure” security consideration in [RFC8754].

### 2.2. Applicability and Key Use Cases

### 2.2.1. Xhaul Transport

Cellular networks predominantly use both IP and MPLS data planes in the transport part of the network. For the cellular transport to evolve for 5G (and beyond), certain underlay network requirements should be met (e.g., for slices other than enhanced Mobile Broadband (eMBB)). PPR is a mechanism to achieve this as it provides dynamic path based routing and traffic steering for any underlying data plane (e.g., IPv4, IPv6, and/or MPLS) used, without any additional control plane protocol in the network. PPR acts as an underlay mechanism in cellular XHaul (e.g., N3/N9 interfaces) and hence can work with any overlay mechanism including GPRS Tunneling Protocol (GTP).

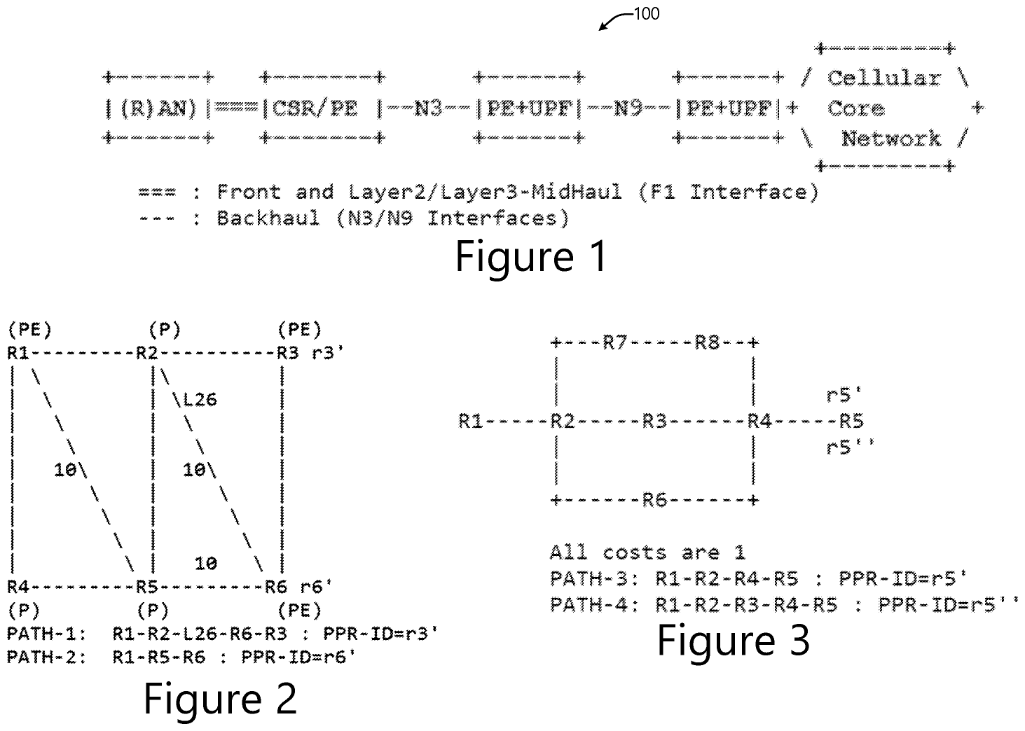

FIG. 1 depicts a high level view of a cellular XHaul network 100. the Xhaul network 100 includes a fronthaul interface between a (radio) access network ((R)AN) and a CSR/provider edge (PE) and midhaul and/or backhaul interfaces communicatively couple the CRS/PE with user plane function (UPF)/PEs and the core network. The (R)AN elements, UPFs, core network elements, and the N3 and N9 interfaces of FIG. 1 are discussed infra with respect to FIG. 22. The fronthaul interface can be a point-to-point link and/or any other access technology such as any of those discussed herein, the midhaul interface(s) can use Layer-2/Layer-3 protocols/access technologies, and the backhaul interface(s) may use an IP and/or MPLS network. For e2e slicing in these deployments, both midhaul and backhaul interfaces have TE as well as underlay QoS capabilities.

In many cellular deployments, connectivity for various 5G nodes on F1, N3 and N9 interfaces, topologies range from sub-tended rings to Leaf-Spine Fabric (LS-Fabric). While there is no limitation with respect to (w.r.t) topologies where PPR is applicable, for some of these deployments PPR is more suitable for providing Traffic Engineering for high volume intra LS-Fabric traffic with no path overhead in the underlying data plane. PPR augments the SR-MPLS deployments with low data plane overhead and high reliability with TE aware fast reroute (pLFA) as described in section 2.3.2.2. In the overlay or virtual router environment, PPR provides lightweight service chaining with non-topological PDEs along the preferred path (see e.g., section 2.3.2.2 infra). PPR helps to achieve OAM capabilities at the path granularity without any additional per packet information.

LS-Fabric underlays are predominantly IP (e.g., IPv4 and/or IPv6) based. If IGP or SDN based underlays are in use, PPR can provide the required flexibility for creating TE paths, where native IP data planes are used. PPR can help operators to mitigate the congestion in the underlay for critical servers in the network dynamically. Additionally or alternatively, some edge deployment underlays are predominantly IP (e.g., IPv4 and/or IPv6) based. If IGP based underlay control plane is in use, PPR can provide the required flexibility for creating TE paths, where native IP data planes (e.g., IPv4 and/or IPv6) are used. PPR can help operators to mitigate the congestion in the underlay and path related services for critical servers in the edge networks dynamically.

### 2.2.2. Ppr as Vpn+Underlay and Network Slicing

There is a need to support the requirements of new applications, particularly applications that are associated with 5G services. An approach to supporting these needs is described in Dong et al., A Framework for Enhanced Virtual Private Network (VPN+) Services, IETF draft-ietf-teas-enhanced-vpn-08 (12 Jul. 2021) (“[VPN08]”), the contents of which is hereby incorporated by reference in its entirety. This approach utilizes existing VPN and TE technologies and adds features that specific services require over and above traditional VPNs. The document describes a framework for using existing, modified and potential new networking technologies as components to provide an Enhanced Virtual Private Network (VPN+) service.

Typically, VPN+will be used to form the underpinning of network slicing, but could also be of use in its own right. It is not envisaged that large numbers of VPN+instances will be deployed in a network and, in particular, it is not intended that all VPNs supported by a network will use VPN+techniques.

Such networks potentially need large numbers of paths each with individually allocated resources at each link and node. A segment routing approach has the potential to require large numbers of SIDs in each packet the paths become strict source routed paths through the end to end set of resources needed to create the VPN+paths. By using PPR the number of segments needed in packets is reduced, and the management overhead of installing the large numbers of BSIDs is reduced.

### 2.2.3. Ppr as Frr Solution

PPR may be used in a network as a method of providing fast reroute (FRR), such as IP FRR (IPFRR). This is independent of whether PPR is used in the network for other traffic steering purposes. It can be used to create optimal paths or paths congruent with the post convergence path from the point of local repair (PLR) as is proposed in TI-LFA (see e.g., [rtgwg-segment-routing-ti-lfa]). Unlike TI-LFA PPR may be used in IPv4 networks. This is discussed further in section 2.4 infra. The approach has the further intrinsic advantage that no matter how complex the repair path only a single header (or MPLS label) needs to be pushed onto the packet which may assist routers that find it difficult to push large headers.

### 2.2.4. Replacement for Flex Algo

Flex-Algorithm (see e.g., Psenak et al., IGP Flexible Algorithm, IETF draft-ietf-1sr-flex-algo-17 (6 Jul. 2021) (“[ietf-1sr-flex-algo]”), the contents of which is hereby incorporated by reference in its entirety, is a method that is sometimes used to create paths between Segment Routing (SR) nodes when it is required that packets traverse a path other than the shortest path that the SPF of the underlying IGP would naturally install. There is a limit of 128 algorithms that can be installed in a network. Flex-Algorithm is a cost based approach to creating a path which means that a path or pathlet is indirectly created by manipulating the metrics of the links. These metrics affect all the paths within the scope of the Flex-Algorithm number (instance). The traffic steering properties of Flex-Algorithm required for SR can be achieved directly with PPR with several advantages: o The scope of a PPR path is strictly limited to the sub-path between the SR nodes; o The path can be directly specifies rather than implicitly through metrics; and o Resources (such as specialist queues and/or the like) may be directly mapped to the PPR path and hence to the SR sub-path.

### 2.3. Preferred Path Routing (Ppr)

PPR allows the direction of traffic along an engineered path through the network by replacing the SID label stack or the SID list with a single PPR-ID. The PPR-ID may either be a single label (e.g., MPLS) and/or a native destination prefix (e.g., IPv4 and/or IPv6). This enables the use of a single data plane identifier to describe an entire path.

A PPR path could be an (Segmented Routed) SR path, a traffic engineered path computed based on some constraints, an explicitly provisioned Fast Re-Route (FRR) path or a service chained path. A PPR path can be signaled by any node, computed by a central controller, or manually configured by an operator. PPR extends the source routing and path steering capabilities to native IP (e.g., IPv4 and IPv6) data planes without hardware upgrades (see e.g., section 2.3.1).

In FIG. 2, consider node R1 as an ingress node, or a head-end node, and the node R3 may be an egress node or another head-end node. The numbers shown on links between nodes indicate the bi-directional IGP metric as provisioned (no number indicates a metric of 1). R1 may be configured to receive TE source routed path information from a central entity (e.g., PCE in Vasseur et al., Path Computation Element (PCE) Communication Protocol (PCEP), IETF RFC 5440 (Mar. 2009) (“[RFC5440]”), Netconf in Enns et al., Network Configuration Protocol (NETCONF), IETF RFC 6241 (Jun. 2011) (“[RFC6241]”), the contents of which is hereby incorporated by reference in its entirety) and/or a controller that comprises of PPR information which relates to sources that are attached to R1. It is also possible to have a PPR provisioned locally by the operator for non-TE needs (e.g., FRR or for chaining certain services).

The PPR is encoded as an ordered list of path elements from source to a destination node in the network and is represented with a PPR-ID to represent the path. The path can represent both topological and non-topological elements (for example, links, nodes, queues, priority and processing actions) and specifies the actual path towards the egress node. The shortest path towards R3 from R1 are through the following sequence of nodes: R1-R2-R3 based on the provisioned IGP metrics. The central entity in this example, can define a PPRs from R1 to R3 and R1 to R6 that deviate from the shortest path based on other network characteristic requirements as requested by an application or service. For example, the network characteristics or performance requirements may include bandwidth, jitter, latency, throughput, error rate, and/or the like. In a VPN setup, node RI, R3 and R6 are PE nodes and other nodes are P nodes. User traffic entering at the ingress PE nodes gets encapsulated (e.g., MPLS, GRE, GTP, IP-IN-IP, GUE) and will be delivered to the egress PE.

Consider two paths in the network of FIG. 2. In PATH-1, a first PPR may be identified by PPR-ID=r3′ with the path description R1-R2-L26-R6-R3 for a prefix advertised by R3. This is an example for a strict path with combination of links and nodes. In PATH-2, a second PPR may be identified by PPR-ID=r6′ with the path description R1-R5-R6. This is an example for a loose path. Though this example shows PPRs with node identifiers it is possible to have a PPR with combination of Non-Topological elements along the path.

It should be noted that the “advertisements” discussed herein may be link state advertisements (LSAs) and/or Link State PDUs (LSPs), and/or other advertisement messages/packets. Examples of the LSAs include the LSAs defined in one or more of Psenak et al., OSPFv2 Prefix/LinkAttribute Advertisement, IETF RFC 7684 (Nov. 2015), [OSPFv2], [OSPFv3], Zhang et al., OSPF Two-PartMetric, IETF 8042 (Dec. 2016), Bhatia et al., Security Extension for OSPFv2 When Using Manual Key Management, IETF RFC 7474 (Apr. 2015), Yang et al., Security Extension for OSPFv2 When Using Manual Key Management, IETF RFC 6860 (Jan. 2013), Sheth et al., OSPFH ybrid Broadcast and Point—to-Multipoint Interface Type, IETF RFC 6845 (Jan. 2013), Lindem et al., OSPFv2 Multi—Instance Extensions, IETF RFC 6549 (Mar. 2012), and Bhatia et al., OSPFv2 HMAC-SHA Cryptographic Authentication, IETF RFC 5709 (Oct. 2009) (collectively referred to herein as (“[OSPF]”), the contents of each of which are hereby incorporated by reference in their entireties). Examples of LSPs include the LSPs discussed in [IS-IS], [RFC7471], [RFC7810], [RFC8570], and the like.

The first topological element relative to the beginning of PPR Path descriptor contains the information about the first node in the path that the packet must pass through (e.g., equivalent to the top label in SR-MPLS and the first SID in an SRv6 SRH). The last topological sub-object or PDE contains information about the last node (e.g., in SR-MPLS it is equivalent to the bottom SR label).

Each IGP node receiving a complete path description, determines whether the node is on the advertised PPR path. This is called the PPR on-path check. It then determines whether it is included more than once on that path. This PPR validation prevents the formation of a routing loop. If the path is looped, no further processing of the PPRs is undertaken. (Note that even if it is invalid, the PPR descriptor must still be flooded to preserve the consistency of the underlying routing protocol). If the validation succeeds, the receiving IGP node installs a Forwarding Information dataBase (FIB) entry (and/or a Routing Information dataBase (RIB) entry) for the PPR-ID with the next-hop (NH) required to take the packet to the next topological path element in the path description. Processing of PPRs may be done, at the end of the IGP SPF computation.

Consider PPR path PATH-1 in FIG. 2. When node R5 receives the PPR (PATH-1) information it does not install a FIB entry for PATH-1 because this PPR does not include node R5 in the path description/ordered path list.

However, node R5 determines that the second PPR (PATH-2), does include the node R5 in its path description (the on-path check passes). Therefore, node R5 updates its FIB to include an entry for the destination address that R6 indicates (PPR-ID) along with path description. This allows the forwarding of data packets with the PPR-ID (r6′) to the next element along the path, and hence towards node R6.

To summarize the control plane processing, the receiving IGP node determines if it is on the path by checking the node's topological elements in the path list. If it is, it adds/adjusts the PPR-ID's shortest path NH towards the next topological path element in the PPR's path list. This process continues at every IGP node as specified in the path description TLV.

### 2.3.1. Ppr Data Plane Aspects

Data plane type for PPR-ID is selected by the entity (e.g., a controller, locally provisioned by operator), which selects a particular PPR in the network.

### 2.3.1.1. PPR NATIVE IP DATA PLANES

In an IPv4 network, source routing and packet steering with PPR can be done by selecting the IPv4 data plane type (PPR-IPv4), in PPR Path description with a corresponding IPv4 address/prefix as PPR-ID while signaling the path description in the control plane (see e.g., section 2.3.2). Forwarding is done by setting the destination IP address of the packet as PPR-ID at the ingress node of the network. In this case this is an IPv4 address in the tunneled/encapsulated user packet. There is no data plane change or upgrade needed to support this functionality.

Similarly, for an IPv6 network source routing and packet steering can be done in IPv6 data plane type (PPR-IPv6), along the path as described in PPR Path description with a corresponding IPv6 address/prefix as PPR-ID in the control plane (see e.g., section 2.3.2). Whatever specified above for IPv4 applies here too, except that destination IP address of the encapsulated data packet at the edge node is an IPv6 Address (PPR-ID). This doesn't require any IPv6 extension headers (EH).

For a loose path in an IPv4 or IPv6 network (Native IPv4 or IPv6 data planes respectively) the packet has to be encapsulated using the capabilities (either dynamically signaled through Xu et al., Advertising Tunnelling Capability in IS-IS, IETF draft-ietf-isis-encapsulation-cap-01 (Apr. 2017) (“[Ietf-Isis-Encapsulation-Cap]”), the Contents of which is hereby incorporated by reference in its entirety, or statically provisioned on the nodes) of the next loose PDE in the path description.

Consider the network fragment shown in FIG. 3 which further illustrates loose routing, and consider PATH-3. Node R2 can reach R5 ECMP through R2->R3->R4, and R2->R6->R4, both at cost 2. The path R2->R7->R8->R4 is longer (cost 3) and is not a path that R2 would choose to use to reach R4. Node R2 (start of the loose segment) is programmed to encapsulate a data packet towards the next loose topological PPR-PDE in the path, which is R4. The NH computed at R1 (for PPR-ID r5′) would be the shortest path towards R5 (e.g., the interfaces towards R2). R2 has an ECMP towards R3 and R6 to reach R4 (next PDE in the loose segment), as packet would be encapsulated at R2 for R4 as the destination. R7 and R8 are not involved in this PPR path and so do not need a FIB entry for PPR-ID r5′ (the on-path check for PATH-3 fails at these nodes).

In a strict path, for example, PATH-4 in FIG. 3, PPR-ID is programmed on the data plane at each node of the path, with NH set to the shortest path towards next topological PPR-PDE. In this case, there is no further encapsulation of the data packet is required.

2.3.1.2. Sr-Mpls with Ppr

PPR is fully backward compatible with SR data plane. As control plane PDEs can be extensible and particular data plane identifiers can be expressed to describe the path, in SR case PDEs can contain the SR SIDs.

In SR-MPLS, a data packet contains the stack of labels (path steering instructions) which guides the packet traversal in the network. For SR-MPLS data plane, the complete set of label stack is represented with a unique SR SID/Label, PPR-ID, to represent the path. The PPR-ID gets programmed on the data plane of each node, with the appropriate NH computed as specified in section 2.3. PPR-ID here is a label/index from the SRGB (like another node SID or global ADJ-SID). PPR path description in the control plane is a set of ordered SIDs represented with PPR-PDEs. Non-Topological segments described along with the topological PDEs can also be programmed in the forwarding plane to enable specific function/service, when the data packet hits with corresponding PPR-ID.

For SR-MPLS data plane either 1 label or 2 labels need to be provisioned on individual nodes on the path description. In the example network FIG. 2, for PATH-2 (a loose path), during control plane processing, node R1 programs the bottom label as PPR-ID and the top label as the next topological PPR-PDE in the path, which is a node SID of R5. In the control plane, the NH computed at R1 would be the shortest path towards R5 i.e., the interfaces towards R2 and R4 (ECMP). For strict paths, a single label (PPR-ID) is programmed on the data plane along the path, with NH set to the shortest path towards next topological PPR-PDE in the path description.

### 2.3.1.3. Srv6, Network Programming and Ppr

One of the key benefits PPR offers for SRv6 data plane is an optimized data plane as individual path steering SIDs in the data packet is replaced with a path identifier (PPR-ID). Thus potentially avoids MTU, hardware incompatibilities and processing overhead. Few PPR and SRv6 inter working scenarios are listed below.

In a simple encapsulation mode without SRH [RFC8754], an SRv6 SID can be used as PPR-ID. With this approach path steering can be brought in with PPR and some of the network functions as defined in Filsfils et al., Segment Routing over IPv6 (SRv6) Network Programming, IETF, draft-ietf-spring-srv6-network-programming-28 (Dec. 2020) (“[ietf-spring-srv6-network-programming]”) can be realized at the egress node as PPR-ID in this case is a SRv6 SID.

In SRv6 with SRH, one-way PPR-ID can be used is by setting it as the destination IPv6 address and SL field in SRH is set to 0; here, SRH can contain any other TLVs and to non-topological SIDs as needed. Another inter working case can be a multi area IGP deployment. In this case multiple PPR-IDs corresponding to each IGP area can be encoded as SIDs in SRH for an e2e path steering with minimal SIDs in SRH.

### 2.3.2. Ppr Control Plane Aspects

### 2.3.2.1. Ppr-Id and Data Plane Extensibility

The data plane identifier, PPR-ID describes a path through the network. A data plane type and corresponding PPR-ID can be specified with the advertised path description in the IGP. The PPR-ID type allows data plane extensibility for PPR, though it is currently defined for IPv4, IPv6, SR-MPLS and SRv6 data planes.

For native IP data planes, this is mapped to either IPv4 or IPv6 address/prefix. For SR-MPLS, PPR-ID is mapped to an MPLS Label/SID and for SRv6, this is mapped to an IPv6-SID. This is further detailed in Section 2.3.1 and Section 2.3.1.3.

### 2.3.2.2. Ppr Path Description Elements (PDEs)

The path identified by the PPR-ID is described as a set of PDEs, each of which represents a segment of the path. Each node determines its location in the path as described, and forwards to the next segment/hop or label of the path description (see the Forwarding Procedure Example later in this document).

These PPR-PDEs like SR SIDs, can represent topological elements like links/nodes, backup nodes, as well as non-topological elements such as a service, function, or context on a node with additional control information as needed.

A preferred path can be described as a Strict-PPR or a Loose-PPR. In a Strict-PPR all nodes/links on the path are described with SR-SIDs for SR data planes or IPv4/IPV6 addresses for native IP data planes. In a Loose-PPR only some of the nodes/links from source to destination is described. More specifics and restrictions around Strict/Loose PPRs are described in respective data planes in Section 2.3.1 and Section 2.3.1.3. Each PDE is described as either an MPLS label towards the NH in MPLS enabled networks, or as an IP NH, in the case of either ‘plain’/‘native’ IP or SRv6 enabled networks. A PPR path is related to a set of PDEs using the TLVs in respective IGPs.

### 2.3.2.3. Ecmp Considerations

PPR inherently supports Equal Cost Multi Path (ECMP) for both strict and loose paths. If a path is described using nodes, it would have ECMP NHs established for PPR-ID along the path. In the network shown in FIG. 2, for PATH-2, node R1 would establish ECMP NHs computed by the IGP, towards R5 for the PPR-ID r6′. However, one can avoid ECMP on any segment of the path by pinning the path using link identifier to the next segment as specified for PATH-1 in FIG. 2.

### 2.3.2.4. Ppr Services Along the Path

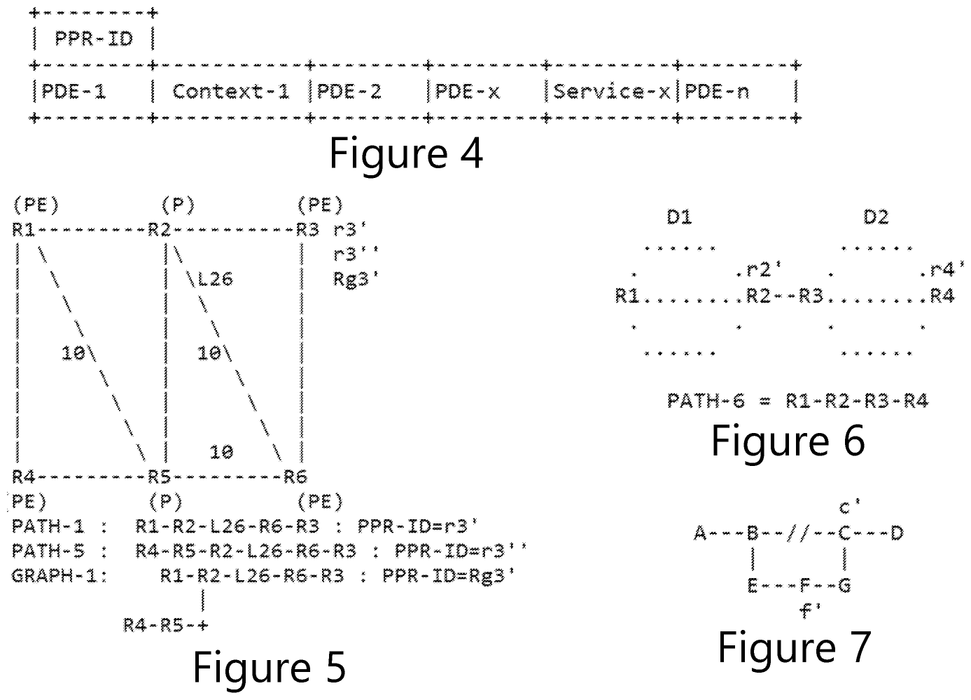

As shown in FIG. 4, some of the services specific to a preferred path, can be encoded as non-topological PDEs and can be part of the path description. These services are applied at the respective nodes along the path. In FIG. 4, PDE-1,PDE-2, PDE-x, PDE-n are topological PDEs of a data plane. For SR-MPLS/SRv6 data planes these are simply SIDs and for native IP data planes corresponding non-topological addresses. When the data packet with a PPR-ID is delivered to node-1, the packet is delivered to Context-1. Similarly on node-x, Service-x is applied. These services/functions need to be pre-provisioned on the particular nodes and optionally can be advertised in IGPs.

The above gives the basic and light weight service chaining capability with PPR without incurring any additional overhead on the data packet. However, this is limited to fixed services/functions for a path and all data packets using the path will be applied with these services. Flow level exclusions using the same path or differentiated services that need to be applied with in a flow cannot be supported with this mechanism and one has to resort to data plane mechanisms as defined in NSH/SFC (see e.g., Quinn et al., Network Service Header (NSH), IETF RFC 8300 (Jan. 2018) (“[RFC8300]”).

### 2.3.2.5. PPR Graphs

In a network of N nodes a total O(N\hat{ }2) unidirectional paths are necessary to establish any-to-any connectivity, and multiple (k) such path sets may be desirable if multiple path policies are to be supported (lowest latency, highest throughput and/or the like).

In many solutions and topologies, N may be small enough and/or only a small set of paths need to be preferred paths, for example for high value traffic (DetNet, some of the defined 5G slices), and then a point-to-point path structure specified in this document can support these deployments.

However, to address the scale needed when a larger number of PPR paths are required, the PPR TREE structure can be used.

Consider the network fragment in FIG. 5, where two PPR paths, PATH-1 and PATH-5 are shown from different ingress PE nodes (RI, R4) to the same egress PE node (R3). In a simple PPR Tree structure, these 2 paths can be combined to form a PPR Tree structure. PPR Tree is one type of a graph where multiple source nodes are rooted at one particular destination node, with one or more branches. FIG. 5, shows a PPR TREE (GRAPH-1), with 2 branches constructed with different PDEs, has a common PDE (node R2) and with a forwarding Identifier Rg3′ (PPR-ID) at the destination node R3.

Each PPR Tree uses one label/SID and defines paths from any set of nodes to one destination, this reduces the number of entries needed. For example, it reduces the number of forwarding identifiers needed in SR-MPLS data plane Section 2.3.1.2 with PPR, which are derived from the SRGB at the egress node. These paths form a tree rooted at the destination. In other word, PPR Tree identifiers are destination identifiers and PPR Treed are path engineered destination routes (like IP routes) and it scaling simplifies to linear in N (e.g., O(k*N)).

### 2.3.2.6. Ppr Multi-Domain Scenarios

PPR can be extended to multi-domain, including multi-area scenarios as shown in FIG. 6. Operation of PPR within the domain is as described in the preceding sections of this document. The key difference in operation in multi-domain concerns the value of the PPR-ID in the packet. There are three approaches that can be taken:

The PPR-ID is constant along the end-end-path. This requires coordination of the PPR-ID in each domain. This has the convenience of a uniform identity for the path. However, whilst an IPv6 network has a large PPR identity space, this is not the case for MPLS and is less the case for IPv4. The approach also has the disadvantage that the entirety of the domains involved need to be configured and provisioned with the common value. In the network shown in FIG. 6 The PPR-ID for PATH-6 is r4′.

The PPR-ID for each individual domain is the value that best suits that domain, and the PPR-ID is swapped at the boundary of the domains. This allows a PPR-ID that best suits arch domain. This is similar to the approach taken with multi-segment pseudowire (see e.g., Bocci et al., An Architecturefor Multi-SegmentPseudowire Emulation Edge-to-Edge, IETF RFC 5659 (Oct. 2009) (“[RFC5659]”)). This approach better suits the needs of network layers with limited identity resources. It also enables the better coordination of PPR-IDs. In this approach the PPR-ID for PATH-6 would be r2′ in domain D1 and r4′ in domain D2. These two PPR-IDs would be distributed in their own domains and the only inter-domain co-ordination required would be between R2 and R3.

A variant of (2) is that the PPR-IDs are domain specific, but a segment routing approach is taken in which they encoded at ingress (RI), and are popped at the inter-domain boarder. This requires that the domain ingress and egress routers support segment routing data-plane capability.

Although the example shown in FIG. 6 shows the case of two domains, nothing limits the design to just two IGP areas. This further explained infra.

In controller based deployments, each IGP area can have separate north bound and south bound communication end points with PCE/SDN controller, in their respective domain. It is expected that PPR paths for each IGP level are computed and provisioned at the ingress nodes of the corresponding area's area boarder router. Separate path advertisement in the respective IGP area should happen with the same PPR-ID. With this, only PPR-ID needs to be leaked to the other area, as long as a path is available in the destination area for that PPR-ID. If the destination area is not provisioned with path information, area boarder shall not leak the PPR-ID to the destination area.

### 2.3.3. Ppr Management Plane Aspects

### 2.3.3.1. IGP Metric Independent Paths/Graphs

PRR allows a considerable simplification in the design and management of networks. In a best effort network the setting of the IGP metrics is a complex problem with competing constraints. A set of metrics the is optimal for traffic distribution under normal operation may not be optimal under conditions of failure of one or more of the network components. Nor is that choice of metrics necessarily best for operation under all IPFRR conditions. When SR is introduced to the network a further constraint on metrics is the need to limit the size of the SID stack/list. These problems further increase with the introduction of demanding technologies such as network slicing and deterministic networking.

Some mitigation occurs with the use of FlexAlgo [ietf-1sr-flex-algo] but fundamentally this is still an approach that is critically dependent on the per-flex-algo provisioning of different metrics on participating nodes, that operate in both the normal and the failure case.

PPR allows the network to simply introduce metric independent paths on a strategic or tactical basis. Being metric independent each PPR path operates ships-in-the-night with respect to all other paths. This means that the network management system can address network tuning on a case by case basis only needing to worry about the traffic matrix along the path rather than needing to deconvolve the impact of tuning a metric on the whole traffic matrix. In other words, PPR is a direct method of tuning the traffic rather than an the indirect method that metric tuning provides.

An example that makes this clear is the maximally redundant tree (MRT) approach to IPFRR. MRT requires the tuning of metrics to tune the paths, and a common algorithm for all nodes in the network. An equivalent solution can be introduced to the network by the insertion of a pair of PPR graphs by the network management system. Furthermore the topology of these graphs are independent of all other graphs, allowing the tuning and to migration of the repair paths in the network management system.

Thus PPR allows the operator to focus on the desired traffic path of specific groups of packets independent of the desired path of the packets in all other paths.

### 2.3.3.2. Granular Oam

For some of the deployments as described in section 2 supra, the ability to collect certain statistics about PPR path usage, including how much traffic a PPR path carries and at what times from any node in the network is a critical requirement. Such statistics can be useful to account for the degree of usage of a path and provide additional operational insights, including usage patterns and trending information.

Traffic for certain PPRs may have more stringent requirement w.r.t accounting for critical service level agreements (SLAs) (e.g., 5G non-eMBB slice, and/or the like) and should account for any link/node failures along the path. Optional per path attributes like Packet Traffic Accounting” and “Traffic Statistics” instructs all the respective nodes along the path to provision the hardware and to account for the respective traffic statistics. Traffic accounting should be applied based on the PPR-ID. This capability allows a more granular and dynamic measurement of traffic statistics for only certain PPRs as needed.

As routing happens on the abstracted path identifier in the packet, no additional per packet instruction is needed for achieving the above functionality regardless of the data plane used in the network (see e.g., section 2.3.1 supra).

### 2.4. Preferred Path Loop Free Alternatives (Plfa)

PPR can be used as a method of providing IP Fast-Reroute (IPFRR). Preferred Path Loop-Free Alternate (pLFA) is described in Bryant et al., Preferred Path Loop-Free Alternate (pLFA), IETF draft-bryant-rtgwg-plfa-02 (27 Jun. 2021) (“[rtgwg-plfa-02]”), the contents of which is hereby incorporated by reference in its entirety. pLFA allows the construction of arbitrary engineered backup paths pLFA and inherits the low packet overhead of PPR requiring a simple encapsulation and a single path identifier for any path of any complexity.

pLFA provides a superset of RSVP-TE repairs (complete with traffic engineering capability) and Topology Independent Loop-Free Alternates (TI-LFA) [rtgwg-segment-routing-ti-lfa]. However, unlike the TI-LFA approaches PPR is applicable to a more complete set of data planes (for example MPLS, both IPv4 and IPv6 and Ethernet) where it can provide a rich set of IPFRR capabilities ranging from simple best-effort repair calculated at the point of local repair (PLR) to full traffic engineered paths. For any repair path pLFA requires one encapsulation and one PPR-ID, regardless of the complexity and constraints of the path.

For a basic understanding of pLFA consider the case of a link repair shown in section 4.1 of [rtgwg-plfa-02]. In the example of FIG. 7, it is assumed that a path A-B-C-D is a path that the packet must traverse. This may be a normal best effort path or a traffic engineered path.

PPR is used to inject the repair path B->E->F->G->C into the network with a PPR-ID of c′. B is monitoring the health of link B->C, for example looking for loss-of-light, or using Bidirectional Forwarding Detection (BFD) (see e.g., Katz et al., Bidirectional Forwarding Detection (BFD), IETF RFC 5880 (Jun. 2010)). When B detects a failure it encapsulates the packet to C by adding to the packet an encapsulation with a destination address set as the PPR-ID for c′ and then sending the packet to E. At C the packet is decapsulated and sent to D. The path B->E->F->G->C may be a traffic engineered path or it may be a best effort path. This may of course be the post convergence path from B to C, as is used by TI-LFA However B may have at its disposal multiple paths to C with different properties for different traffic classes. In this case each path to be used would require its own PPR-ID (c′, c”, and/or the like). Because pLFA only requires a single path identifier regardless of the complexity of the path is not necessary constrain the path to be a small number of loose source routed paths to protect against MTU or maximum SID count considerations.

pLFA supports the usual IPFRR features such as early release into Q-space, node repair, and shared risk link group support, LANs, ECMP and multi-homed prefixes. However, the ability to apply repair graphs (see e.g., section 2.3.2.5) is unique to pLFA. This is described in section 6 of [rtgwg-plfa-02]. The use of graphs in IPFRR repair simplifies the construction of traffic engineered repair paths, and allows for the construction of arbitrary maximally redundant tree repair paths.

Of importance in any IPFRR strategy in a loosely routed network, including normal connectionless routing is the ability to support loop-free convergence. This problem is described in Shand et al., A Framework for Loop-Free Convergence, IETF RFC 5715 (Jan. 2010) (“[RFC5715]”). Litkowski et al., Topology Independent Fast Reroute using Segment Routing, draft-ietf-rtgwg-segment-routing-ti-lfa-07 (29 Jun. 2021) (“[rtgwg-segment-routing-ti-lfa]”) has proposed a mitigation technique for failures (noted above) and pLFA is able to support this. However a network supporting high reliability traffic may find mitigation insufficient. Also disruption can take place on network component inclusion (or repair/recovery) and TI-LFA is silent on this. A network using pLFA is compatible with all of the know loop-free convergence and loop mitigation approaches described in [RFC5715].

### 2.5. Traffic Engineering Attributes

In addition to determining the nodes to traverse, there may be other aspects that need to be set up for a path. Most notably, this concerns the allocation and reservation of resources along the path to help ensure the service levels (e.g., the QoS that is delivered across the path) will be acceptable for the traffic routed across the path (critical in some deployments as listed herein).

While SR allows packet steering on a specified path (for MPLS and IPv6 with SRH), it does not have any notion of QoS or resources reserved along the path. The determination of which resources to allocate and reserve on nodes across the path, like the determination of the path itself, can in many cases be made by a controller. Accordingly, PPR includes extensions that allow to manage those reservations, in addition to the path itself.

The various example implementations discussed herein specify the resources to be reserved along the preferred path, through path attributes TLVs. Reservations are expressed in terms of required resources (e.g., bandwidth and/or the like), traffic characteristics (e.g., burst size and/or the like), and service level parameters (e.g., expected maximum latency at each hop and/or the like) based on the capabilities of each node and link along the path. Various implementations include mechanisms to indicate the status of the requested reservations, for example, if the requested reservations have been honored by individual nodes/links in the path. This can be done by defining new TLV(s)/Sub-TLV(s) in respective IGPs. Another aspect is additional node level TLVs and extensions to IS-IS-TE (see e.g., [RFC7810] and/or [RFC8570]) and OSPF-TE (see e.g., [RFC7471]) to provide accounting/usage statistics that have to be maintained at each node per preferred path.

3. Techniques for Creating Deterministic Cellular and/or Edge Fabric Using Interior Gateway Protocols and Controller Frameworks

A scalable and extensible fabric connectivity with deterministic properties is used by many cellular (e.g., LTE, 5G, WiMAX, and the like) edge deployments. This fabric typically connects cellular radio access network (RAN) nodes, cellular core network (CN) nodes, local compute clusters, management-and-orchestration nodes, and external routers to form a site for edge compute deployment. Unlike cloud data center fabrics, edge compute nodes need to provide deterministic services for many vertical segments where cellular/RAN co-located edge compute nodes are used more than for mere connectivity.

For example, an industrial LTE/5G and/or edge system (e.g., any of the edge computing systems/networks discussed herein) providing manufacturing and operations in a large factory floor needs bounded latency (e.g., an upper limit or threshold) and inter-packet arrival for a given flow (also referred to as jitter), high and reliable throughput for the flows in the edge system, and the like. In another example, an AR/VR application running in a 5G system and/or edge system needs committed throughput and latency upper bound(s) (e.g., a threshold in milliseconds) to avoid motion sickness but may not need stringent jitter. In another example, a V2X application running in a cellular (e.g., LTE, 5G, WiMAX, and the like) edge compute cluster serving UAVs or UGVs need high throughput, bounded latency, and minimal packet loss all the time to provide many services to the vehicular nodes connected to the edge fabric (e.g., in e2e fashion from UE to application).

Most of the data center (DC) fabrics are built using CLOS topology or spine-leaf topology (also called “folded CLOS” or the like; see e.g., FIGS. 19-20). These are designed and deployed today for providing scalability and extensibility, but are unable to provide deterministic properties for the traffic passing through the fabric. The deterministic properties needed from the network for lot of new services envisioned in cellular systems include, for example, committed throughput, bounded latency, bounded jitter, packet loss limits, and redundancy. Depending on the service offered by the edge system either some of these or all are needed (some examples as mentioned previously).

Open Network Foundation (ONF)® SD-Fabric™ attempts to provide deterministic properties using CLOS fabrics in cellular edge deployments using SDN framework through a centralized controller (see e.g., Open Network Foundation (ONF), “SD-Fabric: Open Source Full-Stack Programmable Leaf-Spine Network Fabric”, ONF White Paper (Jun. 2021) (“[ONFWP]”)). One disadvantage of [ONFWP] is the complete manageability of the fabric through a central SDN controller. As this architecture is based on a centralized control mechanism for routing functionality as well as providing possibly traffic engineering (TE) for all the flows in the fabric. [ONFWP] also has disadvantages with respect to configuration and maintenance of each individual node centrally, convergence and reconvergence times for any failures as it involves round-trips to the controller. While this may be appropriate for best effort traffic, building other deterministic properties is not possible as defined in

### [ONFWP].

Additionally, most widely deployed massive scale data centers (MSDCs) architecture using CLOS fabric and eBGP protocol as described in Lapukhov et al., “Use of BGP for Routing in Large-Scale Data Centers”, IETF RFC 7938, ISSN 2070-1721 (Aug. 2016) (“[RFC7938]”). While [RFC7938] provides connectivity for numerous servers in a scalable fashion, achieving deterministic properties is not the goal. While some mechanisms like 3^{rd} party route injection can provide traffic engineering in the fabric, by design even the traffic for the routes injected will be shared with rest of the best effort traffic in the system. However, building deterministic fabric with [RFC7938] is extremely inefficient.

The present disclosure provides a mechanism for deterministic fabrics to enhance widely deployed CLOS fabrics used in large DCs. The embodiments herein can also employ open standards TE techniques such as, for example, those discussed in Filsfils et al., Segment Routing over IPv6 (SRv6) Network Programming, IETF RFC 8986, ISSN 2070-1721 (Feb. 2021) (“[RFC8986]”), U. Chunduri et al., Preferred Path Routing—A Next-Generation Routing Framework beyond Segment Routing, 2018 IEEE Global Communications Conference (GLOBECOM), pp. 1-7, doi: 10.1109/GLOCOM.2018.8647410 (Dec. 2018) (“[Chunduri]”), Chunduri et al., Preferred Path Routing (PPR) in IS-IS, IETF draft-chunduri-1sr-isis-preferred-path-routing-06 (28 Sep. 2020) and/or Chunduri et al., Preferred Path Routing (PPR) in IS-IS, IETF draft-chunduri-1sr-isis-preferred-path-routing-08 (11 Jul. 2022) (collectively referred to as “[lsr isis_ppr]”), and [RFC8754], the contents of each of which are hereby incorporated by reference in their entireties. The example implementations discussed herein build on both centralized and distributed control planes together. This is done in a way the core properties of scalability and extensibilities are still preserved in these topologies for non-deterministic traffic sharing within the fabric. The present disclosure provides methods for TE and includes properties of determinism that can be achieved with this ingredient.

In particular, the deterministic fabric mechanisms discussed herein use a hybrid approach for building the fabric by leveraging the strength of central controllers for policy framework and using the well matured distributed Interior Gateway Protocols (IGPs) viz, OSPF and IS-IS for fabric connectivity. To achieve deterministic properties for certain types of traffic and extensible method to introduce additional connectivity paths in the CLOS fabric is described. This is done in a way with little to no impact to the regular best effort traffic passing through the system with equal-cost multipath (ECMP) connectivity and by not losing the scalability and extensibility properties of CLOS fabric. Finally, the present disclosure describes the technologies and certain base features in those technologies required to utilize the additional connectivity paths for traffic from UE to the local compute cluster passing through the cellular infrastructure nodes (e.g., distributed unit (DU), centralized unit (CU), user plane function (UPF), and the like).

As cellular edge deployments are only beginning to be deployed there is no matured solution which can take care of demands and requirements for new services and applications for many vertical segments or industries. Hence, the architectures and solution components discussed herein provide a base for bringing determinism in the cellular fabrics, edge fabrics, and/or other switching fabrics, and offers a platform to build and innovate many other features like cellular slicing in the in-edge transport fabric and self-healing properties in a fully automated fashion.

In some implementations, the deterministic fabric mechanisms, architecture, and components can be used to build a complete cellular edge system, which uses one or more server compute nodes for local compute clusters, which can enable deterministic services. Additionally or alternatively, the deterministic fabric mechanisms, architecture, and components can be used to build various cellular infrastructure elements such as, for example, DUs, CUs, core network NFs, AFs, and/or the like using one or more compute nodes and network elements (e.g., network switches, and/or the like) for acceleration in the data path. Additionally or alternatively, the deterministic fabric mechanisms, architecture, and components can be used to build software-based solution for running the fabric routing stack with the enhancements discussed herein as oppose to open-source network operating systems (e.g., Software for Open Networking in the Cloud (SONiC)) and/or open-source based controller platforms. Additionally or alternatively, the deterministic fabric mechanisms, architecture, and components can be used to implement a compete and scalable cellular edge solution with not only Flex-RAN and virtualized core network but that includes a flexible transport fabric, which can serve both public cellular operators and private cellular deployments.

### 3.1. Best Effort Connectivity in Clos Fabric

[ONFWP] uses a variant of CLOS fabric with cross links between leaf nodes and multi-chassis link aggregation group (MLAG) connectivity for servers to Leaf or Top-of-Rack (ToR) switches. These two changes alter the CLOS fabric non-blocking and ECMP behavior. [ONFWP] does not use any fabric protocol for connectivity and routing for flows from one server node to the other is done through SDN controller-based entries in the system and does not go in full detail of how traffic engineering and other deterministic properties can be achieved in a scalable fashion.

A common choice used for a horizontally scalable topology in DCs which is applicable to cellular edge fabrics is a folded CLOS or “fat-tree” or spine-leaf topology with odd number of stages [RFC7938]. The basic idea behind fat-trees is to alleviate the bandwidth bottleneck closer to the root with additional links. For private cellular and/or edge networks, an extensible 3 stage fabric with spine and leaf stages/layers and same port count can be used (e.g., a node with 32 or 64 links).

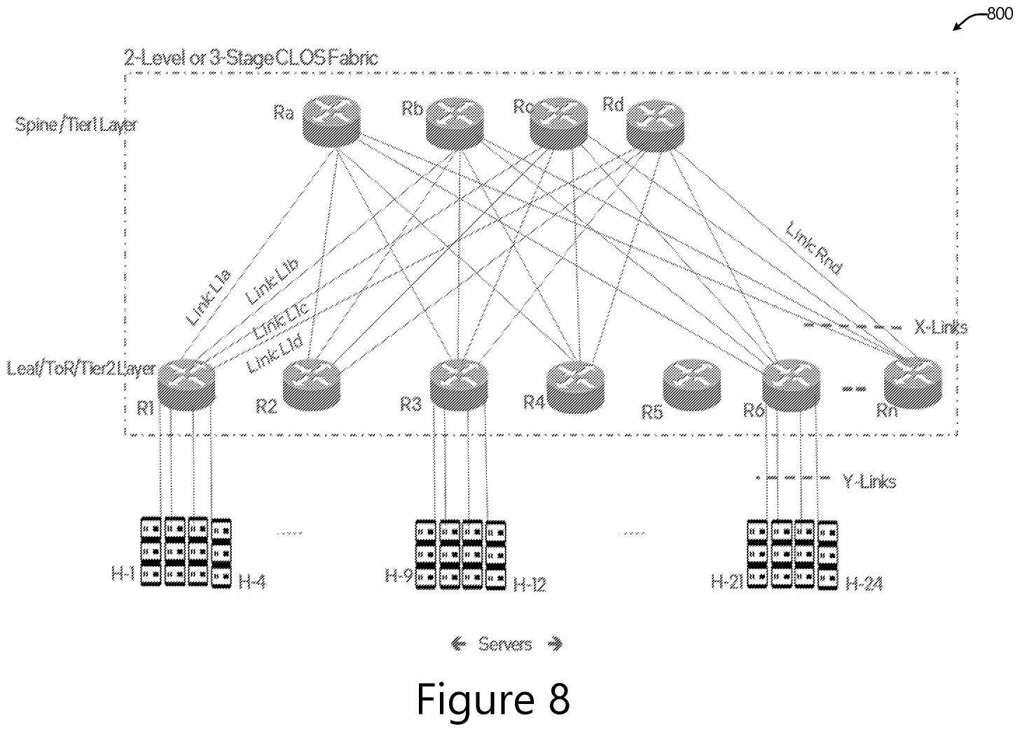

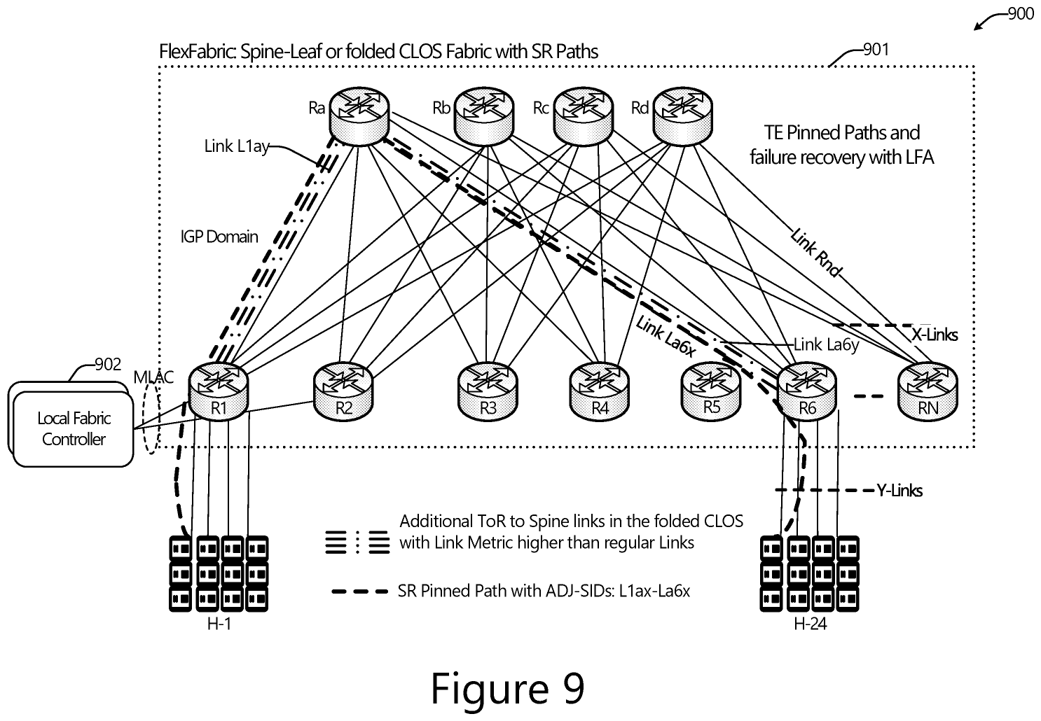

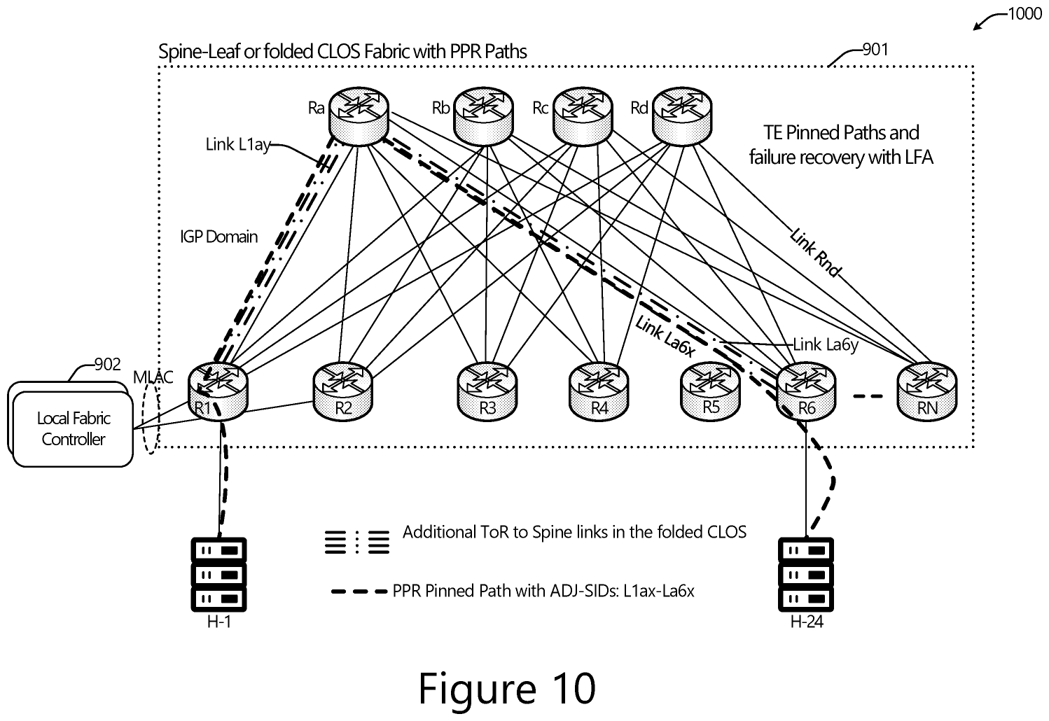

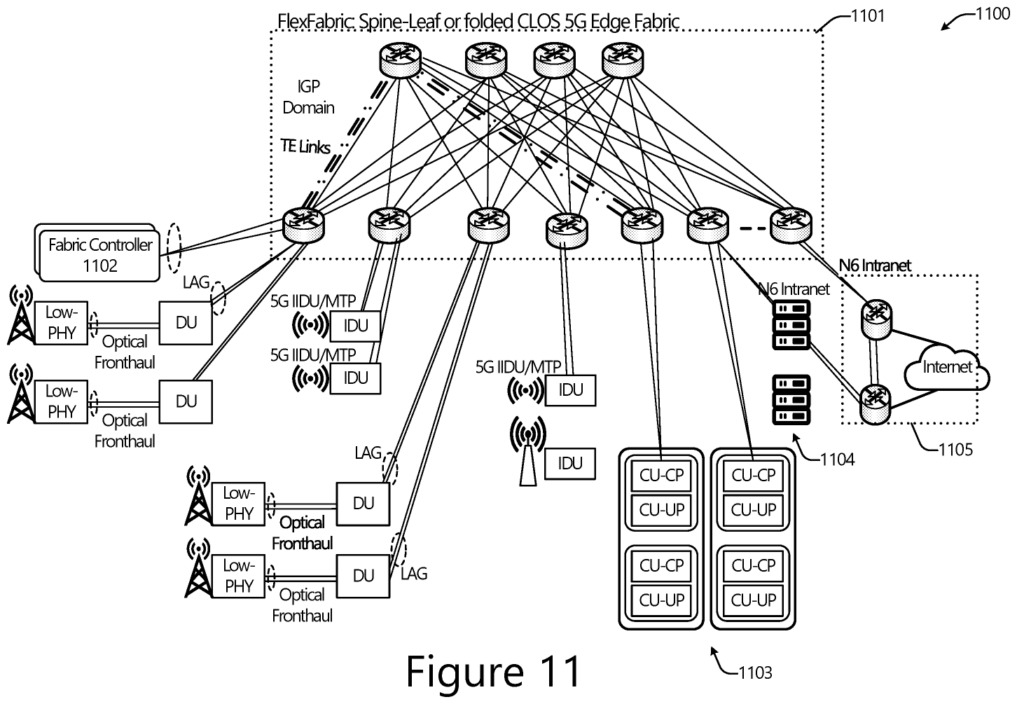

FIG. 8 depicts an example CLOS fabric 800, which includes a hierarchy of nodes arranged in layers including a spine (Tier-1) layer and a leaf/Top-of-Rack (ToR) (Tier-2). The spine (Tier-1) layer includes a set of network nodes Rₐ, R_{b}, R_{c}, and R_{d}, and the leaf/ToR (Tier-2) layer includes a set of network nodes R₁ to Rₙ (where n is a number). For purposes of the present disclosure, nodes Rₐ, R_{b}, R_{c}, and R_{d} may be referred to as “spine nodes” or “tier-1 nodes”, and the nodes R₁ to Rₙ may be referred to as “leaf nodes” or “tier-2 nodes”. The leaf nodes and spine nodes can be any type of network element (e.g., routers, switches, hubs, gateways, access points, RAN nodes, network monitors, network controllers, firewall appliances, fabric controllers, and/or the like) and/or any type of compute node such as any of those discussed herein. Additionally, a set of X links connect individual spine nodes to individual leaf nodes (e.g., links L₁ₐ, L_{1b}, L_{1c}, Li_{1d}, and link Rnd (L_{nd}) in FIG. 8). Note that not all X links in FIG. 8 are labeled for the sake of clarity. In many implementations, the X links are “best effort” links that operate according to know best effort delivery mechanisms.

The example CLOS fabric 800 also includes a set of servers H-1 to H-24 (collectively referred to as “servers H” or the like) are connected to network nodes R in the leaf/ToR (Tier-2) layer. In this example, the set of servers H are arranged into a set of clusters or groupings (e.g., a first cluster including servers H-1 to H-4, a second cluster including servers H-9 to H-12, and a third cluster including servers H-21 to H-24). The clusters may represent individual server racks within a data center network (DCN), individual data centers or DCNs, individual virtual/logical arrangements/groupings of servers, individual edge/RAN locations where edge compute nodes can be deployed, and/or any other suitable configuration or arrangement of servers. Additionally, a set of Y links connect nodes in the leaf layer to individual servers H.

In a 3 stage CLOS fabric 800, a packet crosses a spine stage/layer (Tier-1) once, and leaf/ToR stage/layer (Tier-2) twice. Total capacity can be increased either by adding more spine/leaf nodes while following the CLOS fabric port ratio requirements for non-blocking behavior with desired over subscription level. To support 100000+server the fabric can be extended to additional level (e.g., a 3-level fabric yields a packet to traverse 5 nodes from one server to another server). With this scalability and extensibility requirements are take care for scale out architecture without forklift upgrades for any fabric node capacity increase.

One interesting property of these topologies is that there will be multiple paths to the destination from the source towards the root (upstream) but only one path from the Root to the destination (downstream) as shown in FIG. 8 where 4 spines and n number of leaf nodes are present. The other well-known properties of these topologies include fully non-blocking, full-ECMP with a fan-out of number of links to spine stage, with traffic flowing from server to server is fully load balanced across. To take care of these design requirements, per [RFC7938], Leaf switch links to Spine should be higher than, Leaf switch links to Server (X>Y) and an oversubscription ratio of Y/Xis desired.

[ONFWP] proposes BGP as the fabric distributed protocol to support tens of 1000's of fabric nodes in the multi-level CLOS fabric. As IGP's scalability and overall route propagation through flooding in the fabric was a concern as presented in (see e.g., Lahiri et al., Why BGP is a better IGP, Global Networking Services Team, Global Foundation Services, Microsoft Corporation (11 Jun. 2012), (“[Lahiri]”)) to use BGP despite its short comings w.r.t convergence and configuration. Issues with BGP are recognized and to avoid all work arounds in [Lahiri], IGP's route propagation issue is being addressed through many proposals and one of the prominent efforts is described in Li et al., Dynamic Flooding on Dense Graphs, IETF, draft-ietf-1sr-dynamic-flooding-09 (9 Jun. 2021) (“[lsr-dynamic-flooding-09]”). However, the original MSDC scalability concerns don't apply to Cellular edge deployments due to inherently less scale requirements to few 100's of fabric nodes and few 1000s of servers.

In some implementations, the deterministic fabric elements may use or include aspects of the IGP framework to build the edge fabric, which provides built-in fast convergence and redundancy properties.

Regardless of which underlay fabric routing protocol is used as shown in FIG. 8, each server will have 4-way ECMP to reach to any server. For example, in FIG. 8 for any host connected to node RI, to H-9 with all link costs equal in IGP, it's a 4 CMP nexthops (NH) (e.g., @RT a route entry for H-9). This may be expressed as shown by table 3.1-1.

TABLE 3.1-1

H-9 → [L1a, L1b, L1c, L1d]

In the example of table 3.1-1, all the traffic to H-9 at node R1 will be hashed to one of these paths, and in case of link failures, this traffic will be rehashed to remaining ports, and after reconvergence to another link. This also does not ensure fully the load situation of these 4 paths as ECMP decision to select a particular link is made locally at that node. While this offers great benefits for best effort traffic by distributing the load in the fabric to all the links and providing inherent loop free alternative behavior if one of the links were to fail in the fabric.

However, the inherent ECMP CLOS fabric is not suitable for deterministic traffic and how it's not suitable for each component of determinism is explained as follows:

Throughput for deterministic flows cannot be committed despite taking care of the oversubscription ratio unless if the entire fabric is running at very low levels of traffic. This is because each switch in the path takes independent decision to select the path with our bearing how the load is distributed in e2e fashion.

Bounded latency cannot be committed either as any new flow any time can tilt the scales and occasionally for some unpredictable duration latency can increase. This is an intended as the goal of this design is to packet delivery in a reliable fashion all the time, which is the primary requirement for the best-effort traffic

Inter-packet latency for a flow or Jitter can also be unpredictable for the same reason. However, maintaining jitter bounds is much harder problem and needs multiple solutions in place including QoS along the path and beyond that.

Packet loss (in this case congestion loss) also cannot be committed as any time traffic bursts can cause thing egress queue space to be overfilled to cause queuing disciplines to kick and drop the packets. To minimize head of line blocking and to mitigate excessive latency for the traffic, it's proven strategy to reduce the egress queue output buffers.

Redundancy for link failures is assured in the CLOS fabric by its design (as this gives the biggest simplification and scalability in the fabric for best effort traffic). However, the other components of determinism can be impacted during the failure duration. Secondly, though it is rare, node failures can't be taken care with this design and failure of such magnitude is fatal to high value traffic.

### 3.2. Traffic Engineering-Capable Clos Networks for Building Deterministic Fabrics

FIG. 9 shows an example network fabric 901, which includes a same or similar arrangement of nodes R as discussed previously w.r.t topology 800 of FIG. 8, and also includes one or more fabric controllers 902.

To mitigate the issues identified previously, the deterministic fabric mechanisms discussed herein include re-architect the standard topology to add additional T links and/or reserve a number of existing links to be T links between individual leafnodes and individual spine nodes. In the example of FIG. 9, the network fabric 901 includes a set of T links (also referred to as “TE links”) between individual spine nodes and individual leaf nodes. In this example, there are two T links that connect individual leaf nodes to individual spine nodes (e.g., links L₁ₐₓ, L_{1ay}, Lₐ₆ₓ, and L_{a6y} in FIG. 9). For the sake of clarity, not all of the T links are shown by FIG. 9. Although FIG. 9 shows two T links for individual leaf/spine nodes, in other implementations, individual leaf/spine nodes may have more or fewer T links than shown by FIG. 9.

As alluded to previously, the T links can be newly added wired connections and/or some of the existing X links can be designated as T links. In either implementation, the T links are distinguish from the X links using (routing) metrics in the routing tables and/or forwarding tables of the leaf and spine nodes. In some examples, the T links are configured with higher (routing) metrics than the (routing) metrics of the X links. The T links can be implemented using the same or similar technologies (e.g., wires/cables, network interface controllers, and/or other similar components) as those used for the X links. However, because the T links have higher routing metrics, the T links are not used for regular ECMP operation. The higher metric values exclude the T links from being used for conventional ECMP transmission for traffic to and from the servers H. In addition, the additional bandwidth needs of the T links are managed by the fabric controller(s) 902 and a TE policy so that the T links are not oversubscribed. In some implementations, the management of the T links is based on a total bandwidth of the T links. Additional or alternative metrics can be used to manage the T links in other implementations.

After the T links are added to or otherwise designated in the network, a TE policy (also referred to as a “TE configuration” or the like) for using the T links and the X links can be configured/installed in each leaf and spine node and the fabric controller(s) 902 according to existing provisioning and/or installation methods. The TE policy can be used to route high priority traffic over path(s) that include the T links. Additionally or alternatively, the TE policy can specify various link conditions that will dynamically route best effort traffic over the path(s) that include the T links. In these implementations, individual nodes monitor the the X links, and dynamically reroutes the traffic from a path including X links to a path including T links based on the conditions/metrics of the X links.

After the TE policy is installed or otherwise established on the various nodes and the fabric controller(s) 902, the fabric controller(s) 902 can signal the individual nodes to begin routing traffic flows (data packets) according to the TE policy. For example, the TE policy and/or the higher metric value of the T links can be advertised to the leaf and spine nodes using LSAs, LSPs, and/or using other mechanisms of existing (routing) protocol procedures/operations.

In various implementations, the T links are added or desginated from existing links according to various conditions. In a first example condition, if X is the total number of links from leaf layer to spine, and T is the number of links that can be used for TE (or are currently being used for TE) in a shared deployment of best effort and/or high value traffic, then the conditions or inequalities to reserve T number of links are shown by Table 3.2-1.

TABLE 3.2-1

To ensure the non-blocking properties: (N_{X} − N_{T}) ≥ N_{Y}
metric of link t > metric of link x

In the conditions of Table 3.2-1, Nₓ is the total number of X links between the leaf layer and the spine layer, N_{T} is the number of T links that are added or re-designated for TE, which in some examples are links that are capable of or are currently being used for TE in a shared deployment of best effort and high value traffic, and Ny is the number of Y links between the leaf/ToR switch layer and the set of servers H. Additionally, t represents an individual link in the set of T links, and x represents an individual link in the set of X links. In some implementations, the metric of link t and the metric of link x are routing metrics and/or some other metric(s) such as any of those discussed herein. Additionally or alternatively, conditions to designate or reserve N_{T} number of T links can include one or more of the following example conditions:

A second example condition includes adding/designating/reserving the set of T links according to an over-subscription ratio of N_{y}/(Nₓ-N_{T}).

A third example condition includes, for unrestricted (edge) server or cellular functionality, placement T should be same for all the leaf/ToR switches. Additionally or alternatively, this condition may involve using the same number of T links for each leaf node.

A fourth example condition includes, for example, if multiple t links are present in T, the metric of link t1>metric of link t2, metric of link t2>metric of link t3, and so forth, to avoid ECMPs with the T links.

A fifth example condition includes, for example, a total capacity of the T links being managed centrally for traffic to be steered into the leaf/ToR nodes (e.g., central controller functionality.

A sixth example condition includes, for example, a traffic policy (e.g., TE policy) should be present on Leaf/ToR switches to steer the server traffic to the T links (e.g., central controller functionality).

### 3.2.1. Complete Te Data Plane Solution

Fabric TE topologies can de architected with Segment Routing (SR) technology for IPv6 data plane, also called as SRv6. SRv6 provided pinned paths in any topology by describing the packet traversal path with segment identifiers (SIDs) in the IPv6 routing extension header as specified in SRH (see e.g., [RFC8754]). As path description is in the packet header itself, this is a data plane solution for TE in the fabric. Resource reservation along the path is not recommended (though there some individual proposals in IETF) and SR expects certain over provisioning/subscription in the network and a central controller which is aware of the dynamic network resources. This allows controller to craft the pinned paths as per the management/operator policy in the network. With reasonable dimensioning of the Edge deployment Flex Fabric can be oversubscribed by a factor ToR switch downstream-port-BW (Y)/upstream-port-BW (X), while still maintaining non-blocking properties of the fabric.

A pinned path built with adjacency SIDs (in SR terminology) so as to avoid ECMP is shown by topology 900 in FIG. 9, which includes a network fabric 901 (which may be the same or similar as topology 800 of FIG. 8) and one or more local fabric controllers 902). Without SR, for traffic from H-1 to H-24, router R1 will have a 4-way ECMP as computed by IGP as shown by Table 3.2.1-1 and all the traffic will be ECMPed among these NextHops.

TABLE 3.2.1-1

@R1: H-2 → NextHops [L1a, L1b, L1c, L1d]

With SR, a pinned path from R1-R6 can be created with adjacency SID path list L1ax-La6x, and for certain traffic from H-1 to H-24 a local policy can be put in place with the controller as shown in FIG. 9 in R1 to map to this path. An example local policy is shown by Table 3.2.1-2.

TABLE 3.2.1-2
@R1: SR Path-N (from R1 to R6) → ADJ-SID [L1ax-La6x]
@R1: Local Policy: Certain traffic described with 5-tuples from H-1 to
H-24 → SR Path-N

As shown in Table 3.2.1-2, while best effort traffic uses the IGP computed ECMP paths, which provides load distribution across the fabric, certain premium traffic classes can use the crafted path in the fabric. With SR, the custom path provides more deterministic properties like bounded latency and Jitter budgeted in the fabric. Many customization and operations for traffic plumbing can be done with SRv6 network programmability [RFC8986] using P4 and Intel Barefoot, with which Flex Fabric is built upon.

In summary, SR with IPv6 data plane in the fabric can be deployed to build a base for TE paths, which is an essential building block for QoS and closed loop control.

### 3.2.2. Te Control Plane Solutions

A control plane solution for TE is independent of the underlying data plane. Preferred Path Routing (PPR) (see e.g., section 2 supra, [Chunduri], and [lsr isis_ppr]) is another best possible option. PPR is a method of providing path based dynamic routing for several packet types such as, for example, IPv4, IPv6, MPLS. This seamlessly works with a controller plane which holds both complete network view and Cellular edge enterprise policies while providing self-healing benefits in a distributed fashion in near-real time fashion. Unlike SRv6, PPR can allow Flex Fabric to be built with both IPv4 and IPv6 data planes.

PPR uses a simple encapsulation to add the path identity to the packet. This reduces the per packet overhead (for IPv4 its 20 bytes when compared to SRv6, where it's 40 bytes IPv6 header and a 2 SID SRH of 40 bytes) required for path steering when compared to SR, and therefore, has a smaller impact on both packet MTU, data plane processing and overall goodput for small payload packets.

Like SRv6, a pinned path with adjacency SIDs can be crated and instead of putting the path info in every packet it's advertised in the underlying IGP protocols with a path ID attached to it. With this a path is pre-programmed in the fabric to be used for mapping any desired traffic between 2 ToR switches. This is shown by example topology 1000 in FIG. 10 and described infra.

To traffic engineer high value traffic, 2 additional links from each ToR node to spine node is needed. This additional links will still comply to the folded CLOS design, as long as total links from leaf/ToR layer to spine layer is higher than ToR layer to servers. Instead of standard IGP link cost, these two will have higher cost and will not be part of the ECMP list. Here, there is no change for best effort traffic with these additional links. Without PPR, for traffic from H-1 to H-2, node RI will have a 4-way ECMP as computed by IGP as shown by Table 3.2.2-1, and all the traffic will be ECMPed among these NextHops.

TABLE 3.2.2-1

@R1: H-2 → NextHops [L1a, L1b, L1c, L1d]

With PPR a pinned path from R1-R6 can be crated with Adjacency SID path list L1ax-La6x, and for certain traffic from server H-1 to server H-2, a local policy can be put in place in R1 to map to this path as shown by Table 3.2.2-2.

TABLE 3.2.2-2
@R1: PPR-ID N (Path ID: from R1 to R6) → Path Description
[L1ax-La6x]
@R1: Local Policy: certain traffic described with 5-tuples from H-1 to
H-2 → PPR Path or PPR-ID N

This establishes the pinned path with PPR without little to no additional overhead in the data plane since there is no path description in the packet, and can be deployed for both IPv4 and IPv6 Flex Fabrics with little or no changes to the data plane. 3.3. DETERMINISM IN CLOS FABRIC

FIG. 11 shows an example cellular edge topology 1100, which includes a spine-leaf CLOS 5G edge fabric 1101 (which may be the same or similar to the topologies of FIGS. 8-10 discussed previously); one or more fabric controllers 1102, and various RAN nodes of a CU/DU split architecture (see e.g., 3GPP TS 38.401 v17.2.0 (2022-09-23) (“[TS38401]”), the contents of which are hereby incorporated by reference in its entirety) including network access nodes (NANs) (e.g., base stations and/or the like), radio units (RUs) (also referred to as “remote units” or Low-PHY functions), distributed units (DUs) (also referred to as “digital units”), indoor DUs (IDUs), and central units (CUs) 1103 (also referred to as “centralized units”) including CP-user plane (UP) functions, CP-control plane (CP) functions, UPFs, an N6 intranet 1104 including a set of servers, and N6 internet 1105 that includes various network nodes and is connected to the Internet, wherein some or all of these elements are connected to one another via optical Xhaul interfaces and/or other interfaces such as any of those discussed herein. The deterministic fabric technologies discussed herein can be modified to alleviate the problems with various components of determinism in CLOS fabrics discussed previously. Here, both data plane TE technologies and control plane TE technologies can be applied in the fabric to steer cellular traffic passing through the fabric, as discussed infra.

For throughput issues, as high value traffic is steered through a policy at the ingress of the ToR switches to the TE links, committed throughput can be achieved by selectively steering certain flows and adding more capacity as needed. Bounded latency is achieved because of the traffic separation from the best effort traffic and by ensuring enough resources in the pinned path based on the application profile. If multiple high value traffic applications are multiplexed on these TE links, additional mechanism may be used on top of the deterministic fabric mechanisms. Inter-packet latency for a flow or Jitter can be mitigated or reduced since traffic is traversing the network in a more controlled path. Packet to loss (e.g., congestion loss) can be mitigated by ensuring enough egress queue buffers in the pinned path enough to sustain the burst profile of the application traffic. If multiple high value traffic applications are multiplexed on these TE links additional mechanism are needed on top of this invention. Redundancy can be addressed using the implementations discussed infra.

### 4. Techniques for Building Deterministic Alternate Paths for Traffic Engineered Pinned Paths

Though many deterministic properties can be brought into the Fabric with the embodiments and implementations discussed previously, if a link or node in the traffic engineered pinned path itself fails, then all traffic on those links will be lost until the underlying IGPs converge (e.g., within a few milliseconds). Even after convergence, the traffic on the TE links will be distributed into the rest of the best effort links and hence loose the inability to maintain the deterministic SLAs.

If the traffic steering is done using data plane technology, such as SRv6 discussed previously, a loop free solution can be deployed with a Topology Independent Loop Free Alternative (TI-LFA) as defined in [rtgwg-segment-routing-ti-lfa]. However, TI-LFA is not a viable path for high value traffic if SLAs are to be maintained all the time. In other words, deterministic properties of the traffic need to be maintained even after reconvergence, and [rtgwg-segment-routing-ti-lfa] fails to do that as alternatives computed would resort to best effort paths.

If the traffic steering is done using control plane technology, such as PPR described previously, some of the preferred loop free techniques described in [rtgwg-plfa-02] can be used. The advantage of [rtgwg-plfa-02] over [rtgwg-segment-routing-ti-lfa] is the ability for the traffic to stay on TE backup path after primary path component is failed. Although [rtgwg-plfa-02] meets these requirements, [rtgwg-plfa-02] proposes to add multiple alternate TE paths or graphs into the IGP and associate with the primary path. This has two issues: First, advertising multiple complete paths/graphs in the IGP which eventually causes excessive flooding information in the IGP domain. Second, from the point of local repair (PLR) or where failure happened traffic must be switched to the new PPR and hence it incurs additional encapsulation processing and additional bytes of packet overhead.

The present disclosure includes solutions to provide preferred alternatives than what is proposed in [rtgwg-plfa-02]. To provide TE aware redundancy for the primary path without incurring additional processing and IGP overhead, a set of PDEs are bundled together and advertised into IGPs when the path is advertised, for example, with enhanced mechanisms on top of what's been proposed in [lsr isis_ppr] and Chunduri et al., Preferred Path Routing (PPR) in OSPF, IETF, draft-chunduri-1sr-ospf-preferred-path-routing-04 (8 Mar. 2020) (“[lsr_ospf_ppr]”). In various embodiments, a receiving node on the path may install the nexthops (NHs) based on the current shortest path tree for both primary path element as well as the secondary bundled element. Both the computed NHs are installed in the FIB table with the advertised path ID also called PPR-ID (see e.g., [lsr_isis_ppr] and [lsr_ospf_ppr]).

A scalable 5G edge solution with not only Flex-RAN and virtualized core Flex-Core but that includes a flexible transport fabric, which can serve both public 5G operators and private 5G deployments. This invention allows an efficient method to install TE aware back up paths in the fabric. IOW, this architecture, and solution make sure the gains made in the Flex-RAN and virtualized core network (flex-core) are not lost in the transport fabric connecting these 2 segments even in network failure scenarios.

The deterministic fabric technologies discussed herein can be used to build cellular edge systems, which use one or more server compute nodes for local compute clusters, which can enable deterministic services (e.g., traffic engineered backups). Additionally or alternatively, the deterministic fabric technologies discussed herein can be used to build software-based solutions for running the fabric routing stack with the enhancements discussed herein as oppose to open-source network operating systems (e.g., Software for Open Networking in the Cloud (SONiC)) and/or open-source controller platforms. Additionally or alternatively, the deterministic fabric technologies can be used to implement scalable cellular edge solutions with not only Flex-RAN and virtualized core network and/or Flex-Core, but also ones that include a flexible transport fabric, which can serve both public cellular operators and private cellular deployments. The deterministic fabric technologies discussed herein enable efficient installation of TE aware backup paths in the fabric, which enhance the gains made in Flex-RAN and virtualized core network (flex-core) implementations such that these gains are not lost in the transport fabric connecting these two segments even in network failure scenarios.

### 4.1. Te Aware Loop Free Alternates

Embodiments discussed herein may be implemented using CLOS topologies, which enhances these CLOS topologies and prevents or mitigates issues related to link and node failures in the Fabric for high value traffic. [rtgwg-plfa-02] details traffic engineered alternate paths for providing redundancy in case of Link and Node failures, which is also discussed infra.

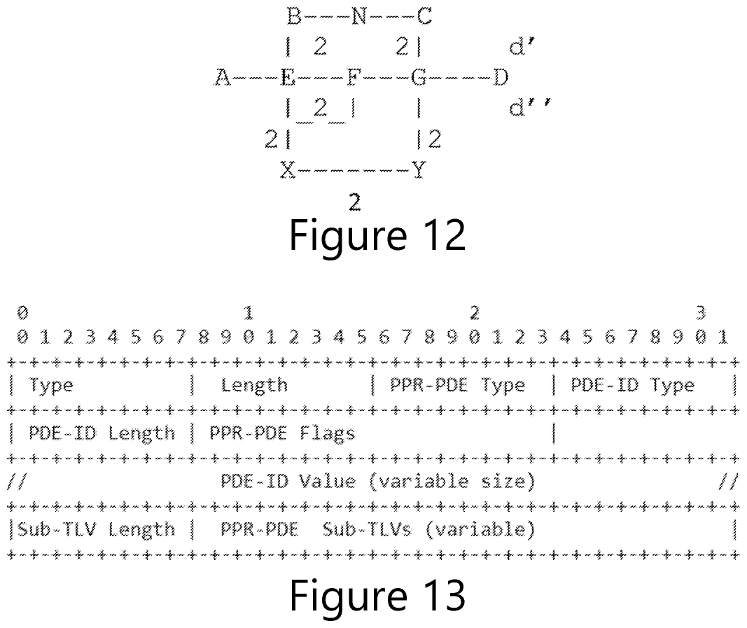

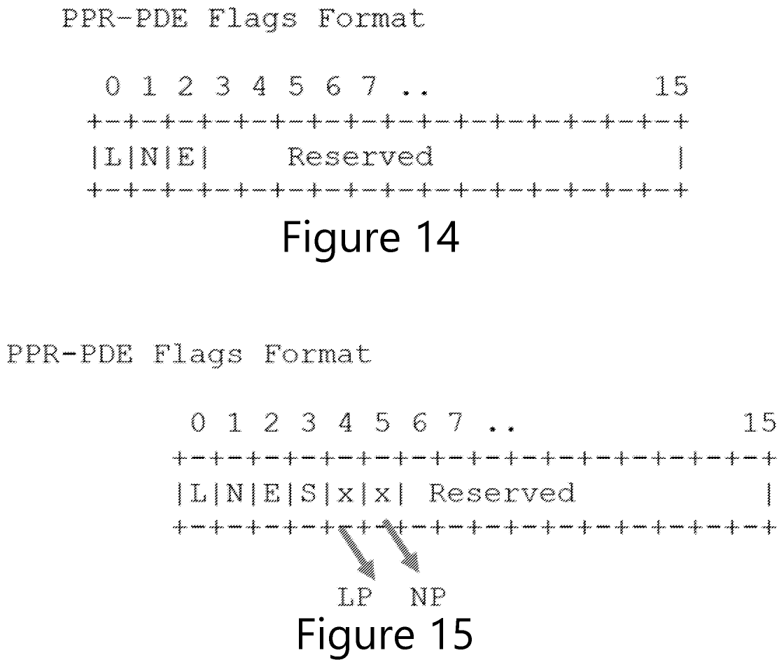

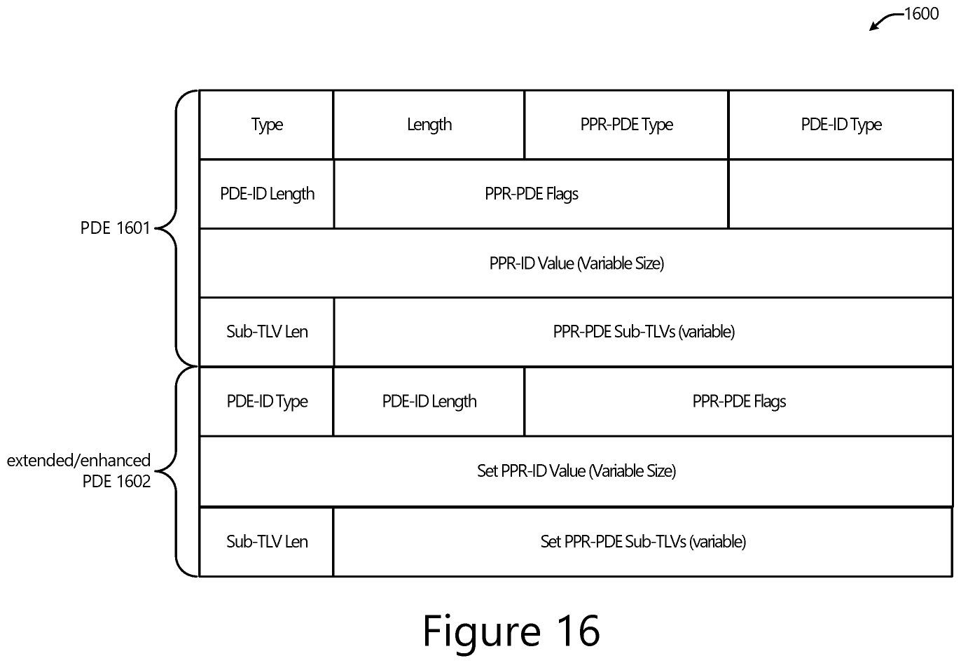

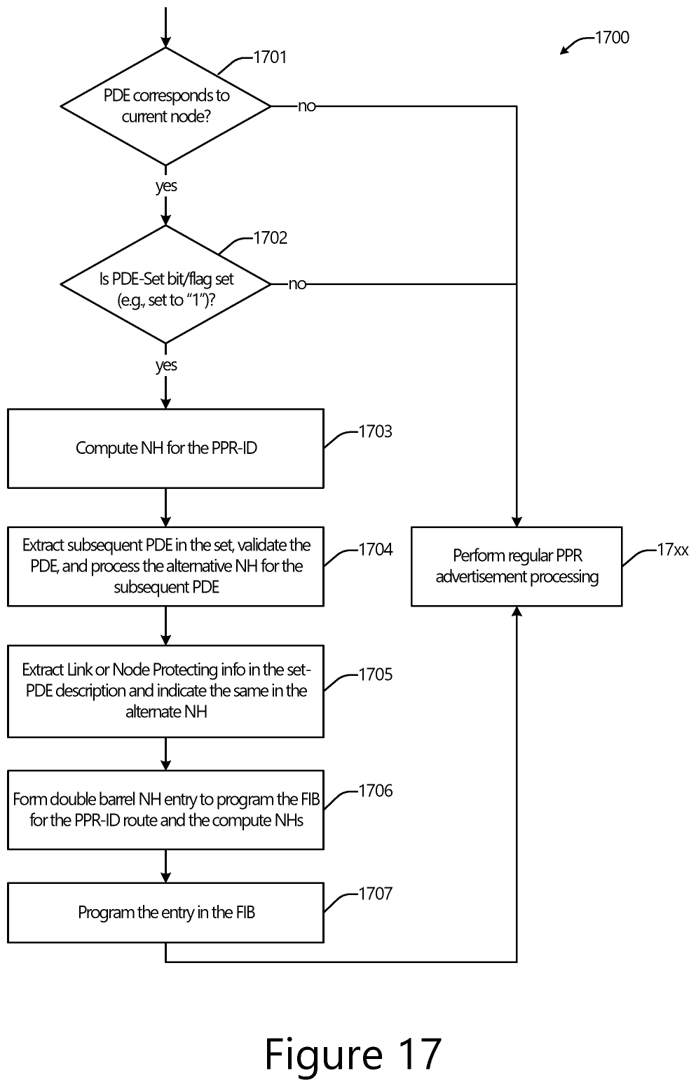

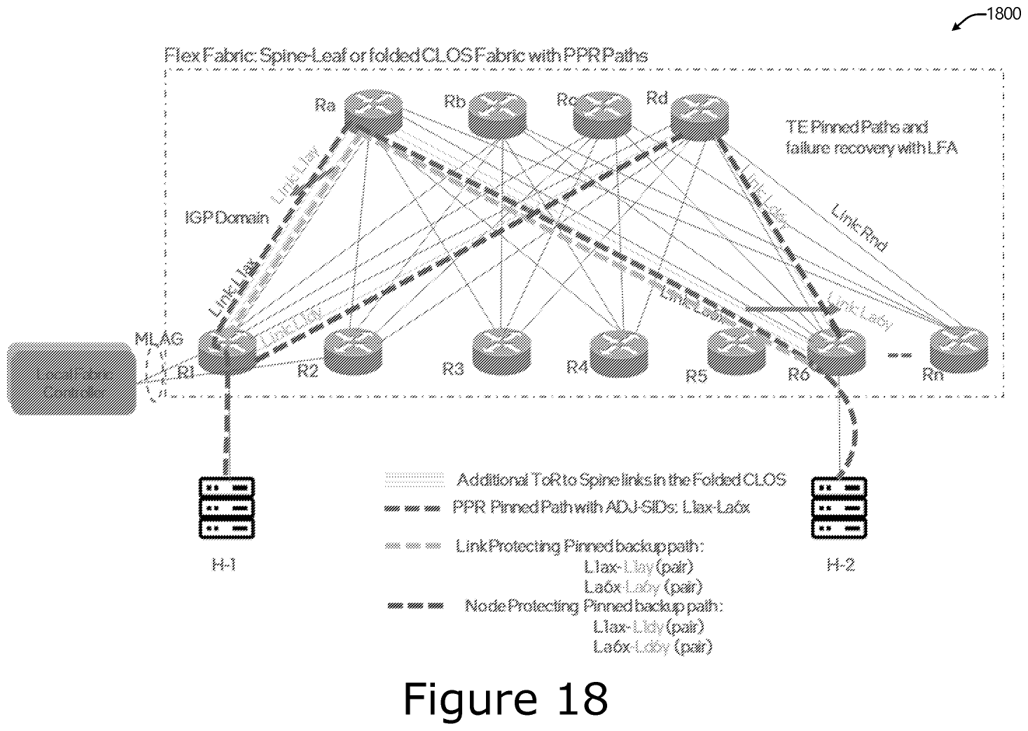

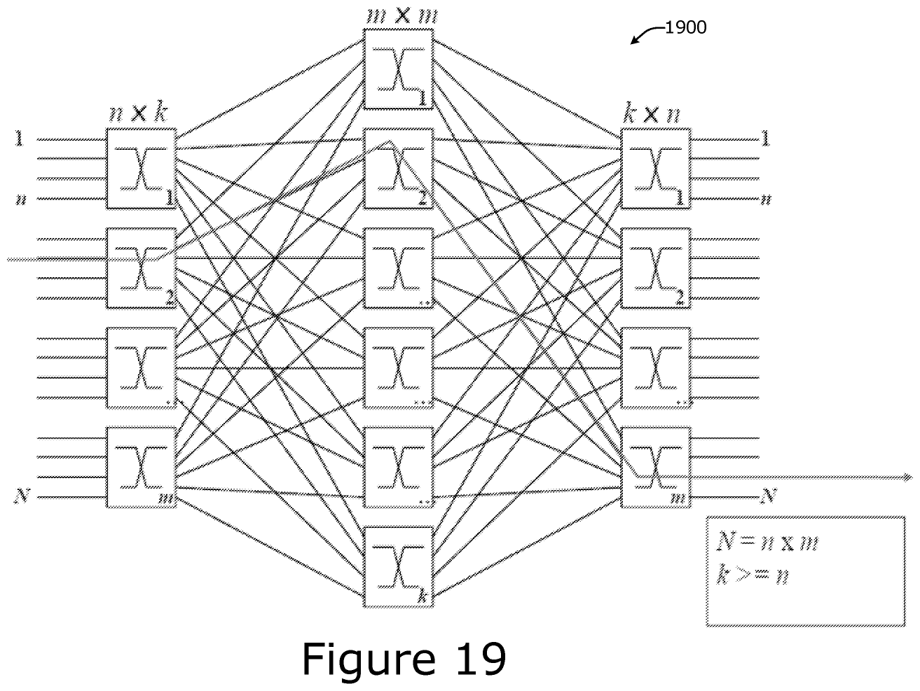

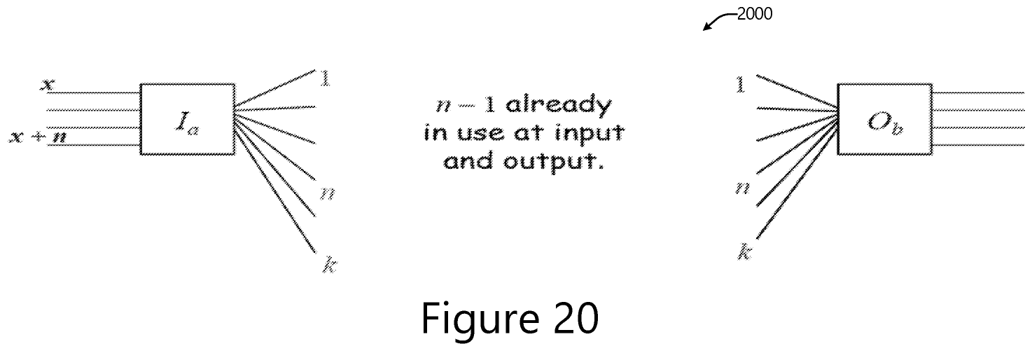

Consider all nodes are connected in the topology of FIG. 12 in an IGP domain, where capital letters represent Nodes and link metrics as shown (e.g., if a metric is not shown, it is considered to be 1). Multiple hosts/servers can be connected to any of these nodes. A shortest path for any host from A to D is A-E-B-N-C-D based on the link metric shown and all the traffic by default will traverse through that path.

A preferred path, TE path, or PPR is advertised as specified in [lsr isis_ppr] with PPR-ID d′ and path description A-E-F-G-D to send high value traffic. Another TE path or PPR is advertised as specified in [lsr isis_ppr] with PPR-ID d″ with path description A-E-X-Y-G-D to send certain other high value traffic or used as a backup path. A mechanism to associate these two paths so that failures in primary TE path (d′) can mitigate with the backup path (d″).

Consider link between E and F is failed then with [rtgwg-plfa-02] one can associate PPR-ID d″as the backup path and E starts immediately divert traffic to d″ (e.g., to node X). This is done by encapsulating the original packet with additional header corresponding to path d″.

However, the above solution requires encapsulation of the packet with destination as d″, which increases the computational and networking overhead. For example, this encapsulation causes an additional 20 bytes overhead for IPv4 packets, and an additional 40 bytes overhead for IPv4 packets.

The embodiments discussed herein assume links have enough MTU and the additional encapsulation does not cause packets to be fragmented. However, reassembly mechanisms may be used if fragmentation is used.

Another issue with the aforementioned solution is processing overhead in the data plane for additional encapsulation and decapsulation. If the network is carrying MIoT devices traffic with payloads are very small<80 bytes) encapsulation reduces the overall throughput.

### 4.2. Path Description Elements in Preferred Path Routing Path Advertisement

To mitigate the issues identified above, an additional PDEs with the primary path d′. This can be done in this topology, as an additional link between E and F with higher metric is present. For example, in the topology of FIG. 12, the advertised primary path may be as shown by Table 4.2-1.

TABLE 4.2-1

A-(E- Link EF2)-F-G-D → Path or PPR-ID d′

Such PDEs may be implemented by extending the PDEs discussed in section 3.3. in [lsr_isis_ppr]. An example PDE is shown by FIG. 14. The Sub-TLV in FIG. 14 represents the PPR-PDE. PPR-PDEs are used to describe the path in the form of set of contiguous and ordered Sub-TLVs, where first Sub-TLV represents (the top of the stack in MPLS data plane or) first node/segment of the path. These set of ordered Sub-TLVs can have both topological elements and non-topological elements (e.g., service segments). The fields of the PPR-PDE Sub-TLV in FIG. 14 are as shown by Table 4.2-2.

TABLE 4.2-2

| Field | Description |
|---|---|
| Type | Type such as, for example, type 3 (see e.g., IANA for suggested value) from IS-IS |
| | PPR TLV Sub-TLV registry (see e.g., section 3 of [lsr_isis_ppr]) |
| Length | Total length of the value field in bytes |
| PPR-PDE Type | A new registry (TBD IANA) for this Sub-TLV and the defined types are as follows: |
| | Type: 1 Topological |
| | Type: 2 Non-Topological |
| PDE-ID Type | 1 Octet PDE-forwarding Identifier Type. A new registry (Suggested Values as listed, |
| | IANA TBD) for this Sub-TLV and the defined types and corresponding PDE-ID Length, |
| | PDE-ID Value are shown by table 4.2-3 |
| PPR-PDE Flags | See e.g., FIG. 14; includes 2 Octet bit-field of flags are described in table 4.2-4 |
| Sub-TLV Length | 1 byte length of all Sub-TLVs followed. This is set to 0 if no further Sub-TLVs are |
| | present. |
| PPR-PDE Sub- | These have 1 octet type, 1 octet length, and value field is defined per the type field. |
| TLVs | Types are as defined in PPR-TLV Sub-TLVs (see e.g., section 7 of [lsr_isis_ppr]), |
| | encoded further as sub-sub-TLVs of PPR-PDE and the length field represents the total |
| | length of the value field in bytes |
| IS-IS System-ID | Type 4 (IANA TBD), Length Total length of value field in bytes, Value: IS-IS System-ID |
| Sub-TLV | of length “ID Length” as defined in ISO 10589: 1992. This Sub-TLV is not present if the |
| | PPR-PDE Type is not Topological. Though the type for this come from the PPR Sub- |
| | TLV registry, here this is a sub-sub-TLV and is part of PPR-ID/PPR-PDE Sub-TLV |

TABLE 4.2-3

| Type | Description |
|---|---|
| Type 0 | This value be set only when PPR-PDE Type is Non-Topological. PDE-ID Length indicates the |
| | length of the PDE-ID Value field in bytes. For this type, PDE-ID value represents a |
| | service/function. This information is provisioned on the immediate topological PDE preceding |
| | to this PDE based on the ‘E’ bit. |
| Type 1 | SID/Label type as defined in Previdi et al., IS-IS Extensions for Segment Routing, IETF RFC |
| | 8667 (December 2019) (“[RFC8667]”), the contents of which is hereby incorporated by reference in |
| | its entirety. PDE-ID Length and PDE-ID Value fields are per section 2.3 of [lsr_isis_ppr] |
| Type 2 | SR-MPLS Prefix SID. PDE-ID Length and PDE-ID Value are same as Type 1 |
| Type 3 | SR-MPLS Adjacency SID. PDE-ID Length and PDE-ID Value are same as Type 1 |
| Type 4 | IPv4 Node Loopback Address. PDE-ID Length 4 bytes and PDE-ID Value is full 4 bytes IPv4 |
| | address encoded as specified in “4-octet IPV4 address” of Sub-TLV 6/TLV 22 in Li et al., IS-IS |
| | Extensions for Traffic Engineering, IETF RFC 5305 (October 2008) (“[RFC5305]”) and/or |
| | Ginsberg et al., Invalid TLV Handling in IS-IS, IETF RFC 8918 (September 2020) (“[RFC8918]”), the |
| | contents of each of which are hereby incorporated by reference in their entireties |
| Type 5 | IPv4 Interface Address. PDE-ID Length is 4 bytes and PDE-ID Value is full 4 bytes IPv4 |
| | address encoded as specified in “4-octet IPV4 address” of Sub-TLV 6/TLV 22 in [RFC5305] |
| | and/or [RFC8918]. This PDE-ID in the path description represents the egress interface of the |
| | path segment and corresponding adjacency is set as nexthop for the PPR-ID |
| Type 6 | IPV6 Node Loopback Address. PDE-ID Length and PDE-ID Value are encoded as specified in |
| | “Prefix Len” and “prefix” portion of TLV 236 in Hopps, Routing IPv6 with IS-IS, IETF RFC |
| | 5308 (October 2008) (“[RFC5308]”), the contents of which are hereby incorporated by reference |
| | in its entirety. See also Ginsberg et al., IS-IS Route Preference for Extended IP and IPv6 |
| | Reachability, IETF RFC 7775 (February 2016) (“[RFC7775]”), the contents of which is hereby |
| | incorporated by reference in its entirety |
| Type 7 | IPv6 Interface Address. PDE-ID Length is 16 bytes and PDE-ID Value is full 16 bytes IPv6 |
| | address encoded as specified in “Interface Address 1” portion of TLV 232 in [RFC5308] |
| | and/or [RFC7775]. This PDE-ID in the path description represents the egress interface of the |
| | path segment and corresponding adjacency is set as nexthop for the PPR-ID |
| Type 8 | SRv6 Node SID as defined in Psenak et al., IS-IS Extensions to Support Routing over IPv6 |
| | Dataplane, IETF draft-bashandy-isis-srv6-extensions-05 (6 Mar. 2019) and/or Psenak et al., |
| | IS-IS Extensions to Support Segment Routing over IPv6 Dataplane, IETF draft-ietf-lsr-isis- |
| | srv6-extensions-18 (20 Oct. 2021) (collectively, “[isis-srv6-extensions]”), the contents of each |
| | of which are hereby incorporated by reference in their entireties. PDE-ID Length and PDE-ID |
| | Value are as defined in SRv6 SID from the referenced draft |
| Type 9 | SRv6 Adjacency-SID. PDE-ID Length and PDE-ID Values are similar to SRv6 Node SID |
| | above |

TABLE 4.2-4

| Flag Field | Flag Name | Description |
|---|---|---|
| L | Loose Bit | Indicates the type of next “Topological PDE-ID” in the path description. This |
| | | bit is set for only Node/Prefix PDE type. If this flag is unset, the next |
| | | Topological PDE is Strict Type |
| N | Node Bit | By default this bit is unset. This bit is set only for PPR-PDE Type is 1 (e.g., |
| | | Topological) and this PDE represents the node, where PPR-Prefix (see e.g., |
| | | section 3.1 of [lsr_isis_ppr]) belongs to (if there is no further PDE specific |
| | | Sub-TLVs to override PPR-Prefix and PPR-ID values) |
| E | Egress Bit | By default this bit is unset. This bit is set only for PPR-PDE Type is 2 (e.g., |
| | | Non-Topological) and the service needs to be applied on the egress side of |
| | | the topological PDE preceding this PDE |
| Reserved | Reserved | Reserved bits for future use. Reserved bits are reset on transmission and |
| | | ignored on receive |

Additional aspects of the PPR-PDEs are discussed in [lsrisisppr] and [lsr_ospf ppr]. The extensions and/or enhancements to the above structures are shown by the example TLV/packet format 1600 of FIG. 16 and discussed infra. It should be noted that the extensions/enhancements discussed herein can also be added as a sub-TLV in the PPR-PDE structure as defined in [lsr isis_ppr] and/or [Isr ospf-ppr]. In FIG. 16, the PDE section 1601 (e.g., PPR-PDE Sub-TLV Format) may be the same or similar to the PDEs discussed herein and/or in [lsr_isis_ppr]. The extended/enhanced PPR-PDE section 1602 includes additional PDE element(s) as pinned TE-aware alternative, which includes various new flags. The new flags for the extended/enhanced PPR-PDEs are shown by FIG. 15, and are summarized in table 4.2-5.

TABLE 4.2-5

| Flag | Flag | |
|---|---|---|
| Field | Name | Description |
| S | Set Flag | This flag indicates the current PDE is a set PDE and |
| | | can be used for back/backup purposes. This should be |
| | | only set in the first of the set PDEs |
| LP | Link | This flag indicates a Link protecting alternate to the |
| | Protecting | next element in the path description) |
| NP | Node | This flag indicates a node protecting alternate to the |
| | Protecting | next element in the path description |

In some implementations, the actual flag names described in standards, specifications, product literature, and the like can be different than those discussed previously, and the naming used herein is only illustrative for purposes of the present disclosure. Additionally or alternatively, in some implementations, the additional PDE element(s) as pinned TE aware alternatives (with new flags) in FIG. 16 can be encoded in the Sub-TLV Len and PPRE-PDE Sub-TLVs fields of the PDE rather than being appended to the PDE as individual elements.

### 4.3. Processing Procedures

FIG. 17 shows an example PPR-PDE processing procedure 1700, which may be performed by a network node, a path management function, and/or some other suitable element/entity. Procedure 1700 begins at operation 1701 where the node determines whether a PDE corresponds to the current node. If not, the node proceeds to operation 1708 to perform the existing/regular PPR advertisement processing procedure(s). If the PDE corresponds to the current node, the node proceeds to operation 1702 to determine if the PDE-Set bit/flag is set (e.g., includes a value of “1” or the like). If not, the node proceeds to operation 1708 to perform the existing/regular PPR advertisement processing procedure(s). If the PDE-Set bit/flag is set, the node proceeds to operation 1703 to compute the NH for the PPR-ID using, for example, existing PPR mechanisms (such as any of those discussed herein) and/or new/updated PPR mechanisms. At operation 1704, the node extracts a subsequent PDE in the set PDE (e.g., subsequent to the set (first) PDE), validates the extracted PDE, and processes the alternative NH for the subsequent PDE. As an example, the set PDE may be the PDE section 1601 in the PPR packet/TLV format 1600 of FIG. 16, and the subsequent PDE may be the enhanced/extended PDE section 1602 in the PPR packet/TLV format 1600 of FIG. 16. Additionally or alternatively, the set PDE may be a first enhanced/extended PDE section 1602 in the PPR packet/TLV format 1600 of FIG. 16, and the subsequent PDE may be a second enhanced/extended PDE section 1602 in the PPR packet/TLV format 1600 (not shown by FIG. 16) which is disposed after the first enhanced/extended PDE section 1602. It should be noted that the depicted packet/TLV encoding is an example illustration of how PDEs can be advertised in a network, and the particular format that is used can be adjust or altered according to implementation or desired use cases. Additionally or alternatively, such packet/TLV format can be standardized and/or specified in technical specifications or technical reference documentation.

At operation 1705, the node extracts link protecting information and/or node protecting information in the set-PDE description, and indicates the same in the alternate NH. At operation 1706, the node forms an NH entry (e.g., a double barrel NH entry) to program the forward information base (FIB) for the PPR-ID route and the computed NHs. At operation 1707, the node programs the entry in the FIB, and then proceeds to operation 1708 to perform the existing/regular PPR advertisement processing procedure(s). After operation 1708, the PPR advertisement may be sent to one or more other nodes, and process 1700 may repeat for additional PPR packets/TLVs.

In process 1700, whenever the S flag in the PDE is set (1702), the new element contains more than one PDE. If on-path check is successful (see e.g., [lsr_isis_ppr] and [lsr_ospf_ppr]) and the PDE-ID corresponds to the node that is processing this PPR (1701), an additional step is done to compute the NH corresponding to the alternate PDE in the set (1703, 1704). In some implementations, the rules for computing the NH for PDEs with LP/NP flags set is/are the same as the rules for computing the NH for PDEs with the S flag set. Once the computation is done, the node should create a FIB entry with PPR-ID with both primary and backup NH set as a double barrel entry in the forwarding table (1704, 1705, 1706, 1707). A double barrel FIB entry is a table entry that has two NHs packaged in an FIB prefix (e.g., the FIB's longest matched prefix). Here, the secondary NH is rapidly instantiated in case of a primary NH failure. The process for installing double barrels in the FIB can be the same or similar as for LFAs defined in, for example, Atlas et al., Basic Specification for IP Fast Reroute: Loop-Free Alternatives, IETF RFC 5286 (Sep. 2008) (“[RFC5286]”) and/or Sarkar et al., Selection of Loop-Free Alternates for Multi-Homed Prefixes, IETF RFC 8518 (Mar. 2019) (“[RFC 8518]”), the contents of each of which are hereby incorporated by reference in their entireties. In the example topology of FIG. 12, the advertised PPR is shown by table 4.2-6.

TABLE 4.2-6

A-(E- Link EF2)-F-G-D → Path or PPR-ID d′

The PDE for node E uses the extensions discussed herein and advertised with the S flag set, and Link EF2 is advertised as the immediate PDE with LP flag set. This enables node E to install double barrel NH in the FIB for PPR-ID d′. If failure of the links is detected (e.g., using link sensing or BFD failure), node E forwarding plane will establish the alternate path for packet forwarding. Thus, sending the packet on the alternate path/link with no additional encapsulation Here, the original packet with destination is still set to d′ and continue traverse the rest of the primary TE path.

As with [rtgwg-plfa-02], backup paths/graphs, a central controller or an external entity need to compute the LP and NP alternatives, which meets the deployment needs and are fundamentally loop-free in nature. Similar encoding enhancements for OSPF protocol as an extension for [lsr_ospfppr] like above.

### 4.4. Example Topology

FIG. 18 depicts an example CLOS fabric 1800 with TE paths with link and node protecting alternatives. The example CLOS fabric 1800 of FIG. 18 shows how the embodiments discussed here and extensions to [rtgwg-plfa-02], [lsr_isis_ppr], and [lsr_ospf_ppr] bring redundancy in the deterministic Flex-Fabric.

In the example CLOS fabric 1800, a pinned path or PPR with adjacency SIDs (see e.g., [lsr_isis_ppr] and [lsr_ospf_ppr]) can be crated and instead of putting the path info in every packet it's advertised in the underlying IGP protocols with a path ID attached to it. With this a path is pre-programmed in the fabric to be used for mapping any desired traffic between two ToR switches.

To traffic engineer high value traffic, two additional links from each ToR node to each spine node is/are used. Complete solution design, pre-conditions and mandatory inequalities are discussed previously. As a recap, without PPR, for traffic from H-1 to H-2, router R1 will have a 4-way ECMP as computed by IGP as shown below, and all the traffic will be ECMPed among these NextHops.

TABLE 4.2-7

@R1: H-2 → NextHops [L1a, L1b, L1c, L1d]

With PPR, a pinned path from RT-R6 can be crated with Adjacency SID path list L1ax-La6x and for certain traffic from H-1 to H-2 a local policy can be put in place in R1 to map to this path.

TABLE 4.2-8
@R1: PPR-ID N (Path ID: from R1 to R6) → Path Description
[L1ax-La6x]
@R1: Local Policy: Certain traffic described with 5-tuples from H-1 to
H-2 → PPR Path or PPR-ID N

This establishes the pinned path with PPR without no additional overhead in the data plane (as no path description in the packet) and can be deployed for both IPv4 and IPv6 Flex Fabrics with no changes to the data plane. This is described more elaborately in section 3, supra.

One of the key requirements for the high value or deterministic traffic through the G fabric is to maintain the SLAs (throughput, bounded latency, jitter, isolation, and redundancy) all the time including any failures in the fabric or increased load conditions for a certain duration of time. SRv6 backup paths, while computed in a distributed fashion [rtgwg-segment-routing-ti-lfa], they resort to best effort paths in the fabric, and this can cause deterioration of the committed SLAs during failure.

The embodiments discussed herein overcome this issue more efficiently than what's been proposed in [rtgwg-plfa-02]. The embodiments discussed herein allows alternate path description elements to be tied together in the advertised PPR, and on-path nodes install the pre-computed backups in the FIB and exercise those in case of primary path fails.

FIG. 18 shows example backup links from R1 to R6 through Llay and Ra to R6 through La6y and the advertised primary path N are shown by table 4.2-9, and FIB entries in R1 for PPR-ID N are shown by table 4.2-10.

TABLE 4.2-9

```
@R1: PPR-ID N (Path ID: from R1 to R6) → Path Description
[(L1ax-L1dy), (La6x-La6y)]
  ‘S’ Flag is set for PDE L1ax, La6x
  ‘LP’ Flag is set for PDE L1ay, La6y
@R1: Local Policy: Certain traffic described with (no change)
5-tuples from H-1 to H-2 → PPR Path or PPR-ID N
```

TABLE 4.2-10
@R1 N→ Double Barrel with Primary NH set to L1ax (Alternate NH set
to L1ay)
@Ra N→ Double Barrel with Primary NH set to L1ay (Alternate NH set
to La6y)

With this traffic continue to propagate on the rest of the primary PPR path N without any additional encapsulations that would have needed in [rtgwg-plfa-02]. FIG. 18 also shows cases nod protecting alternatives above, which is shown by table 4.2-11.

TABLE 4.2-9

```
@R1: PPR-ID N (Path ID: from R1 to R6) → Path Description
[(L1ax-L1ay), (La6x-Ld6y)]
  ‘S’ Flag is set for PDE L1ax, La6x
  ‘NP’ Flag is set for PDE La6x, Ld6y
```

The various example implementations discussed herein enable deterministic and/or high value traffic to have TE aware backups with no additional overhead for link and node failures on the TE path.

### 5. Clos Networks/Topologies

Clos network is a multistage switching network. Many data centers today deploy their systems using a fat-tree or CLOS topology where servers and appliances that host applications are deployed within racks. In such topologies, a top of the rack (ToR) switch (also referred to as a leaf switch) connects the systems within one or more racks and connects those systems to other spine switches. The spine switches connect ToRs as well as provide connectivity to other spine switches through another layer of switches. Applications communicate with other applications running on other systems to consumer services such as, for example, accessing an asset stored in another device, gathering results from a micro-service task(s) executed on other systems, or simply getting a status update from management software.

FIG. 19 shows an example of a 3-stage clos network 1900. The advantage of a Clos network is that connections between a large number of input and output ports can be made by using only small-sized switches. A bipartite matching between the ports can be made by configuring the switches in all stages. In FIG. 19, n represents the number of sources which feed into each of the m ingress stage crossbar switches. As can be seen, there is exactly one connection between each ingress stage switch and each middle stage switch. And each middle stage switch is connected exactly once to each egress stage switch.

It can be shown that with k n, the CLOS network can be non-blocking like a crossbar switch. That is, for each input-output matching an arrangement of paths for connecting the inputs and outputs can be found through the middle-stage switches. The Clos Theorem shows that for adding a new connection, there is no need to rearrange the existing connections so long as the number of middle-stage switches is large enough.

The Clos theorem may be as follows: If k2n−1, then a new connection can be added without rearrangement. For example, consider adding the nth connection between 1st stage Iₐ and 3rd stage O_{b} as shown in FIG. 20, where there is some center-stage M available. If k>(n−1)+(n−1), then there is always an M available (e.g., k>2n−1).

A three-stage folded CLOS network may be referred to as a leaf-and-spine architecture. A leaf-and-spine (or “leaf-spine”) architecture is a physical fabric architecture in which every (edge) compute node (leaf) is connected to every core compute node (spine). In many leaf-spine fabric implementations, a core includes two or more spines for redundancy. The number of spine interfaces determines the number of leafs the topology can support. A leaf-spine fabric can include either two or three tiers, depending on the needed scale. Each tier shares the same attributes reducing switch model variety requirements.

In a leaf-spine network, each leaf switch is connected to every spine switch. Typically, spines are of the same model and capacity. The spine tier is the backbone of the network and is responsible for interconnecting all leaf switches. Servers and other devices/nodes are grouped by rack and connected to the leaf switches. The leaf switch models may vary by rack depending on server interface capacity and speed requirements.

Leaf-and-spine fabrics have equidistant endpoints, where any pair of endpoints gets the same average e2e bandwidth. The equidistant endpoints property is based on the symmetry of leaf-and-spine fabrics where every leaf switch is connected to every spine switch with uplinks of uniform bandwidth. Contrary to Clos networks that use circuit switching, leaf-and-spine fabrics use hop-by-hop packet forwarding (e.g., statistical multiplexing). Thus, endpoints are equidistant only when the fabric transports large enough number of small flows to make statistical multiplexing and ECMP work.

### 6. Edge Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, and the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and the like). The orchestration functions may be used to deploy the isolated user-space instances, identifying and scheduling use of specific hardware, security related functions (e.g., key management, trust anchor management, and the like), and other tasks related to the provisioning and lifecycle of isolated user spaces.

Applications that have been adapted for edge computing include but are not limited to virtualization of traditional network functions including include, for example, Software-Defined Networking (SDN), Network Function Virtualization (NFV), distributed RAN units and/or RAN clouds, and the like. Additional example use cases for edge computing include computational offloading, Content Data Network (CDN) services (e.g., video on demand, content streaming, security surveillance, alarm system monitoring, building access, data/content caching, and the like), gaming services (e.g., AR/VR, and the like), accelerated browsing, IoT and industry applications (e.g., factory automation), media analytics, live streaming/transcoding, and V2X applications (e.g., driving assistance and/or autonomous driving applications).

The present disclosure provides specific examples relevant to various edge computing configurations provided within and various access/network implementations. Any suitable standards and network implementations are applicable to the edge computing concepts discussed herein. For example, many edge computing/networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

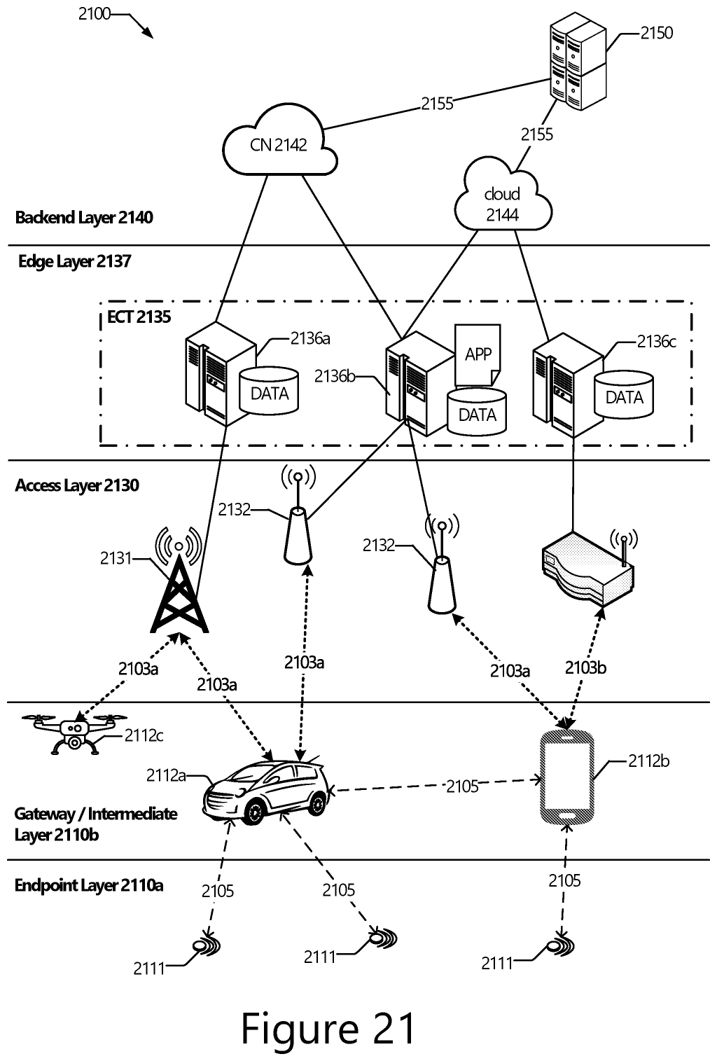

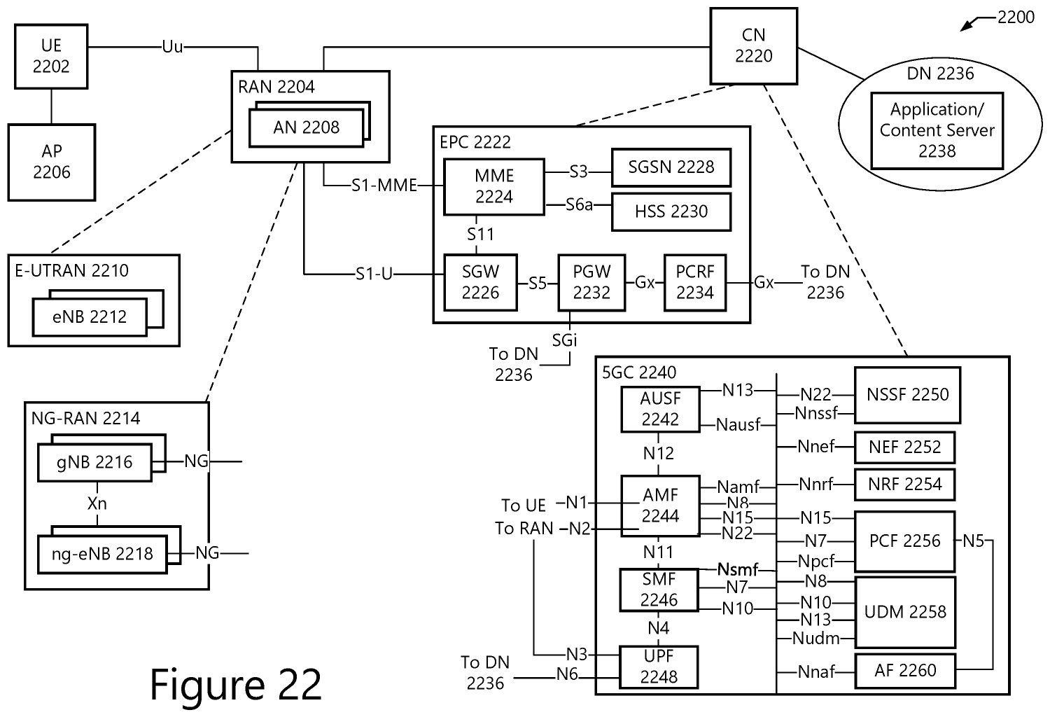

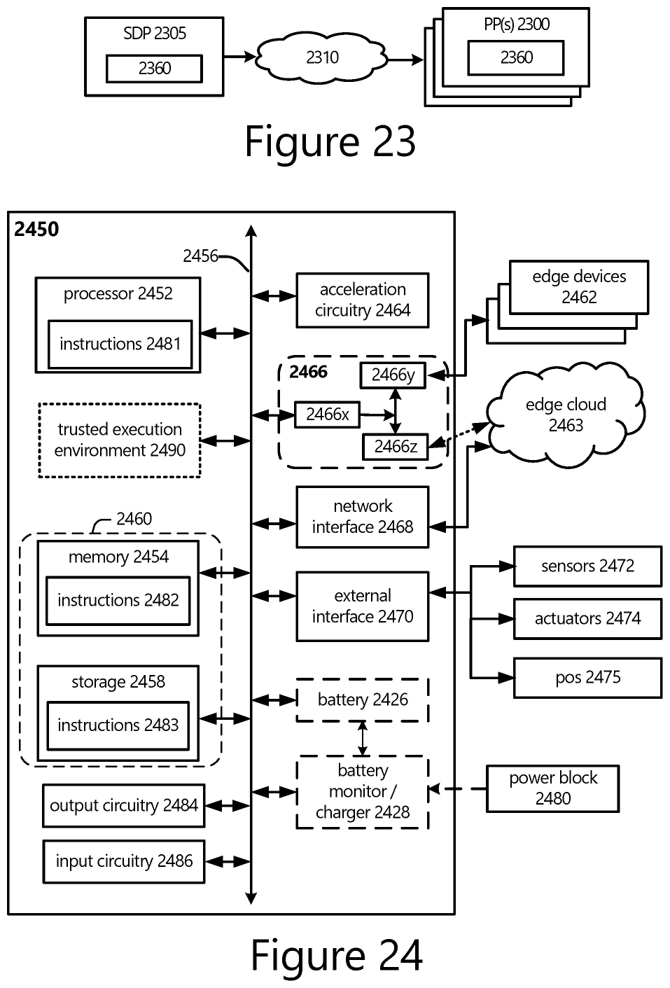

FIG. 21 illustrates an example edge computing environment 2100 including different layers of communication, starting from an endpoint layer 2110a (also referred to as “sensor layer 2110a”, “things layer 2110a”, or the like) including one or more IoT devices 2111 (also referred to as “endpoints 2110a” or the like) (e.g., in an Internet of Things (IoT) network, wireless sensor network (WSN), fog, and/or mesh network topology); increasing in sophistication to intermediate layer 2110b (also referred to as “client layer 2110b”, “gateway layer 2110b”, or the like) including various user equipment (UEs) 2112a, 2112b, and 2112c (also referred to as “intermediate nodes 2110b” or the like), which may facilitate the collection and processing of data from endpoints 2110a; increasing in processing and connectivity sophistication to access layer 2130 including a set of network access nodes (NANs) 2131, 2132, and 2133 (collectively referred to as “NANs 2130” or the like); increasing in processing and connectivity sophistication to edge layer 2137 including a set of edge compute nodes 2136a-c (collectively referred to as “edge compute nodes 2136” or the like) within an edge computing framework 2135 (also referred to as “ECT 2135” or the like); and increasing in connectivity and processing sophistication to a backend layer 2140 including core network (CN) 2142, cloud 2144, and server(s) 2150. The processing at the backend layer 2140 may be enhanced by network services as performed by one or more remote servers 2150, which may be, or include, one or more CN functions, cloud compute nodes or clusters, application (app) servers, and/or other like systems and/or devices. Some or all of these elements may be equipped with or otherwise implement some or all features and/or functionality discussed herein.

The environment 2100 is shown to include end-user devices such as intermediate nodes 2110b and endpoint nodes 2110a (collectively referred to as “nodes 2110”, “UEs 2110”, or the like), which are configured to connect to (or communicatively couple with) one or more communication networks (also referred to as “access networks,” “radio access networks,” or the like) based on different access technologies (or “radio access technologies”) for accessing application, edge, and/or cloud services. These access networks may include one or more NANs 2130, which are arranged to provide network connectivity to the UEs 2110 via respective links 2103a and/or 2103b (collectively referred to as “channels 2103”, “links 2103”, “connections 2103”, and/or the like) between individual NANs 2130 and respective UEs 2110.

As examples, the communication networks and/or access technologies may include cellular technology such as LTE, MuLTEfire, and/or NR/5G (e.g., as provided by Radio Access Network (RAN) node 2131 and/or RAN nodes 2132), WiFi or wireless local area network (WLAN) technologies (e.g., as provided by access point (AP) 2133 and/or RAN nodes 2132), and/or the like. Different technologies exhibit benefits and limitations in different scenarios, and application performance in different scenarios becomes dependent on the choice of the access networks (e.g., WiFi, LTE, and the like) and the used network and transport protocols (e.g., Transfer Control Protocol (TCP), Virtual Private Network (VPN), Multi-Path TCP (MPTCP), Generic Routing Encapsulation (GRE), and the like).

The intermediate nodes 2110b include UE 2112a, UE 2112b, and UE 2112c (collectively referred to as “UE 2112” or “UEs 2112”). In this example, the UE 2112a is illustrated as a vehicle system (also referred to as a vehicle UE or vehicle station), UE 2112b is illustrated as a smartphone (e.g., handheld touchscreen mobile computing device connectable to one or more cellular networks), and UE 2112c is illustrated as a flying drone or unmanned aerial vehicle (UAV). However, the UEs 2112 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi, Arduino, Intel Edison, and the like), plug computers, and/or any type of computing device such as any of those discussed herein.

The endpoints 2110 include UEs 2111, which may be IoT devices (also referred to as “IoT devices 2111”), which are uniquely identifiable embedded computing devices (e.g., within the Internet infrastructure) that comprise a network access layer designed for low-power IoT applications utilizing short-lived UE connections. The IoT devices 2111 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 2111 may be abiotic devices such as autonomous sensors, gauges, meters, image capture devices, microphones, light emitting devices, audio emitting devices, audio and/or video playback devices, electro-mechanical devices (e.g., switch, actuator, and the like), EEMS, ECUs, ECMs, embedded systems, microcontrollers, control modules, networked or “smart” appliances, MTC devices, M2M devices, and/or the like. The IoT devices 2111 can utilize technologies such as M2M or MTC for exchanging data with an MTC server (e.g., a server 2150), an edge server 2136 and/or ECT 2135, or device via a PLMN, ProSe or D2D communication, sensor networks, or IoT networks. The M2M or MTC exchange of data may be a machine-initiated exchange of data.

The IoT devices 2111 may execute background applications (e.g., keep-alive messages, status updates, and the like) to facilitate the connections of the IoT network. Where the IoT devices 2111 are, or are embedded in, sensor devices, the IoT network may be a WSN. An IoT network describes an interconnecting IoT UEs, such as the IoT devices 2111 being connected to one another over respective direct links 2105. The IoT devices may include any number of different types of devices, grouped in various combinations (referred to as an “IoT group”) that may include IoT devices that provide one or more services for a particular user, customer, organizations, and the like. A service provider (e.g., an owner/operator of server(s) 2150, CN 2142, and/or cloud 2144) may deploy the IoT devices in the IoT group to a particular area (e.g., a geolocation, building, and the like) in order to provide the one or more services. In some implementations, the IoT network may be a mesh network of IoT devices 2111, which may be termed a fog device, fog system, or fog, operating at the edge of the cloud 2144. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 2144 to Things (e.g., IoT devices 2111). The fog may be established in accordance with specifications released by the OFC, the OCF, among others. Additionally or alternatively, the fog may be a tangle as defined by the IOTA foundation.

The fog may be used to perform low-latency computation/aggregation on the data while routing it to an edge cloud computing service (e.g., edge nodes 2130) and/or a central cloud computing service (e.g., cloud 2144) for performing heavy computations or computationally burdensome tasks. On the other hand, edge cloud computing consolidates human-operated, voluntary resources, as a cloud. These voluntary resource may include, inter-alia, intermediate nodes 2120 and/or endpoints 2110, desktop PCs, tablets, smartphones, nano data centers, and the like. In various implementations, resources in the edge cloud may be in one to two-hop proximity to the IoT devices 2111, which may result in reducing overhead related to processing data and may reduce network delay.

Additionally or alternatively, the fog may be a consolidation of IoT devices 2111 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources.

Additionally or alternatively, the fog may operate at the edge of the cloud 2144. The fog operating at the edge of the cloud 2144 may overlap or be subsumed into an edge network 2130 of the cloud 2144. The edge network of the cloud 2144 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g., the aforementioned edge compute nodes 2136 or edge devices). The Fog layer resides on top of the edge layer and is a consolidation of networking devices such as the intermediate nodes 2120 and/or endpoints 2110 of FIG. 21.

Data may be captured, stored/recorded, and communicated among the IoT devices 2111 or, for example, among the intermediate nodes 2120 and/or endpoints 2110 that have direct links 2105 with one another as shown by FIG. 21. Analysis of the traffic flow and control schemes may be implemented by aggregators that are in communication with the IoT devices 2111 and each other through a mesh network. The aggregators may be a type of IoT device 2111 and/or network appliance. In the example of FIG. 21, the aggregators may be edge nodes 2130, or one or more designated intermediate nodes 2120 and/or endpoints 2110. Data may be uploaded to the cloud 2144 via the aggregator, and commands can be received from the cloud 2144 through gateway devices that are in communication with the IoT devices 2111 and the aggregators through the mesh network. Unlike the traditional cloud computing model, in some implementations, the cloud 2144 may have little or no computational capabilities and only serves as a repository for archiving data recorded and processed by the fog. In these implementations, the cloud 2144 centralized data storage system and provides reliability and access to data by the computing resources in the fog and/or edge devices. Being at the core of the architecture, the Data Store of the cloud 2144 is accessible by both Edge and Fog layers of the aforementioned edge-fog network.

As mentioned previously, the access networks provide network connectivity to the end-user devices 2120, 2110 via respective NANs 2130. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for WiMAX implementations. Additionally or alternatively, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 2131, 2132. This virtualized framework allows the freed-up processor cores of the NANs 2131, 2132 to perform other virtualized applications, such as virtualized applications for various elements discussed herein.

The UEs 2110 may utilize respective connections (or channels) 2103a, each of which comprises a physical communications interface or layer. The connections 2103a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 2110 and the NANs 2130 communicate data (e.g., transmit and receive) data over a licensed medium (also referred to as the “licensed spectrum” and/or the “licensed band″) and an unlicensed shared medium (also referred to as the “unlicensed spectrum” and/or the “unlicensed band″). To operate in the unlicensed spectrum, the UEs 2110 and NANs 2130 may operate using LAA, enhanced LAA (eLAA), and/or further eLAA (feLAA) mechanisms. The UEs 2110 may further directly exchange communication data via respective direct links 2105. Examples of the direct links 2105 include 3GPP LTE and/or NR sidelinks, Proximity Services (ProSe) links, and/or PC5 interfaces/links; WiFi based links and/or a personal area network (PAN) based links (e.g., [IEEE802154] based protocols including ZigBee, IPv6 over Low power Wireless Personal Area Networks (6LoWPAN), WirelessHART, MiWi, Thread, and the like; WiFi-direct; Bluetooth/Bluetooth Low Energy (BLE) protocols).

Additionally or alternatively, individual UEs 2110 provide radio information to one or more NANs 2130 and/or one or more edge compute nodes 2136 (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 2110 current location). As examples, the measurements collected by the UEs 2110 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/I0), energy per chip to noise power density ratio (Ec/NO), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022-03-31) (“[TS36214]”), 3GPP TS 38.215 v17.2.0 (2022-09-21) (“[TS38215]”), 3GPP TS 38.314 v17.1.0 (2022-07-17) (“[TS38314]”), [IEEE80211], and/or the like. Additionally or alternatively, any of the aforementioned measurements (or combination of measurements) may be collected by one or more NANs 2130 and provided to the edge compute node(s) 2136.

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to Radio Resource Control (RRC) (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 2110, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.7.1 (2022-06-17) (“[TS28552]”), 3GPP TS 32.425 v17.1.0 (2021-06-24) (“[TS32425]”), and/or the like.

The radio information may be reported in response to a trigger event and/or on a periodic basis. Additionally or alternatively, individual UEs 2110 report radio information either at a low periodicity or a high periodicity depending on a data transfer that is to take place, and/or other information about the data transfer. Additionally or alternatively, the edge compute node(s) 2136 may request the measurements from the NANs 2130 at low or high periodicity, or the NANs 2130 may provide the measurements to the edge compute node(s) 2136 at low or high periodicity. Additionally or alternatively, the edge compute node(s) 2136 may obtain other relevant data from other edge compute node(s) 2136, core network functions (NFs), application functions (AFs), and/or other UEs 2110 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

In any of the embodiments discussed herein, any suitable data collection and/or measurement mechanism(s) may be used to collect the observation data. For example, data to marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF MAMS (e.g., [MAMS], Kanugovi et al., Multi-Access Management Services (MAMS), INTERNET ENGINEERING TASK FORCE (IETF), REQUEST FOR COMMENTS (RFC) 8743 (Mar. 2020) (“[RFC8743]”)), IEEE/WiFi (e.g., [IEEE80211], [WiMAX], [IEEE16090], and the like), and/or any other like standards such as those discussed herein.

The UE 2112b is shown as being capable of accessing access point (AP) 2133 via a connection 2103b. In this example, the AP 2133 is shown to be connected to the Internet without connecting to the CN 2142 of the wireless system. The connection 2103b can comprise a local wireless connection, such as a connection consistent with any IEEE 802.11 protocol (e.g., [IEEE80211] and variants thereof), wherein the AP 2133 would comprise a WiFi router. Additionally or alternatively, the UEs 2110 can be configured to communicate using suitable communication signals with each other or with any of the AP 2133 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and the like; or Quadrature Amplitude Modulation (QAM) such as M-QAM; and/or the like.

The one or more NANs 2131 and 2132 that enable the connections 2103a may be referred to as “RAN nodes” or the like. The RAN nodes 2131, 2132 may comprise ground stations (e.g., terrestrial access points) or satellite stations providing coverage within a geographic area (e.g., a cell). The RAN nodes 2131, 2132 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 2131 is embodied as a NodeB, evolved NodeB (eNB), or a next generation NodeB (gNB), and the RAN nodes 2132 are embodied as relay nodes, distributed units, or Road Side Unites (RSUs). Any other type of NANs can be used.

Any of the RAN nodes 2131, 2132 can terminate the air interface protocol and can be the first point of contact for the UEs 2112 and IoT devices 2111. Additionally or alternatively, any of the RAN nodes 2131, 2132 can fulfill various logical functions for the RAN including, but not limited to, RAN function(s) (e.g., radio network controller (RNC) functions and/or NG-RAN functions) for radio resource management, admission control, UL and DL dynamic resource allocation, radio bearer management, data packet scheduling, and the like Additionally or alternatively, the UEs 2110 can be configured to communicate using OFDM communication signals with each other or with any of the NANs 2131, 2132 over a multicarrier communication channel in accordance with various communication techniques, such as, but not limited to, an OFDMA communication technique (e.g., for DL communications) and/or an SC-FDMA communication technique (e.g., for UL and ProSe or sidelink communications), although the scope of the present disclosure is not limited in this respect.

For most cellular communication systems, the RAN function(s) operated by a RAN or individual NANs 2131-2132 organize DL transmissions (e.g., from any of the RAN nodes 2131, 2132 to the UEs 2110) and UL transmissions (e.g., from the UEs 2110 to RAN nodes 2131, 2132) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g., PRBs and modulation and coding schemes (MCS)) to each UE 2110 at each transmission time interval (TTI). A TTI is the duration of a transmission on a radio link 2103a, 2105, and is related to the size of the data blocks passed to the radio link layer from higher network layers.

The NANs 2131, 2132 may be configured to communicate with one another via respective interfaces or links (not shown), such as an X2 interface for LTE implementations (e.g., when CN 2142 is an Evolved Packet Core (EPC)), an Xn interface for 5G or NR implementations (e.g., when CN 2142 is an Fifth Generation Core (5GC)), or the like. The NANs 2131 and 2132 are also communicatively coupled to CN 2142. Additionally or alternatively, the CN 2142 may be an evolved packet core (EPC)network, a NextGen Packet Core (NPC) network, a 5G core (5GC), or some other type of CN. The CN 2142 is a network of network elements and/or network functions (NFs) relating to a part of a communications network that is independent of the connection technology used by a terminal or user device. The CN 2142 comprises a plurality of network elements/NFs configured to offer various data and telecommunications services to customers/subscribers (e.g., users of UEs 2112 and IoT devices 2111) who are connected to the CN 2142 via a RAN. The components of the CN 2142 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 2142 may be referred to as a network slice, and a logical instantiation of a portion of the CN 2142 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 2142 components/functions.

The CN 2142 is shown to be communicatively coupled to an application server 2150 and a network 2150 via an IP communications interface 2155. the one or more server(s) 2150 comprise one or more physical and/or virtualized systems for providing functionality (or services) to one or more clients (e.g., UEs 2112 and IoT devices 2111) over a network. The server(s) 2150 may include various computer devices with rack computing architecture component(s), tower computing architecture component(s), blade computing architecture component(s), and/or the like. The server(s) 2150 may represent a cluster of servers, a server farm, a cloud computing service, or other grouping or pool of servers, which may be located in one or more datacenters. The server(s) 2150 may also be connected to, or otherwise associated with one or more data storage devices (not shown). Moreover, the server(s) 2150 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 2150 offer applications or services that use IP/network resources. As examples, the server(s) 2150 may provide traffic management services, cloud analytics, content streaming services, immersive gaming experiences, social networking and/or microblogging services, and/or other like services. In addition, the various services provided by the server(s) 2150 may include initiating and controlling software and/or firmware updates for applications or individual components implemented by the UEs 2112 and IoT devices 2111. The server(s) 2150 can also be configured to support one or more communication services (e.g., Voice-over-Internet Protocol (VoIP) sessions, PTT sessions, group communication sessions, social networking services, and the like) for the UEs 2112 and IoT devices 2111 via the CN 2142.

The Radio Access Technologies (RATs) employed by the NANs 2130, the UEs 2110, and the other elements in FIG. 21 may include, for example, any of the communication protocols and/or RATs discussed herein. Different technologies exhibit benefits and limitations in different scenarios, and application performance in different scenarios becomes dependent on the choice of the access networks (e.g., WiFi, LTE, and the like) and the used network and transport protocols (e.g., Transfer Control Protocol (TCP), Virtual Private Network (VPN), Multi-Path TCP (MPTCP), Generic Routing Encapsulation (GRE), and the like). These RATs may include one or more V2X RATs, which allow these elements to communicate directly with one another, with infrastructure equipment (e.g., NANs 2130), and other devices. In some implementations, at least two distinct V2X RATs may be used including WLAN V2X (W-V2X) RAT based on IEEE V2X technologies (e.g., DSRC for the U.S. and ITS-G5 for Europe) and 3GPP C-V2X RAT (e.g., LTE, 5G/NR, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”), V2X Communications Message Set Dictionary, SAE INT'L (23 Jul. 2020) (“[J2735_202007]”), Intelligent Transport Systems in the 5 GHz frequency band (ITS-G5), the [IEEE8021Ip] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020-01) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018-04) (“[TS102687]”). The access layer for 3GPP LTE-V2X based interface(s) is outlined in, inter alia, ETSI EN 303 613 V1.1.1 (2020-01), 3GPP TS 23.285 v16.2.0 (2019-12); and 3GPP 5G/NR-V2X is outlined in, inter alia, 3GPP TR 23.786 v16.1.0 (2019-06) and 3GPP TS 23.287 v16.2.0 (2020-03).

The cloud 2144 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. Cloud computing provides cloud computing services (or cloud services), which are one or more capabilities offered via cloud computing that are invoked using a defined interface (e.g., an API or the like). Some capabilities of cloud 2144 include application capabilities type, infrastructure capabilities type, and platform capabilities type. A cloud capabilities type is a classification of the functionality provided by a cloud service to a cloud service customer (e.g., a user of cloud 2144), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 2144 may provide include, for example, Communications as a Service (CaaS), which is a cloud service category involving real-time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service (FaaS), which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (SaaS), which is a cloud service category involving the application capabilities type; Security as a Service, which is a cloud service category involving providing network and information security (infosec) services; and/or other like cloud services.

Additionally or alternatively, the cloud 2144 may represent one or more cloud servers, application servers, web servers, and/or some other remote infrastructure. The to remote/cloud servers may include any one of a number of services and capabilities such as, for example, any of those discussed herein. Additionally or alternatively, the cloud 2144 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 2144 may be a network that comprises computers, network connections among the computers, and software routines to enable communication between the computers over network connections. In this regard, the cloud 2144 comprises one or more network elements that may include one or more processors, communications systems (e.g., including network interface controllers, one or more transmitters/receivers connected to one or more antennas, and the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 2144 may be via a wired or a wireless connection using the various communication protocols discussed infra. More than one network may be involved in a communication session between the illustrated devices. Connection to the cloud 2144 may require that the computers execute software routines which enable, for example, the seven layers of the OSI model of computer networking or equivalent in a wireless (cellular) phone network. Cloud 2144 may be used to enable relatively long-range communication such as, for example, between the one or more server(s) 2150 and one or more UEs 2110. Additionally or alternatively, the cloud 2144 may represent the Internet, one or more cellular networks, local area networks, or wide area networks including proprietary and/or enterprise networks, TCP/Internet Protocol (IP)-based network, or combinations thereof. In these implementations, the cloud 2144 may be associated with network operator who owns or controls equipment and other elements necessary to provide network-related services, such as one or more base stations or access points, one or more servers for routing digital data or telephone calls (e.g., a core network or backbone network), and the like The backbone links 2155 may include any number of wired or wireless technologies, and may be part of a LAN, a WAN, or the Internet. In one example, the backbone links 2155 are fiber backbone links that couple lower levels of service providers to the Internet, such as the CN 2112 and cloud 2144.

As shown by FIG. 21, each of the NANs 2131, 2132, and 2133 are co-located with edge compute nodes (or “edge servers”) 2136a, 2136b, and 2136c, respectively. These implementations may be small-cell clouds (SCCs) where an edge compute node 2136 is co-located with a small cell (e.g., pico-cell, femto-cell, and the like), or may be mobile micro clouds (MCCs) where an edge compute node 2136 is co-located with a macro-cell (e.g., an eNB, gNB, and the like). The edge compute node 2136 may be deployed in a multitude of arrangements other than as shown by FIG. 21. In a first example, multiple NANs 2130 are co-located or otherwise communicatively coupled with one edge compute node 2136. In a second example, the edge servers 2136 may be co-located or operated by RNCs, which may be the case for legacy network deployments, such as 3G networks. In a third example, the edge servers 2136 may be deployed at cell aggregation sites or at multi-RAT aggregation points that can be located either within an enterprise or used in public coverage areas. In a fourth example, the edge servers 2136 may be deployed at the edge of CN 2142. These implementations may be used in follow-me clouds (FMC), where cloud services running at distributed data centers follow the UEs 2110 as they roam throughout the network.

In any of the implementations discussed herein, the edge servers 2136 provide a distributed computing environment for application and service hosting, and also provide storage and processing resources so that data and/or content can be processed in close proximity to subscribers (e.g., users of UEs 2110) for faster response times The edge servers 2136 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 2136 from the UEs 2110, CN 2142, cloud 2144, and/or server(s) 2150, or vice versa. For example, a device application or client application operating in a UE 2110 may offload application tasks or workloads to one or more edge servers 2136. In another example, an edge server 2136 may offload application tasks or workloads to one or more UE 2110 (e.g., for distributed ML computation or the like).

The edge compute nodes 2136 may include or be part of an edge system 2135 that employs one or more ECTs 2135. The edge compute nodes 2136 may also be referred to as “edge hosts 2136” or “edge servers 2136.” The edge system 2135 includes a collection of edge servers 2136 and edge management systems (not shown by FIG. 21) necessary to run edge computing applications within an operator network or a subset of an operator network. The edge servers 2136 are physical computer systems that may include an edge platform and/or virtualization infrastructure, and provide compute, storage, and network resources to edge computing applications. Each of the edge servers 2136 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 2110. The VI of the edge servers 2136 provide virtualized environments and virtualized resources for the edge hosts, and the edge computing applications may run as VMs and/or application containers on top of the VI.

In one example implementation, the ECT 2135 is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1 (2020-12), ETSI GS MEC 012 V2.2.1 (2022-02), ETSI GS MEC 013 V2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 V2.2.1 (2021-07), ETSI GS MEC 029 v2.2.1 (2022-01), ETSI MEC GS 030 v2.1.1 (2020-04), ETSI GR MEC 031 v2.1.1 (2020-10), U.S. Provisional App. No. 63/003,834 filed Apr. 1, 2020 (“[US'834]”), and Int'l App. No. PCT/US2020/066969 filed on Dec. 23, 2020 (“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021-03), ETSI GS NFV 002 V1.2.1 (2014-12), ETSI GR NFV 003 V1.6.1 (2021-03), ETSI GS NFV 006 V2.1.1 (2021-01), ETSI GS NFV-INF 001 V1.1.1 (2015-01), ETSI GS NFV-INF 003 V1.1.1 (2014-12), ETSI GS NFV-INF 004 V1.1.1 (2015-01), ETSI GS NFV-MAN 001 v1.1.1 (2014-12), and/or Israel et al., OSM Release FIVE Technical Overview, ETSI OPEN SOURCE MANO, OSM White Paper, 1st ed. (Jan. 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.2.0 (2022-03-22) (“[TS28533]”), the contents of each of which are hereby incorporated by reference in their entireties.

In another example implementation, the ECT 2135 is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v05.00, O-RAN ALLIANCE WG1 (Jul. 2021); O-RAN Operations and Maintenance Architecture Specification v04.00, O-RAN ALLIANCE WG1 (Nov. 2020); O-RAN Operations and Maintenance Interface Specification v04.00, O-RAN ALLIANCE WG1 (Nov. 2020); O-RAN Information Model and Data Models Specification v01.00, O-RAN ALLIANCE WG1 (Nov. 2020); O-RAN Working Group 1 Slicing Architecture v05.00, O-RAN ALLIANCE WG1 (Jul. 2021); O-RAN Working Group 2 (Non-RT RIC and AI interface WG) AI interface: Application Protocol v03.01, O-RAN ALLIANCE WG2 (Mar. 2021); O-RAN Working Group 2 (Non-RT RIC and AI interface WG) AI interface: Type Definitions v02.00, O-RAN ALLIANCE WG2 (Jul. 2021); O-RAN Working Group 2 (Non-RT RIC and A] interface WG) A] interface: Transport Protocol v01.01, O-RAN ALLIANCE WG2 (Mar. 2021); O-RAN Working Group 2 AI/ML workflow description and requirements v01.03 O-RAN ALLIANCE WG2 (Jul. 2021); O-RAN Working Group 2 Non-RT RIC: Functional Architecture v01.03 O-RAN ALLIANCE WG2 (Jul. 2021); O-RAN Working Group 3, Near-Real-time Intelligent Controller, E2 Application Protocol (E2AP) v02.00, O-RAN ALLIANCE WG3 (Jul. 2021); O-RAN Working Group 3 Near-Real-time Intelligent Controller Architecture & E2 General Aspects and Principles v02.00, O-RAN ALLIANCE WG3 (Jul. 2021); O-RAN Working Group 3 Near-Real-time Intelligent Controller E2 Service Model (E2SM) v02.00, O-RAN ALLIANCE WG3 (Jul. 2021); O-RAN Working Group 3 Near-Real-time Intelligent Controller E2 Service Model (E2SM) KPM v02.00, O-RAN ALLIANCE WG3 (Jul. 2021); O-RAN Working Group 3 Near-Real-time Intelligent Controller E2 Service Model (E2SM) RANFunction Network Interface (NI) v01.00, O-RAN ALLIANCE WG3 (Feb. 2020); O-RAN Working Group 3 Near-Real-time Intelligent Controller E2 Service Model (E2SM) RAN Control v01.00, O-RAN ALLIANCE WG3 (Jul. 2021); O-RAN Working Group 3 Near-Real-time Intelligent Controller Near-RT RIC Architecture v02.00, O-RAN ALLIANCE WG3 (Mar. 2021); O-RAN Fronthaul Working Group 4 Cooperative Transport Interface Transport Control Plane Specification v02.00, O-RAN ALLIANCE WG4 (Mar. 2021); O-RAN Fronthaul Working Group 4 Cooperative Transport Interface Transport Management Plane Specification v02.00, O-RAN ALLIANCE WG4 (Mar. 2021); O-RAN Fronthaul Working Group 4 Control, User, and Synchronization Plane Specification v07.00, O-RAN ALLIANCE WG4 (Jul. 2021); O-RAN Fronthaul Working Group 4 Management Plane Specification v07.00, O-RAN ALLIANCE WG4 (Jul. 2021); O-RAN Open F]/WI/El/X2/Xn Interfaces Working Group Transport Specification v01.00, O-RAN ALLIANCE WG5 (Apr. 2020); O-RANAlliance Working Group 5 O] Interface specification for O-DUv02.00, O-RAN ALLIANCE WGX (Jul. 2021); Cloud Architecture and Deployment Scenarios for 0-RAN Virtualized RAN v02.02, O-RAN ALLIANCE WG6 (Jul. 2021); O-RAN Acceleration Abstraction Layer General Aspects and Principles v01.01, O-RAN ALLIANCE WG6 (Jul. 2021); Cloud Platform Reference Designs v02.00, O-RAN ALLIANCE WG6 (Nov. 2020); O-RAN 02 Interface General Aspects and Principles v01.01, O-RAN ALLIANCE WG6 (Jul. 2021); O-RAN White Box Hardware Working Group Hardware Reference Design Specification for Indoor Pico Cell with Fronthaul Split Option 6 v02.00, O-RAN ALLIANCE WG7 (Jul. 2021); O-RAN WG7 Hardware Reference Design Specification for Indoor Picocell (FR]) with Split Option 7-2 v03.00, O-RAN ALLIANCE WG7 (Jul. 2021); O-RAN WG7Hardware Reference Design Specification for Indoor Picocell (FR]) with Split Option 8 v03.00, O-RAN ALLIANCE WG7 (Jul. 2021); O-RAN Open Transport Working Group 9 Xhaul Packet Switched Architectures and Solutions v02.00, O-RAN ALLIANCE WG9 (Jul. 2021); O-RAN Open X-haul Transport Working Group Management interfaces for Transport Network Elements v02.00, O-RAN ALLIANCE WG9 (Jul. 2021); O-RAN Open X-haul Transport WG9 WDM-based Fronthaul Transport v01.00, O-RAN ALLIANCE WG9 (Nov. 2020); O-RAN Open X-haul Transport Working Group Synchronization Architecture and Solution Specification v01.00, O-RAN ALLIANCE WG9 (Mar. 2021); O-RAN Operations and Maintenance Interface Specification v05.00, O-RAN ALLIANCE WG10 (Jul. 2021); O-RAN Operations and Maintenance Architecture v05.00, O-RAN ALLIANCE WG10 (Jul. 2021); O-RAN: Towards an Open and Smart RAN, O-RAN ALLIANCE, White Paper (Oct. 2018), and U.S. application Ser. No. 17/484,743 filed on 24 Sep. 2021 (“[US'743]”) (collectively referred to as “[O-RAN]”); the contents of each of which are hereby incorporated by reference in their entireties.

In another example implementation, the ECT 2135 is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.2.0 (2021-12-31), 3GPP TS 23.501 v17.6.0 (2022-09-22) (“[TS23501]”), 3GPP TS 28.538 v17.1.0 (2022-06-16) (“[TS28538]”), and U.S. application Ser. No. 17/484,719 filed on 24 Sep. 2021 (“[US'719]”) (collectively referred to as “[SA6Edge]”), the contents of each of which are hereby incorporated by reference in their entireties.

In another example implementation, the ECT 2135 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISEO]”), the contents of which is hereby incorporated by reference in its entirety.

In another example implementation, the ECT 2135 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (Mar. 2020) (“[RFC8743]”), Ford et al., TCP ExtensionsforMultipath Operation withMultiple Addresses, IETF RFC 8684, (Mar. 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (Feb. 2022) (collectively referred to as “[MAMS]”), the contents of each of which are hereby incorporated by reference in their entireties. In these implementations, an edge compute node 2135 and/or one or more cloud computing nodes/clusters may be one or more MAMS servers that includes or operates a Network Connection Manager (NCM) for downstream/DL traffic, and the individual UEs 2110 include or operate a Client Connection Manager (CCM) for upstream/UL traffic. An NCM is a functional entity that handles MAMS control messages from clients (e.g., individual UEs 2110 configures the distribution of data packets over available access paths and (core) network paths, and manages user-plane treatment (e.g., tunneling, encryption, and/or the like) of the traffic flows (see e.g., [RFC8743], [MAMS]). The CCM is the peer functional element in a client (e.g., individual UEs 2110 that handles MAMS control-plane procedures, exchanges MAMS signaling messages with the NCM, and configures the network paths at the client for the transport of user data (e.g., network packets, and/or the like) (see e.g., [RFC8743], [MAMS]).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

### 7. Cellular Network Aspects

FIG. 22 illustrates an example network architecture 2200. The network 2200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 2200 includes a UE 2202, which is any mobile or non-mobile computing device designed to communicate with a RAN 2204 via an over-the-air connection. The UE 2202 is communicatively coupled with the RAN 2204 by a Uu interface, which may be applicable to both LTE and NR systems. Examples of the UE 2202 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 2200 may include a plurality of UEs 2202 coupled directly with one another via a D2D, ProSe, PC5, and/or sidelink (SL) interface. These UEs 2202 may be M2M/D2D/MTC/IoT devices and/or vehicular systems that communicate using physical sidelink channels such as, but not limited to, PSBCH, PSDCH, PSSCH, PSCCH, PSFCH, and/or the like. The UE 2202 may perform blind decoding attempts of SL channels/links according to the various embodiments herein.

In some embodiments, the UE 2202 may additionally communicate with an AP 2206 via an over-the-air (OTA) connection. The AP 2206 manages a WLAN connection, which may serve to offload some/all network traffic from the RAN 2204. The connection between the UE 2202 and the AP 2206 may be consistent with any IEEE 802.11 protocol. Additionally, the UE 2202, RAN 2204, and AP 2206 may utilize cellular-WLAN aggregation/integration (e.g., LWA/LWIP). Cellular-WLAN aggregation may involve the UE 2202 being configured by the RAN 2204 to utilize both cellular radio resources and WLAN resources.

The RAN 2204 includes one or more access network nodes (ANs) 2208. The ANs 2208 terminate air-interface(s) for the UE 2202 by providing access stratum protocols including RRC, PDCP, RLC, MAC, and PHY/L1 protocols. In this manner, the AN 2208 enables data/voice connectivity between CN 2220 and the UE 2202. The ANs 2208 may be a macrocell base station or a low power base station for providing femtocells, picocells or other like cells having smaller coverage areas, smaller user capacity, or higher bandwidth compared to macrocells; or some combination thereof. In these implementations, an AN 2208 be referred to as a BS, gNB, RAN node, eNB, ng-eNB, NodeB, RSU, TRxP, and/or the like

One example implementation is a “CU/DU split” architecture where the ANs 2208 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 2208 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 2204 is an LTE RAN or Evolved Universal Terrestrial Radio Access Network (E-UTRAN) 2210) or an Xn interface (if the RAN 2204 is a NG-RAN 2214). The X2/Xn interfaces, which may be separated into control/user plane interfaces in some embodiments, may allow the ANs to communicate information related to handovers, data/context transfers, mobility, load management, interference coordination, and/or the like

The ANs of the RAN 2204 may each manage one or more cells, cell groups, component carriers, and/or the like to provide the UE 2202 with an air interface for network access. The UE 2202 may be simultaneously connected with a plurality of cells provided by the same or different ANs 2208 of the RAN 2204. For example, the UE 2202 and RAN 2204 may use carrier aggregation to allow the UE 2202 to connect with a plurality of component carriers, each corresponding to a Pcell or Scell. In dual connectivity scenarios, a first AN 2208 may be a master node that provides an MCG and a second AN 2208 may be secondary node that provides an SCG. The first/second ANs 2208 may be any combination of eNB, gNB, ng-eNB, and/or the like.

The RAN 2204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 2202 or AN 2208 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 2204 may be an E-UTRAN 2210 with one or more eNBs 2212. The an E-UTRAN 2210 provides an LTE air interface (Uu) with the following characteristics: SCS of 15 kHz; CP-OFDM waveform for DL and SC-FDMA waveform for UL; turbo codes for data and TBCC for control; and/or the like. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 2204 may be an next generation (NG)-RAN 2214 with one or more gNB 2216 and/or on or more ng-eNB 2218. The gNB 2216 connects with 5G-enabled UEs 2202 using a 5G NR interface. The gNB 2216 connects with a 5GC 2240 through an NG interface, which includes an N2 interface or an N3 interface. The ng-eNB 2218 also connects with the 5GC 2240 through an NG interface, but may connect with a UE 2202 via the Uu interface. The gNB 2216 and the ng-eNB 2218 may connect with each other over an Xn interface.

In some embodiments, the NG interface may be split into two parts, an NG user plane (NG-U) interface, which carries traffic data between the nodes of the NG-RAN 2214 and a UPF 2248 (e.g., N3 interface), and an NG control plane (NG-C) interface, which is a signaling interface between the nodes of the NG-RAN 2214 and an AMF 2244 (e.g., N2 interface).

The NG-RAN 2214 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 2202 can be configured with multiple BWPs where each BWP configuration has a different SCS. When a BWP change is indicated to the UE 2202, the SCS of the transmission is changed as well. Another use case example of BWP is related to power saving. In particular, multiple BWPs can be configured for the UE 2202 with different amount of frequency resources (e.g., PRBs) to support data transmission under different traffic loading scenarios. A BWP containing a smaller number of PRBs can be used for data transmission with small traffic load while allowing power saving at the UE 2202 and in some cases at the gNB 2216. A BWP containing a larger number of PRBs can be used for scenarios with higher traffic load.

The RAN 2204 is communicatively coupled to CN 2220 that includes network elements and/or network functions (NFs) to provide various functions to support data and telecommunications services to customers/subscribers (e.g., UE 2202). The components of the CN 2220 may be implemented in one physical node or separate physical nodes. In some embodiments, NFV may be utilized to virtualize any or all of the functions provided by the network elements of the CN 2220 onto physical compute/storage resources in servers, switches, and/or the like. A logical instantiation of the CN 2220 may be referred to as a network slice, and a logical instantiation of a portion of the CN 2220 may be referred to as a network sub-slice.

The CN 2220 may be an LTE CN 2222 (also referred to as an Evolved Packet Core (EPC) 2222). The EPC 2222 may include MME 2224, SGW 2226, SGSN 2228, HSS 2230, PGW 2232, and PCRF 2234 coupled with one another over interfaces (or “reference points”) as shown. The NFs in the EPC 2222 are briefly introduced as follows.

The MME 2224 implements mobility management functions to track a current location of the UE 2202 to facilitate paging, bearer activation/deactivation, handovers, gateway selection, authentication, and/or the like.

The SGW 2226 terminates an S1 interface toward the RAN 2210 and routes data packets between the RAN 2210 and the EPC 2222. The SGW 2226 may be a local mobility anchor point for inter-RAN node handovers and also may provide an anchor for inter-3GPP mobility. Other responsibilities may include lawful intercept, charging, and some policy enforcement.

The SGSN 2228 tracks a location of the UE 2202 and performs security functions and access control. The SGSN 2228 also performs inter-EPC node signaling for mobility between different RAT networks; PDN and S-GW selection as specified by MME 2224; MME 2224 selection for handovers; and/or the like. The S3 reference point between the MME 2224 and the SGSN 2228 enable user and bearer information exchange for inter-3GPP access network mobility in idle/active states.

The HSS 2230 includes a database for network users, including subscription-related information to support the network entities' handling of communication sessions. The HSS 2230 can provide support for routing/roaming, authentication, authorization, naming/addressing resolution, location dependencies, and/or the like. An S6a reference point between the HSS 2230 and the MME 2224 may enable transfer of subscription and authentication data for authenticating/authorizing user access to the EPC 2220.

The PGW 2232 may terminate an SGi interface toward a data network (DN) 2236 that may include an application (app)/content server 2238. The PGW 2232 routes data packets between the EPC 2222 and the data network 2236. The PGW 2232 is communicatively coupled with the SGW 2226 by an S5 reference point to facilitate user plane tunneling and tunnel management. The PGW 2232 may further include a node for policy enforcement and charging data collection (e.g., PCEF). Additionally, the SGi reference point may communicatively couple the PGW 2232 with the same or different data network 2236. The PGW 2232 may be communicatively coupled with a PCRF 2234 via a Gx reference point.

The PCRF 2234 is the policy and charging control element of the EPC 2222.

The PCRF 2234 is communicatively coupled to the app/content server 2238 to determine appropriate QoS and charging parameters for service flows. The PCRF 2232 also provisions associated rules into a PCEF (via Gx reference point) with appropriate TFT and QCI.

The CN 2220 may be a 5GC 2240 including an AUSF 2242, AMF 2244, SMF 2246, UPF 2248, NSSF 2250, NEF 2252, NRF 2254, PCF 2256, UDM 2258, and AF 2260 coupled with one another over various interfaces as shown. The NFs in the 5GC 2240 are briefly introduced as follows.

The AUSF 2242 stores data for authentication of UE 2202 and handle authentication-related functionality. The AUSF 2242 may facilitate a common authentication framework for various access types..

The AMF 2244 allows other functions of the 5GC 2240 to communicate with the UE 2202 and the RAN 2204 and to subscribe to notifications about mobility events with respect to the UE 2202. The AMF 2244 is also responsible for registration management (e.g., for registering UE 2202), connection management, reachability management, mobility management, lawful interception of AMF-related events, and access authentication and authorization. The AMF 2244 provides transport for SM messages between the UE 2202 and the SMF 2246, and acts as a transparent proxy for routing SM messages. AMF 2244 also provides transport for SMS messages between UE 2202 and an SMSF. AMF 2244 interacts with the AUSF 2242 and the UE 2202 to perform various security anchor and context management functions. Furthermore, AMF 2244 is a termination point of a RAN-CP interface, which includes the N2 reference point between the RAN 2204 and the AMF 2244. The AMF 2244 is also a termination point of NAS (N1) signaling, and performs NAS ciphering and integrity protection.

AMF 2244 also supports NAS signaling with the UE 2202 over an N3IWF interface. The N3IWF provides access to untrusted entities. N3IWF may be a termination point for the N2 interface between the (R)AN 2204 and the AMF 2244 for the control plane, and may be a termination point for the N3 reference point between the (R)AN 2214 and the 2248 for the user plane. As such, the AMF 2244 handles N2 signaling from the SMF 2246 and the AMF 2244 for PDU sessions and QoS, encapsulate/de-encapsulate packets for IPSec and N3 tunneling, marks N3 user-plane packets in the uplink, and enforces QoS corresponding to N3 packet marking taking into account QoS requirements associated with such marking received over N2. N3IWF may also relay UL and DL control-plane NAS signaling between the UE 2202 and AMF 2244 via an N1 reference point between the UE 2202 and the AMF 2244, and relay uplink and downlink user-plane packets between the UE 2202 and UPF 2248. The N3IWF also provides mechanisms for IPsec tunnel establishment with the UE 2202. The AMF 2244 may exhibit an Namf service-based interface, and may be a termination point for an N14 reference point between two AMFs 2244 and an N17 reference point between the AMF 2244 and a 5G-EIR (not shown by FIG. 22).

The SMF 2246 is responsible for SM (e.g., session establishment, tunnel management between UPF 2248 and AN 2208); UE IP address allocation and management (including optional authorization); selection and control of UP function; configuring traffic steering at UPF 2248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 2244 over N2 to AN 2208; and determining SSC mode of a session. SM refers to management of a PDU session, and a PDU session or “session” refers to a PDU connectivity service that provides or enables the exchange of PDUs between the UE 2202 and the DN 2236.

The UPF 2248 acts as an anchor point for intra-RAT and inter-RAT mobility, an external PDU session point of interconnect to data network 2236, and a branching point to support multi-homed PDU session. The UPF 2248 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 2248 may include an uplink classifier to support routing traffic flows to a data network.

The NSSF 2250 selects a set of network slice instances serving the UE 2202. The NSSF 2250 also determines allowed NSSAI and the mapping to the subscribed S-NSSAIs, if needed. The NSSF 2250 also determines an AMF set to be used to serve the UE 2202, or a list of candidate AMFs 2244 based on a suitable configuration and possibly by querying the NRF 2254. The selection of a set of network slice instances for the UE 2202 may be triggered by the AMF 2244 with which the UE 2202 is registered by interacting with the NSSF 2250; this may lead to a change of AMF 2244. The NSSF 2250 interacts with the AMF 2244 via an N22 reference point; and may communicate with another NSSF in a visited network via an N31 reference point (not shown).

The NEF 2252 securely exposes services and capabilities provided by 3GPP NFs for third party, internal exposure/re-exposure, AFs 2260, edge computing or fog computing systems (e.g., edge compute node, and/or the like. In such embodiments, the NEF 2252 may authenticate, authorize, or throttle the AFs. NEF 2252 may also translate information exchanged with the AF 2260 and information exchanged with internal network functions. For example, the NEF 2252 may translate between an AF-Service-Identifier and an internal 5GC information. NEF 2252 may also receive information from other NFs based on exposed capabilities of other NFs. This information may be stored at the NEF 2252 as structured data, or at a data storage NF using standardized interfaces. The stored information can then be re-exposed by the NEF 2252 to other NFs and AFs, or used for other purposes such as analytics.

The NRF 2254 supports service discovery functions, receives NF discovery requests from NF instances, and provides information of the discovered NF instances to the requesting NF instances. NRF 2254 also maintains information of available NF instances and their supported services. The NRF 2254 also supports service discovery functions, wherein the NRF 2254 receives NF Discovery Request from NF instance or an SCP (not shown), and provides information of the discovered NF instances to the NF instance or SCP.

The PCF 2256 provides policy rules to control plane functions to enforce them, and may also support unified policy framework to govern network behavior. The PCF 2256 may also implement a front end to access subscription information relevant for policy decisions in a UDR of the UDM 2258. In addition to communicating with functions over reference points as shown, the PCF 2256 exhibit an Npcf service-based interface.

The UDM 2258 handles subscription-related information to support the network entities' handling of communication sessions, and stores subscription data of UE 2202. For example, subscription data may be communicated via an N8 reference point between the UDM 2258 and the AMF 2244. The UDM 2258 may include two parts, an application front end and a UDR. The UDR may store subscription data and policy data for the UDM 2258 and the PCF 2256, and/or structured data for exposure and application data (including PFDs for application detection, application request information for multiple UEs 2202) for the NEF 2252. The Nudr service-based interface may be exhibited by the UDR 221 to allow the UDM 2258, PCF 2256, and NEF 2252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 2258 may exhibit the Nudm service-based interface.

AF 2260 provides application influence on traffic routing, provide access to NEF 2252, and interact with the policy framework for policy control. The AF 2260 may influence UPF 2248 (re)selection and traffic routing. Based on operator deployment, when AF 2260 is considered to be a trusted entity, the network operator may permit AF 2260 to interact directly with relevant NFs. Additionally, the AF 2260 may be used for edge computing implementations,

The 5GC 2240 may enable edge computing by selecting operator/3rd party services to be geographically close to a point that the UE 2202 is attached to the network. This may reduce latency and load on the network. In edge computing implementations, the 5GC 2240 may select a UPF 2248 close to the UE 2202 and execute traffic steering from the UPF 2248 to DN 2236 via the N6 interface. This may be based on the UE subscription data, UE location, and information provided by the AF 2260, which allows the AF 2260 to influence UPF (re)selection and traffic routing.

The data network (DN) 2236 may represent various network operator services, Internet access, or third party services that may be provided by one or more servers including, for example, application (app)/content server 2238. The DN 2236 may be an operator external public, a private PDN, or an intra-operator packet data network, for example, for provision of IMS services. In this embodiment, the app server 2238 can be coupled to an IMS via an S-CSCF or the I-CSCF. In some implementations, the DN 2236 may represent one or more local area DNs (LADNs), which are DNs 2236 (or DN names (DNNs)) that is/are accessible by a UE 2202 in one or more specific areas. Outside of these specific areas, the UE 2202 is not able to access the LADN/DN 2236.

Additionally or alternatively, the DN 2236 may be an Edge DN 2236, which is a (local) Data Network that supports the architecture for enabling edge applications. In these embodiments, the app server 2238 may represent the physical hardware systems/devices providing app server functionality and/or the application software resident in the cloud or at an edge compute node that performs server function(s). In some embodiments, the app/content server 2238 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 2210, 2214. For example, the edge compute nodes can provide a connection between the RAN 2214 and UPF 2248 in the 5GC 2240. The edge compute nodes can use one or more NFV instances instantiated on virtualization infrastructure within the edge compute nodes to process wireless connections to and from the RAN 2214 and UPF 2248.

The interfaces of the 5GC 2240 include reference points and service-based interfaces. The reference points include: N1 (between the UE 2202 and the AMF 2244), N2 (between RAN 2214 and AMF 2244), N3 (between RAN 2214 and UPF 2248), N4 (between the SMF 2246 and UPF 2248), N5 (between PCF 2256 and AF 2260), N6 (between UPF 2248 and DN 2236), N7 (between SMF 2246 and PCF 2256), N8 (between UDM 2258 and AMF 2244), N9 (between two UPFs 2248), N10 (between the UDM 2258 and the SMF 2246), N11 (between the AMF 2244 and the SMF 2246), N12 (between AUSF 2242 and AMF 2244), N13 (between AUSF 2242 and UDM 2258), N14 (between two AMFs 2244; not shown), N15 (between PCF 2256 and AMF 2244 in case of a non-roaming scenario, or between the PCF 2256 in a visited network and AMF 2244 in case of a roaming scenario), N16 (between two SMFs 2246; not shown), and N22 (between AMF 2244 and NSSF 2250). Other reference point representations not shown in FIG. 22 can also be used. The service-based representation of FIG. 22 represents NFs within the control plane that enable other authorized NFs to access their services. The service-based interfaces (SBIs) include: Namf (SBI exhibited by AMF 2244), Nsmf (SBI exhibited by SMF 2246), Nnef (SBI exhibited by NEF 2252), Npcf (SBI exhibited by PCF 2256), Nudm (SBI exhibited by the UDM 2258), Naf (SBI exhibited by AF 2260), Nnrf (SBI exhibited by NRF 2254), Nnssf (SBI exhibited by NSSF 2250), Nausf (SBI exhibited by AUSF 2242). Other service-based interfaces (e.g., Nudr, N5g-eir, and Nudsf) not shown in FIG. 22 can also be used. In some embodiments, the NEF 2252 can provide an interface to edge compute nodes 2236x, which can be used to process wireless connections with the RAN 2214.

In some implementations, the system 2200 may include an SMSF, which is responsible for SMS subscription checking and verification, and relaying SM messages to/from the UE 2202 to/from other entities, such as an SMS-GMSC/IWMSC/SMS-router. The SMS may also interact with AMF 2242 and UDM 2258 for a notification procedure that the UE 2202 is available for SMS transfer (e.g., set a UE not reachable flag, and notifying UDM 2258 when UE 2202 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501 v17.7.0 (2022-09-22)), load balancing, monitoring, overload control, and/or the like; and discovery and selection functionality for UDM(s), AUSF(s), UDR(s), PCF(s) with access to subscription data stored in the UDR based on UE's SUPI, SUCI or GPSI (see e.g., [TS23501] § 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

### 8. Software Distribution Systems

FIG. 23 illustrates an example software distribution platform 2305 to distribute software 2360, such as the example computer readable instructions 2460 of FIG. 24, to one or more devices, such as example processor platform(s) 2300 and/or example connected edge devices 2462 (see e.g., FIG. 24) and/or any of the other computing systems/devices discussed herein. The example software distribution platform 2305 may be implemented by any computer server, data facility, cloud service, and the like, capable of storing and transmitting software to other computing devices (e.g., third parties, the example connected edge devices 2462 of FIG. 24). Example connected edge devices may be customers, clients, managing devices (e.g., servers), third parties (e.g., customers of an entity owning and/or operating the software distribution platform 2305). Example connected edge devices may operate in commercial and/or home automation environments. In some examples, a third party is a developer, a seller, and/or a licensor of software such as the example computer readable instructions 2460 of FIG. 24. The third parties may be consumers, users, retailers, OEMs, and the like that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), and the like).

In the illustrated example of FIG. 23, the software distribution platform 2305 includes one or more servers and one or more storage devices. The storage devices store the computer readable instructions 2360, which may correspond to the example computer readable instructions 2460 of FIG. 24, as described above. The one or more servers of the example software distribution platform 2305 are in communication with a network 2310, which may correspond to any one or more of the Internet and/or any of the example networks as described herein. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2360 from the software distribution platform 2305. For example, the software 2360, which may correspond to the example computer readable instructions 2460 of FIG. 24, may be downloaded to the example processor platform(s) 2300, which is/are to execute the computer readable instructions 2360 to implement Radio apps.

In some examples, one or more servers of the software distribution platform 2305 are communicatively connected to one or more security domains and/or security devices through which requests and transmissions of the example computer readable instructions 2360 must pass. In some examples, one or more servers of the software distribution platform 2305 periodically offer, transmit, and/or force updates to the software (e.g., the example computer readable instructions 2460 of FIG. 24) to ensure improvements, patches, updates, and the like are distributed and applied to the software at the end user devices.

In the illustrated example of FIG. 23, the computer readable instructions 2360 are stored on storage devices of the software distribution platform 2305 in a particular format. A format of computer readable instructions includes, but is not limited to a particular code language (e.g., Java, JavaScript, Python, C, C #, SQL, HTML, and the like), and/or a particular code state (e.g., uncompiled code (e.g., ASCII), interpreted code, linked code, executable code (e.g., a binary), and the like). In some examples, the computer readable instructions 2482 stored in the software distribution platform 2305 are in a first format when transmitted to the example processor platform(s) 2300. In some examples, the first format is an executable binary in which particular types of the processor platform(s) 2300 can execute. However, in some examples, the first format is uncompiled code that requires one or more preparation tasks to transform the first format to a second format to enable execution on the example processor platform(s) 2300. For instance, the receiving processor platform(s) 2300 may need to compile the computer readable instructions 2360 in the first format to generate executable code in a second format that is capable of being executed on the processor platform(s) 2300. In still other examples, the first format is interpreted code that, upon reaching the processor platform(s) 2300, is interpreted by an interpreter to facilitate execution of instructions.

### 9. Hardware Components

FIG. 24 illustrates an example of components that may be present in an compute node 2450 for implementing the techniques (e.g., operations, processes, methods, and methodologies) described herein. This compute node 2450 provides a closer view of the respective components of node 2450 when implemented as or as part of a computing device (e.g., as a mobile device, a base station, server, gateway, and/or the like). The compute node 2450 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the compute node 2450, or as components otherwise incorporated within a chassis of a larger system. The compute node 2450 may be embodied as a type of device, appliance, computer, or other “thing” capable of communicating with other edge, networking, or endpoint components. For example, compute node 2450 may be embodied as a smartphone, a mobile compute device, a smart appliance, an in-vehicle compute system (e.g., a navigation system), an edge compute node, a NAN, switch, router, bridge, hub, and/or other device or system capable of performing the described functions. In some examples, the compute node 2450 may correspond to the elements shown and described w.r.t FIGS. 1-7; network nodes R and/or servers H-1 to H-24 in FIGS. 8-11; the fabric controllers of FIGS. 9-11; the RUs/Low-PHY, DUs, IDUs, CU-CP entities, CU-CUP entities, N6 intranet elements, and N6 Internet elements in FIG. 11;

UEs 2110, NANs 2130, ECT 2135, edge compute nodes 2136, one or more network functions in CN 2142, one or more cloud compute nodes in cloud 2144, and/or server(s) 2150 of FIG. 21; software distribution platform 2305 and/or processor platform(s) 2300 of FIG. 23; and/or any other component, device, and/or system discussed herein.

The compute node 2450 includes processing circuitry in the form of one or more processors 2452. The processor circuitry 2452 includes circuitry such as, for example, one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2452 may include one or more hardware accelerators (e.g., same or similar to acceleration circuitry 2464), which may be microprocessors, programmable processing devices (e.g., FPGA, ASIC, and/or the like), or the like. The one or more accelerators may include, for example, computer vision and/or deep learning accelerators. In some implementations, the processor circuitry 2452 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein. The processor circuitry 2452 includes a microarchitecture that is capable of executing the penclave implementations and techniques discussed herein. The processors (or cores) 2452 may be coupled with or may include memory/storage and may be configured to execute instructions stored in the memory/storage to enable various applications or OSs to run on the platform 2450. The processors (or cores) 2452 is configured to operate application software to provide a specific service to a user of the platform 2450. Additionally or alternatively, the processor(s) 2452 may be a special-purpose processor(s)/controller(s) configured (or configurable) to operate according to the elements, features, and implementations discussed herein.

The processor circuitry 2452 may be or include, for example, one or more processor cores (CPUs), application processors, graphics processing units (GPUs), RISC processors, Acorn RISC Machine (ARM) processors, CISC processors, one or more DSPs, FPGAs, PLDs, one or more ASICs, baseband processors, radio-frequency integrated circuits (RFIC), microprocessors or controllers, multi-core processor, multithreaded processor, ultra-low voltage processor, embedded processor, an XPU, a data processing unit (DPU), an Infrastructure Processing Unit (IPU), a network processing unit (NPU), and/or any other known processing elements, or any suitable combination thereof.

As examples, the processor(s) 2452 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® to processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2452 may be a part of a system on a chip (SoC), System-in-Package (SiP), a multi-chip package (MCP), and/or the like, in which the processor(s) 2452 and other components are formed into a single integrated circuit, or a single package, such as the Edison™ or Galileo™ SoC boards from Intel® Corporation. Other examples of the processor(s) 2452 are mentioned elsewhere in the present disclosure.

The processor(s) 2452 may communicate with system memory 2454 over an interconnect (IX) 2456. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). Other types of RAM, such as static RAM (SRAM), dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. Additionally or alternatively, the memory circuitry 2454 is or includes block addressable memory device(s), such as those based on NAND or NOR technologies (e.g., single-level cell (“SLC”), Multi-Level Cell (“MLC”), Quad-Level Cell (“QLC”), Tri-Level Cell (“TLC”), or some other NAND).

To provide for persistent storage of information such as data, applications, OSs and so forth, a storage 2458 may also couple to the processor 2452 via the IX 2456. In an example, the storage 2458 may be implemented via a solid-state disk drive (SSDD) and/or high-speed electrically erasable memory (commonly referred to as “flash memory”). Other devices that may be used for the storage 2458 include flash memory cards, such as SD cards, microSD cards, eXtreme Digital (XD) picture cards, and the like, and USB flash drives. Additionally or alternatively, the memory circuitry 2454 and/or storage circuitry 2458 may be or may include memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. Additionally or alternatively, the memory circuitry 2454 and/or storage circuitry 2458 can include resistor-based and/or transistor-less memory architectures. The memory circuitry 2454 and/or storage circuitry 2458 may also incorporate three-dimensional (3D) cross-point (XPOINT) memory devices (e.g., Intel® 3D XPoint™ memory), and/or other byte addressable write-in-place NVM. The memory circuitry 2454 and/or storage circuitry 2458 may refer to the die itself and/or to a packaged memory product.

In low power implementations, the storage 2458 may be on-die memory or registers associated with the processor 2452. However, in some examples, the storage 2458 may be implemented using a micro hard disk drive (HDD). Further, any number of new technologies may be used for the storage 2458 in addition to, or instead of, the technologies described, such resistance change memories, phase change memories, holographic memories, or chemical memories, among others.

Computer program code for carrying out operations of the present disclosure (e.g., computational logic and/or instructions 2481, 2482, 2483) may be written in any combination of one or more programming languages, including an object oriented programming language such as Python, Ruby, Scala, Smalltalk, Java™, C++, C #, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code 2481, 2482, 2483 for carrying out operations of the present disclosure may also be written in any combination of the programming languages discussed herein. The program code may execute entirely on the system 2450, partly on the system 2450, as a stand-alone software package, partly on the system 2450 and partly on a remote computer or entirely on the remote computer or server. In the latter scenario, the remote computer may be connected to the system 2450 through any type of network, including a LAN or WAN, or the connection may be made to an external computer (e.g., through the Internet using an Internet Service Provider (ISP)).

In an example, the instructions 2481, 2482, 2483 on the processor circuitry 2452 (separately, or in combination with the instructions 2481, 2482, 2483) may configure execution or operation of a trusted execution environment (TEE) 2490. The TEE 2490 operates as a protected area accessible to the processor circuitry 2402 to enable secure access to data and secure execution of instructions. In some embodiments, the TEE 2490 may be a physical hardware device that is separate from other components of the system 2450 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

Additionally or alternatively, the TEE 2490 may be implemented as secure enclaves (or “enclaves”), which are isolated regions of code and/or data within the processor and/or memory/storage circuitry of the compute node 2450. Only code executed within a secure enclave may access data within the same secure enclave, and the secure enclave may only be accessible using the secure application (which may be implemented by an application processor or a tamper-resistant microcontroller). Various implementations of the TEE 2490, and an accompanying secure area in the processor circuitry 2452 or the memory circuitry 2454 and/or storage circuitry 2458 may be provided, for instance, through use of Intel® Software Guard Extensions (SGX), ARM® TrustZone®, Keystone Enclaves, Open Enclave SDK, and/or the like. Other aspects of security hardening, hardware roots-of-trust, and trusted or protected operations may be implemented in the device 2400 through the TEE 2490 and the processor circuitry 2452. Additionally or alternatively, the memory circuitry 2454 and/or storage circuitry 2458 may be divided into isolated user-space instances such as virtualization/OS containers, partitions, virtual environments (VEs), and/or the like. The isolated user-space instances may be implemented using a suitable OS-level virtualization technology such as Docker® containers, Kubemetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 2404 and/or storage circuitry 2408 may be divided into one or more trusted memory regions for storing applications or software modules of the TEE 2490.

The OS stored by the memory circuitry 2454 and/or storage circuitry 2458 is software to control the compute node 2450. The OS may include one or more drivers that operate to control particular devices that are embedded in the compute node 2450, attached to the compute node 2450, and/or otherwise communicatively coupled with the compute node 2450. Example OSs include consumer-based operating systems (e.g., Microsoft® Windows® 10, Google® Android®, Apple® macOS®, Apple® iOS®, KaiOS™ provided by KaiOS Technologies Inc., Unix or a Unix-like OS such as Linux, Ubuntu, or the like), industry-focused OSs such as real-time OS (RTOS) (e.g., Apache® Mynewt, Windows® IoT®, Android Things®, Micrium® Micro-Controller OSs (“MicroC/OS” or “pC/OS”), VxWorks®, FreeRTOS, and/or the like), hypervisors (e.g., Xen® Hypervisor, Real-Time Systems® RTS Hypervisor, Wind River Hypervisor, VMWare® vSphere® Hypervisor, and/or the like), and/or the like. The OS can invoke alternate software to facilitate one or more functions and/or operations that are not native to the OS, such as particular communication protocols and/or interpreters. Additionally or alternatively, the OS instantiates various functionalities that are not native to the OS. In some examples, OSs include varying degrees of complexity and/or capabilities. In some examples, a first OS on a first compute node 2450 may be the same or different than a second OS on a second compute node 2450. For instance, the first OS may be an RTOS having particular performance expectations of responsivity to dynamic input conditions, and the second OS can include GUI capabilities to facilitate end-user I/O and the like.

The storage 2458 may include instructions 2483 in the form of software, firmware, or hardware commands to implement the techniques described herein. Although such instructions 2483 are shown as code blocks included in the memory 2454 and the storage 2458, any of the code blocks may be replaced with hardwired circuits, for example, built into an application specific integrated circuit (ASIC), FPGA memory blocks, and/or the like. In an example, the instructions 2481, 2482, 2483 provided via the memory 2454, the storage 2458, or the processor 2452 may be embodied as a non-transitory, machine-readable medium 2460 including code to direct the processor 2452 to perform electronic operations in the compute node 2450. The processor 2452 may access the non-transitory, machine-readable medium 2460 (also referred to as “computer readable medium 2460” or “CRM 2460”) over the IX 2456. For instance, the non-transitory, CRM 2460 may be embodied by devices described for the storage 2458 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, CRM 2460 may include instructions to direct the processor 2452 to perform a specific sequence or flow of actions, for example, as described with respect to the flowchart(s) and/or block diagram(s) of operations and functionality depicted herein.

The components of edge computing device 2450 may communicate over an interconnect (IX) 2456. The IX 2456 may represent any suitable type of connection or interface such as, for example, metal or metal alloys (e.g., copper, aluminum, and/or the like), fiber, and/or the like. The IX 2456 may include any number of IX, fabric, and/or interface technologies, including instruction set architecture (ISA), extended ISA (eISA), Inter-Integrated Circuit (I2C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX technology, RapidIO™ IX, Coherent Accelerator Processor Interface (CAPI), OpenCAPI, cache coherent interconnect for accelerators (CCIX), Gen-Z Consortium IXs, HyperTransport IXs, NVLink provided by NVIDIA®, a Time-Trigger Protocol (TTP) system, a FlexRay system, PROFIBUS, ARM® Advanced eXtensible Interface (AXI), ARM® Advanced Microcontroller Bus Architecture (AMBA) IX, HyperTransport, Infinity Fabric (IF), and/or any number of other IX technologies. The IX 2456 may be a proprietary bus, for example, used in a SoC based system. Additionally or alternatively, the IX 2456 may be a suitable compute fabric.

The IX 2456 couples the processor 2452 to communication circuitry 2466 for communications with other devices, such as a remote server (not shown) and/or the connected edge devices 2462. The communication circuitry 2466 is a hardware element, or collection of hardware elements, used to communicate over one or more networks (e.g., cloud 2463) and/or with other devices (e.g., edge devices 2462). Communication circuitry 2466 includes modem circuitry 2466x may interface with application circuitry of compute node 2450 (e.g., a combination of processor circuitry 2402 and CRM 2460) for generation and processing of baseband signals and for controlling operations of the transceivers (TRx) 2466y and 2466z. The modem circuitry 2466x may handle various radio control functions that enable communication with one or more (R)ANs via the TRxs 2466y and 2466z according to one or more wireless communication protocols and/or RATs. The modem circuitry 2466x may include circuitry such as, but not limited to, one or more single-core or multi-core processors (e.g., one or more baseband processors) or control logic to process baseband signals received from a receive signal path of the TRxs 2466y, 2466z, and to generate baseband signals to be provided to the TRxs 2466y, 2466z via a transmit signal path. The modem circuitry 2466x may implement a real-time OS (RTOS) to manage resources of the modem circuitry 2466x, schedule tasks, perform the various radio control functions, process the transmit/receive signal paths, and the like. In some implementations, the modem circuitry 2466x includes a parch that is capable of executing the penclave implementations and techniques discussed herein.

The TRx 2466y may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2462. For example, a wireless local area network (WLAN) unit may be used to implement Wi-Fi® communications in accordance with [IEEE802] standard (e.g., IEEE Standard for Information Technology—Telecommunications and Information Exchange between Systems Local and Metropolitan Area Networks—Specific Requirements—Part 11: Wireless LAN Medium Access Control (MAC) and Physical Layer (PHY) Specifications, IEEE Std802.11-2020, pp. 1-4379 (26 Feb. 2021) (“[IEEE80211]”) and/or the like). In addition, wireless wide area communications, e.g., according to a cellular or other wireless wide area protocol, may occur via a wireless wide area network (WWAN) unit.

The TRx 2466y (or multiple transceivers 2466y) may communicate using multiple standards or radios for communications at a different range. For example, the compute node 2450 may communicate with relatively close devices (e.g., within about 10 meters) using a local transceiver based on BLE, or another low power radio, to save power. More distant connected edge devices 2462 (e.g., within about 50 meters) may be reached over ZigBee® or other intermediate power radios. Both communications techniques may take place over a single radio at different power levels or may take place over separate transceivers, for example, a local transceiver using BLE and a separate mesh transceiver using ZigBee®.

A TRx 2466z (e.g., a radio transceiver) may be included to communicate with devices or services in the edge cloud 2463 via local or wide area network protocols. The TRx 2466z may be an LPWA transceiver that follows [IEEE802154] and/or IEEE 802.15.4g standards, among many others. The edge computing node 2463 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used. Any number of other radio communications and protocols may be used in addition to the systems mentioned for the TRx 2466z, as described herein. For example, the TRx 2466z may include a cellular transceiver that uses spread spectrum (SPA/SAS) communications for implementing high-speed communications. Further, any number of other protocols may be used, such as WiFi® networks for medium speed communications and provision of network communications. The TRx 2466z may include radios that are compatible with any number of 3GPP specifications, such as LTE and 5G/NR communication systems.

A network interface controller (NIC) 2468 may be included to provide a wired communication to nodes of the edge cloud 2463 or to other devices, such as the connected edge devices 2462 (e.g., operating in a mesh, fog, and/or the like). The wired communication may provide an Ethernet connection (see e.g., Ethernet (e.g., IEEE Standard for Ethernet, IEEE Std 802.3-2018, pp. 1-5600 (31 Aug. 2018) (“[IEEE8023]”)) or may be based on other types of networks, such as Controller Area Network (CAN), Local Interconnect Network (LIN), DeviceNet, ControlNet, Data Highway+, or PROFINET, among many others. In some implementations, the NIC 2468 may be an Ethernet controller (e.g., a Gigabit Ethernet Controller or the like), a SmartNIC, Intelligent Fabric Processor(s) (IFP(s)). An additional NIC 2468 may be included to enable connecting to a second network, for example, a first NIC 2468 providing communications to the cloud over Ethernet, and a second NIC 2468 providing communications to other devices over another type of network.

Given the variety of types of applicable communications from the device to another component or network, applicable communications circuitry used by the device may include or be embodied by any one or more of components 2464, 2466, 2468, or 2470. Accordingly, in various examples, applicable means for communicating (e.g., receiving, transmitting, and/or the like) may be embodied by such communications circuitry.

The compute node 2450 can include or be coupled to acceleration circuitry 2464, which may be embodied by one or more hardware accelerators, a neural compute stick, neuromorphic hardware, FPGAs, GPUs, SoCs (including programmable SoCs), vision processing units (VPUs), digital signal processors, dedicated ASICs, programmable ASICs, PLDs (e.g., CPLDs and/or HCPLDs), DPUs, IPUs, NPUs, and/or other forms of specialized processors or circuitry designed to accomplish one or more specialized tasks. Additionally or alternatively, the acceleration circuitry 2464 is embodied as one or more XPUs. In some implementations, an XPU is a multi-chip package including multiple chips stacked like tiles into an XPU, where the stack of chips includes any of the processor types discussed herein. Additionally or alternatively, an XPU is implemented by a heterogeneous computing system including multiple types of processor circuitry (e.g., one or more FPGAs, one or more CPUs, one or more GPUs, one or more DSPs, and/or the like, and/or a combination thereof) and application programming interface(s) (API(s)) that may assign computing task(s) to whichever one(s) of the multiple types of the processing circuitry is/are best suited to execute the computing task(s). In any of these implementations, the tasks may include AI/ML tasks (e.g., training, inferencing/prediction, classification, and the like), visual data processing, network data processing, infrastructure function management, object detection, rule analysis, or the like. In FPGA-based implementations, the acceleration circuitry 2464 may comprise logic blocks or logic fabric and other interconnected resources that may be programmed (configured) to perform various functions, such as the procedures, methods, functions, and/or the like discussed herein. In such implementations, the acceleration circuitry 2464 may also include memory cells (e.g., EPROM, EEPROM, flash memory, static memory (e.g., SRAM, anti-fuses, and/or the like) used to store logic blocks, logic fabric, data, and/or the like in LUTs and the like.

In some implementations, the acceleration circuitry 2464 and/or the processor circuitry 2452 can be or include may be a cluster of artificial intelligence (AI) GPUs, tensor processing units (TPUs) developed by Google® Inc., Real AI Processors (RAPs™) provided by AlphaICs®, Intel® Nervana™ Neural Network Processors (NNPs), Intel® Movidius™ Myriad™ X Vision Processing Units (VPUs), NVIDIA® PX™ based GPUs, the NM500 chip provided by General Vision®, Tesla® Hardware 3 processor, an Adapteva® Epiphany™ based processor, and/or the like. Additionally or alternatively, the acceleration circuitry 2464 and/or the processor circuitry 2452 can be implemented as AI accelerating co-processor(s), such as the Hexagon 685 DSP provided by Qualcomm®, the PowerVR 2NX Neural Net Accelerator (NNA) provided by Imagination Technologies Limited®, the Apple® Neural Engine core, a Neural Processing Unit (NPU) within the HiSilicon Kirin 970 provided by Huawei®, and/or the like.

The IX 2456 also couples the processor 2452 to an external interface 2470 that is used to connect additional devices or subsystems. In some implementations, the interface 2470 can include one or more input/output (I/O) controllers. Examples of such I/O controllers include integrated memory controller (IMC), memory management unit (MMU), input-output MMU (IOMMU), sensor hub, General Purpose I/O (GPIO) controller, PCIe endpoint (EP) device, direct media interface (DMI) controller, Intel® Flexible Display Interface (FDI) controller(s), VGA interface controller(s), Peripheral Component Interconnect Express (PCIe) controller(s), universal serial bus (USB) controller(s), eXtensible Host Controller Interface (xHCI) controller(s), Enhanced Host Controller Interface (EHCI) controller(s), Serial Peripheral Interface (SPI) controller(s), Direct Memory Access (DMA) controller(s), hard drive controllers (e.g., Serial AT Attachment (SATA) host bus adapters/controllers, Intel® Rapid Storage Technology (RST), and/or the like), Advanced Host Controller Interface (AHCI), a Low Pin Count (LPC) interface (bridge function), Advanced Programmable Interrupt Controller(s) (APIC), audio controller(s), SMBus host interface controller(s), UART controller(s), and/or the like. Some of these controllers may be part of, or otherwise applicable to the memory circuitry 2454, storage circuitry 2458, and/or IX 2456 as well. The additional/external devices may include sensors 2472, actuators 2474, and positioning circuitry 2445.

The sensor circuitry 2472 includes devices, modules, or subsystems whose purpose is to detect events or changes in its environment and send the information (sensor data) about the detected events to some other a device, module, subsystem, and/or the like. Examples of such sensors 2472 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node 2450); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 2474, allow platform 2450 to change its state, position, and/or orientation, or move or control a mechanism or system. The actuators 2474 comprise electrical and/or mechanical devices for moving or controlling a mechanism or system, and converts energy (e.g., electric current or moving air and/or liquid) into some kind of motion. The actuators 2474 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2474 may include one or more electromechanical devices such as pneumatic actuators, hydraulic actuators, electromechanical switches including electromechanical relays (EMRs), motors (e.g., DC motors, stepper motors, servomechanisms, and/or the like), power switches, valve actuators, wheels, thrusters, propellers, claws, clamps, hooks, audible sound generators, visual warning devices, and/or other like electromechanical components. The platform 2450 may be configured to operate one or more actuators 2474 based on one or more captured events and/or instructions or control signals received from a service provider and/or various client systems.

The positioning circuitry 2445 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and/or the like), or the like. The positioning circuitry 2445 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 2445 may include a Micro-Technology for Positioning, Navigation, and Timing (Micro-PNT) IC that uses a master timing clock to perform position tracking/estimation without GNSS assistance. The positioning circuitry 2445 may also be part of, or interact with, the communication circuitry 2466 to communicate with the nodes and components of the positioning network. The positioning circuitry 2445 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 2445 is, or includes an INS, which is a system or device that uses sensor circuitry 2472 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 2450 without the need for external references.

In some optional examples, various input/output (I/O) devices may be present within or connected to, the compute node 2450, which are referred to as input circuitry 2486 and output circuitry 2484 in FIG. 24. The input circuitry 2486 and output circuitry 2484 include one or more user interfaces designed to enable user interaction with the platform 2450 and/or peripheral component interfaces designed to enable peripheral component interaction with the platform 2450. Input circuitry 2486 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2484 may be included to show information or otherwise convey information, such as sensor readings, actuator position(s), or other like information. Data and/or graphics may be displayed on one or more user interface components of the output circuitry 2484. Output circuitry 2484 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and/or the like), with the output of characters, graphics, multimedia objects, and the like being generated or produced from the operation of the platform 2450. The output circuitry 2484 may also include speakers or other audio emitting devices, printer(s), and/or the like. Additionally or alternatively, the sensor circuitry 2472 may be used as the input circuitry 2484 (e.g., an image capture device, motion capture device, or the like) and one or more actuators 2474 may be used as the output device circuitry 2484 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2476 may power the compute node 2450, although, in examples in which the compute node 2450 is mounted in a fixed location, it may have a power supply coupled to an electrical grid, or the battery may be used as a backup or for temporary capabilities. The battery 2476 may be a lithium ion battery, or a metal-air battery, such as a zinc-air battery, an aluminum-air battery, a lithium-air battery, and the like.

A battery monitor/charger 2478 may be included in the compute node 2450 to track the state of charge (SoCh) of the battery 2476, if included. The battery monitor/charger 2478 may be used to monitor other parameters of the battery 2476 to provide failure predictions, such as the state of health (SoH) and the state of function (SoF) of the battery 2476. The battery monitor/charger 2478 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2478 may communicate the information on the battery 2476 to the processor 2452 over the IX 2456. The battery monitor/charger 2478 may also include an analog-to-digital (ADC) converter that enables the processor 2452 to directly monitor the voltage of the battery 2476 or the current flow from the battery 2476. The battery parameters may be used to determine actions that the compute node 2450 may perform, such as transmission frequency, mesh network operation, sensing frequency, and the like.

A power block 2480, or other power supply coupled to a grid, may be coupled with the battery monitor/charger 2478 to charge the battery 2476. In some examples, the power block 2480 may be replaced with a wireless power receiver to obtain the power wirelessly, for example, through a loop antenna in the compute node 2450. A wireless battery charging circuit, such as an LTC 4020 chip from Linear Technologies of Milpitas, California, among others, may be included in the battery monitor/charger 2478. The specific charging circuits to may be selected based on the size of the battery 2476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The example of FIG. 24 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed below (e.g., a mobile device in industrial compute for smart city or smart factory, among many other examples).

### 10. EXAMPLE IMPLEMENTATIONS

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example A01 includes a method of operating a deterministic switching fabric, the method comprising: determining one or more conditions or inequalities to enhance a folded CLOS fabric to be shared with deterministic traffic.

Example A02 includes the method of example A01 and/or some other example(s) herein, wherein the deterministic switching fabric is part of a folded CLOS fabric.

Example A03 includes the method of examples A01-A02 and/or some other example(s) herein, wherein the method includes: performing or executing a methodology to achieve deterministic CLOS fabric with an SRv6 data plane.

Example A04 includes the method of example A03 and/or some other example(s) herein, wherein a segmented routing (SR) data plane is based on IGP distributed routing and centralized controller technologies in a mixed mode paradigm in the folded CLOS fabric to serve high value traffic alongside best effort traffic.

Example A05 includes the method of example A04 and/or some other example(s) herein, wherein the SR data plane is an SR IPv6 (SRv6) data plane.

Example A06 includes the method of examples A01-A05 and/or some other example(s) herein, further comprising: a preferred path routing (PPR) control plane.

Example A07 includes the method of example A06 and/or some other example(s) herein, wherein the PPR control plane is based on IGP distributed routing and centralized controller technologies in a mixed mode paradigm in the folded CLOS fabric to serve high value traffic alongside best effort traffic.

Example A08 includes the deterministic switching fabric of examples A01-A07 and/or some other example(s) herein, wherein one or more nodes are configured to advertise set Path Description Elements (PDEs) in a primary path advertisement.

Example A09 includes the deterministic switching fabric of examples A01-A08 and/or some other example(s) herein, wherein one or more nodes are configured to indicate first PDE element in the list with S bit.

Example A10 includes the deterministic switching fabric of examples A01-A09 and/or some other example(s) herein, wherein one or more nodes are configured to indicate subsequent PDE element in the list with LP bit and procedure to install efficient and traffic engineering aware link protecting path.

Example All includes the deterministic switching fabric of examples A01-A10 and/or some other example(s) herein, wherein one or more nodes are configured to indicate subsequent PDE element in the list with NP bit and procedure to install efficient and traffic engineering aware node protecting path.

Example B01 includes a method comprising: advertising, by a network node in a switching fabric, a set of Path Description Elements (PDEs) in a primary path advertisement.

Example B02 includes method of example B01 and/or some other example(s) herein, further comprising: indicating, by the network node, a first PDE element in a list with a set (S) bit.

Example B03 includes method of example B02 and/or some other example(s) herein, further comprising: indicating, by the network node, a subsequent PDE element in the list with a Link Protecting (LP) bit.

Example B04 includes method of example B03 and/or some other example(s) herein, further comprising: installing, by the network node, an efficient and traffic engineering aware link protecting path.

Example B05 includes method of example B04 and/or some other example(s) herein, wherein the installing comprises adding the traffic engineering aware link protecting path to a routing information base and/or a forwarding information base.

Example B06 includes method of examples B02-B05 and/or some other example(s) herein, further comprising: indicating, by the network node, a subsequent PDE element in the list with a Node Protecting (NP) bit.

Example B07 includes method of example B06 and/or some other example(s) herein, further comprising: installing, by the network node, an efficient and traffic engineering aware node protecting path.

Example B08 includes method of example B07 and/or some other example(s) herein, wherein the installing comprises adding the traffic engineering aware node protecting path to a routing information base and/or a forwarding information base.

Example COT includes a method comprising: reserving, by a compute node, a subset of links between a set of network nodes in a network topology when one or more conditions are met, wherein the reservation of the set of links is for data packets belonging to a high value traffic flow.

Example C02 includes the method of example COT and/or some other example(s) herein, wherein the subset of links is among a set of links in the network topology.

Example C03 includes the method of example C02 and/or some other example(s) herein, wherein the subset of links is used for traffic engineering (TE), and the network topology is shared among one or more best effort traffic flows and one or more high value traffic flows.

Example C04 includes the method of examples C02-C03 and/or some other example(s) herein, wherein the one or more conditions comprises: a difference between the set of links and the subset of links is at least same as a threshold number of links.

Example C05 includes the method of examples C02-C04 and/or some other example(s) herein, wherein the one or more conditions comprises: a difference between the set of links and the subset of links is same or more than a downstream-port-bandwidth threshold.

Example C06 includes the method of examples C02-C05 and/or some other example(s) herein, wherein the one or more conditions comprises: one or more metrics of the subset of links is same or better than same one or more metrics of the set of links.

Example C07 includes the method of examples C02-C06 and/or some other example(s) herein, wherein the one or more conditions comprises: a number of links in the subset of links is same as a number of switches in the network topology.

Example C08 includes the method of examples C02-C07 and/or some other example(s) herein, wherein the one or more conditions comprises: one or more metrics of one or more links in the subset of links is better than same one or more metrics of one or more other links in the subset of links.

Example C09 includes the method of examples C02-C08 and/or some other example(s) herein, wherein the one or more conditions comprises: a total capacity of the subset of links is managed centrally for traffic steering into one or more network nodes and/or one or more network switches.

Example C10 includes the method of examples C02-C09 and/or some other example(s) herein, wherein the one or more conditions comprises: a traffic policy being present on one or more network nodes and/or one or more network switches in the network topology to steer traffic to the subset of links.

Example C11 includes the method of examples C01-Cl0 and/or some other example(s) herein, further comprising: adding or inserting a path description element (PDE) to one or more data packets belonging to the high value traffic flow to implement TE for the high value traffic flow.

Example C12 includes the method of examples C01-C11 and/or some other example(s) herein, further comprising: adding or inserting a Preferred Path Routing (PPR) identifier into one or more data packets belonging to the high value traffic flow to implement TE for the high value traffic flow.

Example C13 includes the method of examples C01-C12 and/or some other example(s) herein, further comprising: adding or inserting a PPR-PDE path advertisement into one or more data packets belonging to the high value traffic flow to implement TE for the high value traffic flow.

Example C14 includes the method of example C13 and/or some other example(s) herein, wherein the PPR-PDE includes a set (S) flag that indicates that a current PDE is a set PDE and can be used for backup purposes.

Example C15 includes the method of examples C13-C14 and/or some other example(s) herein, wherein the PPR-PDE includes a link protection (LP) flag that indicates a link protecting alternative to a next element in a path description of the PDE.

Example C16 includes the method of examples C13-C15 and/or some other example(s) herein, wherein the PPR-PDE includes a node protection (NP) flag that indicates a node protecting alternative to a next element in a path description of the PDE.

Example C17 includes the method of examples C14-C16 and/or some other example(s) herein, further comprising: computing a next hop (NH) for a PPR-ID based on current PPR when the S flag is set.

Example C18 includes the method of example C17 and/or some other example(s) herein, further comprising: extracting a second PDE in the set; validating the second PDE; and processing the alternative next hop for the second PDE.

Example C19 includes the method of example C18 and/or some other example(s) herein, further comprising: extracting LP and/or NP information in the set-PDE; and indicating the extracted LP and/or NP information in the alternative next hop.

Example C20 includes the method of example C19 and/or some other example(s) herein, further comprising: forming a double barrel next hop entry for the PPR-ID route and the computed next hop and the alternative next hop; and adding or inserting the double barrel next hop entry to a routing table and/or a forwarding table.

Example D01 includes a method of operating a compute node, comprising: determining a first subset including a first number of links in a set of links to be designated as traffic engineering (TE) links between a first subset of network nodes in a set of network nodes and a second subset of network nodes in the set of network nodes according to a set of conditions; determining a second subset including a second number links between the first subset of network nodes and the second subset of network nodes, wherein the second subset of links are non-TE links; determining a third subset including a third number links between the second subset of network nodes and a set of servers; the set of conditions includes a difference between the second number and the first number being greater than or equal to the third number; causing advertisement of the first subset to the set of network nodes; configuring a TE policy in the set of network nodes, wherein the TE policy defines when data packets are to be routed over one or more paths including the TE links according to a preferred path routing (PPR) protocol; and signaling, after the configuring, the set of network nodes to begin routing data packets according to the TE policy.

Example D02 includes the method of examples D01 and/or some other example(s) herein, wherein the set of network nodes are part of a network topology, the network topology includes a leaf layer and a spine layer, and wherein the first subset of network nodes belongs to the spine layer and the second subset of network nodes belongs to the leaf layer.

Example D03 includes the method of example D02 and/or some other example(s) herein, wherein the network topology is shared among best effort traffic flows and high priority traffic flows, and the TE policy defines the best effort traffic flows to be routed over one or more paths including links in the second subset of links and defines the high priority traffic flows to be routed over TE paths including TE links in the first subset of links.

Example D04 includes the method of examples D01-D03 and/or some other example(s) herein, wherein the set of conditions includes the difference between the second number and the first number is at least a threshold number of links.

Example D05 includes the method of examples D01-D04 and/or some other example(s) herein, wherein the set of conditions includes the difference between the second number and the first number is same or more than a downstream-port-bandwidth threshold.

Example D06 includes the method of examples D01-D05 and/or some other example(s) herein, wherein the set of conditions includes metrics of links in the first subset of links being higher than metrics of links in the second subset of links.

Example D07 includes the method of examples D01-D06 and/or some other example(s) herein, wherein the set of conditions includes the first number being same as a number of switches in the network topology.

Example D08 includes the method of examples D01-D07 and/or some other example(s) herein, wherein the set of conditions includes an over-subscription ratio of the third number to the difference between the second number and the first number.

Example D09 includes the method of examples D01-D08 and/or some other example(s) herein, wherein the set of conditions includes a total capacity of the first subset of links being managed centrally for traffic steering into one or more network nodes of the set of network nodes and/or one or more network switches in the network toplogy.

Example D10 includes the method of example D09 and/or some other example(s) herein, wherein the set of network nodes includes a combination of one or more network elements.

Example D11 includes the method of examples D01-D10 and/or some other example(s) herein, wherein the network elements include one or more of routers, switches, hubs, gateways, access points, radio access network nodes, firewall appliances, network controllers, and fabric controllers.

Example D12 includes the method of examples D01-D11 and/or some other example(s) herein, wherein the method includes: adding or inserting a path description element (PDE) to one or more data packets belonging to the traffic flow to implement the TE for the traffic flow.

Example D13 includes the method of example D12 and/or some other example(s) herein, wherein the method includes: adding or inserting a Preferred Path Routing (PPR) identifier (ID) into the one or more data packets belonging to the traffic flow to implement the TE for the traffic flow.

Example D14 includes the method of examples D12-D13 and/or some other example(s) herein, wherein the method includes: adding or inserting a PPR-PDE path advertisement into the one or more data packets belonging to the traffic flow to implement the TE for the traffic flow.

Example D15 includes the method of example D14 and/or some other example(s) herein, wherein the PPR-PDE includes a set (S) flag that indicates that a current PDE is a set PDE and can be used for backup purposes.

Example D16 includes the method of examples D14-D15 and/or some other example(s) herein, wherein the PPR-PDE includes a link protection (LP) flag that indicates a link protecting alternative path in a path description of the PDE.

Example D17 includes the method of examples D14-D16 and/or some other example(s) herein, wherein the PPR-PDE includes a node protection (NP) flag that indicates a node protecting alternative path in a path description of the PDE.

Example D18 includes the method of examples D16 and D17 and/or some other example(s) herein, wherein the link protecting path and the node protecting path is through a same or different subset of network nodes of the set of network nodes.

Example D19 includes the method of examples D15-D18 and/or some other example(s) herein, wherein the method includes: computing a next hop (NH) for a PPR-ID based on current PPR when the S flag is set.

Example D20 includes the method of example D19 and/or some other example(s) herein, wherein the method includes: extracting a subsequent PDE in the set PDE; validating the subsequent PDE; and processing an alternative NH for the subsequent PDE.

Example D21 includes the method of example D20 and/or some other example(s) herein, wherein the method includes: extracting one or both of LP information and NP information from the set PDE; and inserting the extracted LP information and/or NP information in the alternative NH.

Example D22 includes the method of example D21 and/or some other example(s) herein, wherein the method includes: forming a NH entry for the PPR-ID route, the computed NH, and the alternative NH; and adding or inserting the next hop entry to a routing table and/or a forwarding table.

Example D23 includes the method of example D22 and/or some other example(s) herein, wherein the NH entry is a double barrel NH entry in the routing table or the forwarding table.

Example D24 includes the method of examples D01-D23 and/or some other example(s) herein, wherein the causing the advertisement includes: increasing metric values for respective links of the first subset of links based on a set of required resources, a set of traffic characteristics, and a set of service level parameters based on the capabilities of each network node in the set of network nodes and links along a preferred path.

Example E01 includes the method of examples A01-D24 and/or some other example(s) herein, wherein the network topology is a CLOS network topology or a leaf-and-spine network topology.

Example E02 includes the method of examples A01-D24 and/or some other example(s) herein, wherein the compute node is a PPR control plane entity or a Segment Routing IPv6 (SRv6) data plane entity.

Example E03 includes the method of examples A01-D25 and/or some other example(s) herein, wherein the compute node is a network switch, a cloud compute node, an edge compute node, a radio access network (RAN) node, or a compute node that operates one or more network functions in a cellular core network.

Example Z01 includes one or more computer readable media comprising instructions, wherein execution of the instructions by processor circuitry is to cause the processor circuitry to perform the method of any one of examples A01-E03 and/or some other example(s) herein. Example Z02 includes a computer program comprising the instructions of example Z01. Example Z03a includes an Application Programming Interface defining functions, methods, variables, data structures, and/or protocols for the computer program of example Z02. Example Z03b includes an API or specification defining functions, methods, variables, data structures, protocols, and/or the like, defining or involving use of any of examples A01-E03, or portions thereof, or otherwise related to any of examples A01-E03 or portions thereof. Example Z04 includes an apparatus comprising circuitry loaded with the instructions of example Z01. Example Z05 includes an apparatus comprising circuitry operable to run the instructions of example Z01. Example Z06 includes an integrated circuit comprising one or more of the processor circuitry of example Z01 and the one or more computer readable media of example Z01. Example Z07 includes a computing system comprising the one or more computer readable media and the processor circuitry of example Z01. Example Z08 includes an apparatus comprising means for executing the instructions of example Z01. Example Z09 includes a signal generated as a result of executing the instructions of example Z01. Example Z10 includes a data unit generated as a result of executing the instructions of example Z01. Example Z11 includes the data unit of example Z10 and/or some other example(s) herein, wherein the data unit is a datagram, network packet, data frame, data segment, a Protocol Data Unit (PDU), a Service Data Unit (SDU), a message, or a database object. Example Z12 includes a signal encoded with the data unit of examples Z10 and/or Z11. Example Z13 includes an electromagnetic signal carrying the instructions of example Z01. Example Z14 includes an apparatus comprising means for performing the method of any one of examples A01-E03 and/or some other example(s) herein. Example Z15 includes an edge compute node executing a service as part of one or more edge applications instantiated on virtualization infrastructure, the service being related to any of examples A01-E03, portions thereof, and/or some other example(s) herein.

### 11. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established″ at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value.

The term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or to module need not be physically located together but may comprise disparate instructions stored in different locations which, when joined logically together, comprise the component or module and achieve the stated purpose for the component or module. Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable to mediums for storing data. The term “computer-readable medium” may include, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. to The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “SmartNIC” at least in some examples refers to a network interface controller (NIC), network adapter, or a programmable network adapter card with programmable hardware accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity.

The term “entity” at least in some examples refers to a distinct component of an architecture or device, or information transferred as a payload.

The term “controller” at least in some examples refers to an element or entity that has the capability to affect a physical entity, such as by changing its state or causing the physical entity to move.

The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some embodiments, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another.

Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to to technical control and logging mechanisms to enforce or reconcile policy rules (information use rules) and to ensure accountability in information systems.

The term “gateway” at least in some examples refers to a network appliance that allows data to flow from one network to another network, or a computing system or application configured to perform such tasks. Examples of gateways include IP gateways, Internet-to-Orbit (I20) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmut-mounted display devices, augmented reality (AR) devices, virtual reality (VR) devices, mixed reality (MR) devices, and/or other like systems or devices.

The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, firewall appliances, network controllers, fabric controllers, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. In some examples, an AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA.

The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an Si interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022-04-15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “Transmission Reception Point” or “TRxP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an RU and DU are physically separated from one another, and/or an architecture in which a DU and a CU are physically separated from one another. The term “integrated architecture at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, and the like). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “colocated” or “co-located” at least in some examples refers to two or more elements being in the same place or location, or relatively close to one another (e.g., within some predetermined distance from one another). Additionally or alternatively, the term “colocated” or “co-located” at least in some examples refers to the placement or deployment of two or more compute elements or compute nodes together in a secure dedicated storage facility, or within a same enclosure or housing.

The term “central office” or “CO” at least in some examples refers to an aggregation point for telecommunications infrastructure within an accessible or defined geographical area, often where telecommunication service providers have traditionally located switching equipment for one or multiple types of access networks. In some examples, a CO can be physically designed to house telecommunications infrastructure equipment or compute, data storage, and network resources. The CO need not, however, be a designated location by a telecommunications service provider. The CO may host any number of compute devices for Edge applications and services, or even local implementations of cloud-like services. The term “cloud computing” or “cloud″ at least in some examples refers to a paradigm for enabling network access to a scalable and elastic pool of shareable computing resources with self-service provisioning and administration on-demand and without active to management by users. Cloud computing provides cloud computing services (or cloud services), which are one or more capabilities offered via cloud computing that are invoked using a defined interface (e.g., an API or the like). The term “cloud service provider” or “CSP” at least in some examples refers to an organization which operates typically large-scale “cloud″ resources comprised of centralized, regional, and Edge data centers (e.g., as used in the context of the public cloud). In other examples, a CSP may also be referred to as a “Cloud Service Operator” or “CSO”. References to “cloud computing” generally refer to computing resources and services offered by a CSP or a CSO, at remote locations with at least some increased latency, distance, or constraints relative to edge computing.

The term “data center” at least in some examples refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some examples refers to to compute, storage, and/or network resources provided by physical hardware element(s). A “virtualized resource” at least in some examples refers to to compute, storage, and/or network resources provided by virtualization infrastructure to an application, device, system, and the like. The term “network resource” or “communication resource” at least in some examples refers to to resources that are accessible by computer devices/systems via a communications network. The term “system resources” at least in some examples refers to to any kind of shared entities to provide services, and may include computing and/or network resources. System resources may be considered as a set of coherent functions, network data objects or services, accessible through a server where such system resources reside on a single host or multiple hosts and are clearly identifiable.

The term “workload” at least in some examples refers to an amount of work performed by a computing system, device, entity, and the like, during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by a processor during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, and the like), and/or the like. Various algorithms may be used to determine a workload and/or workload characteristics, which may be based on any of the aforementioned workload types.

The term “network function” or “NF” at least in some examples refers to a functional block within a network infrastructure that has one or more external interfaces and a defined functional behavior. The term “network service” or “NS” at least in some examples refers to a composition of Network Function(s) and/or Network Service(s), defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “edge compute function” or “ECF” at least in some examples refers to an element or entity that performs an aspect of an edge computing technology (ECT), an aspect of edge to networking technology (ENT), or performs an aspect of one or more edge computing services running over the ECT or ENT. The term “management function” at least in some examples refers to a logical entity playing the roles of a service consumer and/or a service producer. The term “management service” at least in some examples refers to a set of offered management capabilities. The term “network function virtualization” or “NFV” at least in some examples refers to the principle of separating network functions from the hardware they run on by using virtualisation techniques and/or virtualization technologies. The term “virtualized network function” or “VNF” at least in some examples refers to an implementation of an NF that can be deployed on a Network Function Virtualisation Infrastructure (NFVI). The term “Network Functions Virtualisation Infrastructure Manager” or “NFVI” at least in some examples refers to a totality of all hardware and software components that build up the environment in which VNFs are deployed.

The term “slice” at least in some examples refers to a set of characteristics and behaviors that separate one instance, traffic, data flow, application, application instance, link or connection, RAT, device, system, entity, element, and the like from another instance, traffic, data flow, application, application instance, link or connection, RAT, device, system, entity, element, and the like, or separate one type of instance, and the like, from another instance, and the like.

The term “network slice” at least in some examples refers to a logical network that provides specific network capabilities and network characteristics and/or supports various service properties for network slice service consumers. Additionally or alternatively, the term “network slice” at least in some examples refers to a logical network topology connecting a number of endpoints using a set of shared or dedicated network resources that are used to satisfy specific service level objectives(SLOs) and/or service level agreements (SLAs).

The term “network slicing” at least in some examples refers to methods, processes, techniques, and technologies used to create one or multiple unique logical and virtualized networks over a common multi-domain infrastructure.

The term “access network slice”, “radio access network slice”, or “RAN slice” at least in some examples refers to a part of a network slice that provides resources in a RAN to fulfill one or more application and/or service requirements (e.g., SLAs, and the like).

The term “network slice instance” at least in some examples refers to a set of Network Function instances and the required resources (e.g. compute, storage and to networking resources) which form a deployed network slice. Additionally or alternatively, the term “network slice instance” at least in some examples refers to a representation of a service view of a network slice.

The term “network instance” at least in some examples refers to information identifying a domain.

The term “service consumer” at least in some examples refers to an entity that consumes one or more services.

The term “service producer” at least in some examples refers to an entity that offers, serves, or otherwise provides one or more services.

The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “Virtualized Infrastructure Manager” or “VIM” at least in some examples refers to a functional block that is responsible for controlling and managing the NFVI compute, storage and network resources, usually within one operator's infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “cluster” at least in some examples refers to a set or grouping of entities as part of an Edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces).

The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “standard protocol” at least in some examples refers to a protocol whose specification is published and known to the public and is controlled by a standards body.

The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT, Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (pTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, theterm “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 v17.0.0 (2022-04-13) and/or 3GPP TS 38.331 v17.0.0 (2022-04-19) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022-04-13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.0.0 (2022-04-15) and/or 3GPP TS 38.323 v17.0.0 (2022-04-14)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.0.0 (2022-04-15) and 3GPP TS 36.322 v17.0.0 (2022-04-15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.0.0 (2022-04-14) and 3GPP TS 36.321 v17.0.0 (2022-04-19) (collectively referred to as “[TSMAC]”)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “radio technology” at least in some examples refers to technology for wireless transmission and/or reception of electromagnetic radiation for information transfer.

The term “radio access technology” or “RAT” at least in some examples refers to the technology used for the underlying physical connection to a radio based communication network.

The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.1 lad, IEEE 802.1lay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11 p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “V2X” at least in some examples refers to vehicle to vehicle (V2V), vehicle to infrastructure (V2I), infrastructure to vehicle (I2V), vehicle to network (V2N), and/or network to vehicle (N2V) communications and associated radio access technologies.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications.

The term “wide area network” or “WAN” at least in some examples refers to a network of devices that extends over a relatively large geographic area (e.g., a telecommunications network). Additionally or alternatively, the term “wide area network” or “WAN” at least in some examples refers to a computer network spanning regions, countries, or even an entire planet.

The term “backbone network”, “backbone”, or “core network” at least in some examples refers to a computer network which interconnects networks, providing a path for the exchange of information between different subnetworks such as LANs or WANs.

The term “interworking” at least in some examples refers to the use of interconnected stations in a network for the exchange of data, by means of protocols operating over one or more underlying data transmission paths.

The term “flow” at least in some examples refers to a sequence of data and/or data units (e.g., datagrams, packets, or the like) from a source entity/element to a destination entity/element. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some examples refer to a set of data and/or data units (e.g., datagrams, packets, or the like) passing an observation point in a network during a certain time interval. Additionally or alternatively, the term “flow” at least in some examples refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, and the like. For purposes of the present disclosure, the terms “traffic flow”, “data flow”, “dataflow”, “packet flow”, “network flow”, and/or “flow” may be used interchangeably even though these terms at least in some examples refers to to different concepts.

The term “dataflow” or “data flow” at least in some examples refers to the movement of data through a system including software elements, hardware elements, or a combination of both software and hardware elements. Additionally or alternatively, the term “dataflow” or “data flow” at least in some examples refers to a path taken by a set of data from an origination or source to destination that includes all nodes through which the set of data travels.

The term “stream” at least in some examples refers to a sequence of data elements made available over time. At least in some examples, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some examples refers to a manner of processing in which an object is not represented by a complete logical data structure of nodes occupying memory proportional to a size of that object, but are processed “on the fly” as a sequence of events.

The term “distributed computing” at least in some examples refers to computation resources that are geographically distributed within the vicinity of one or more localized networks' terminations.

The term “distributed computations” at least in some examples refers to a model in which components located on networked computers communicate and coordinate their actions by passing messages interacting with each other in order to achieve a common goal.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfil a goal using technology-agnostic protocols (e.g., HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols.

The term “network service” at least in some examples refers to a composition of Network Function(s) and/or Network Service(s), defined by its functional and behavioural specification.

The term “session” at least in some examples refers to a temporary and interactive information interchange between two or more communicating devices, two or more application instances, between a computer and user, and/or between any two or more entities or elements. Additionally or alternatively, the term “session” at least in some examples to refers to a connectivity service or other service that provides or enables the exchange of data between two entities or elements. The term “network session” at least in some examples refers to a session between two or more communicating devices over a network. The term “web session” at least in some examples refers to session between two or more communicating devices over the Internet or some other network. The term “session identifier,” “session ID,” or “session token” at least in some examples refers to a piece of data that is used in network communications to identify a session and/or a series of message exchanges.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS' at least in some examples refers to a description or measurement of the overall performance of a service (e.g., telephony and/or cellular service, network service, wireless communication/connectivity service, cloud computing service, and the like). In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS' at least in some examples refers to mechanisms that provide traffic-forwarding treatment based on flow-specific traffic classification. In some implementations, the term “Quality of Service” or “QoS” can be used interchangeably with the term “Class of Service” or “CoS”.

The term “Class of Service” or “CoS' at least in some examples refers to mechanisms that provide traffic-forwarding treatment based on non-flow-specific traffic classification. In some implementations, the term “Class of Service” or “CoS” can be used interchangeably with the term “Quality of Service” or “QoS”.

The term “QoS flow” at least in some examples refers to the finest granularity for QoS forwarding treatment in a network. The term “5G QoS flow” at least in some examples refers to the finest granularity for QoS forwarding treatment in a 5G System (5GS). Traffic mapped to the same QoS flow (or 5G QoS flow) receive the same forwarding treatment. The term “QoS Identifier” at least in some examples refers to a scalar that is used as a reference to a specific QoS forwarding behavior (e.g., packet loss rate, packet delay budget, and the like) to be provided to a QoS flow. This may be implemented in an access network by referencing node specific parameters that control the QoS forwarding treatment (e.g., scheduling weights, admission thresholds, queue management thresholds, link layer protocol configuration, and the like).

The term “reliability flow” at least in some examples refers to the finest granularity for reliability forwarding treatment in a network, where traffic mapped to the same reliability flow receive the same reliability treatment. Additionally or alternatively, the term “reliability flow” at least in some examples refers to the a reliability treatment assigned to packets of a dataflow

The term “reliability forwarding treatment” or “reliability treatment” refers to the manner in which packets belonging to a dataflow are handled to provide a certain level of reliability to that dataflow including, for example, a probability of success of packet delivery, QoS or Quality of Experience (QoE) over a period of time (or unit of time), admission control capabilities, a particular coding scheme, and/or coding rate for arrival data bursts.

The term “packet routing” or “routing” at least in some examples refers to a mechanism, technique, algorithm, method, and/or process of selecting a path for traffic in a network and/or between or across multiple networks. Additionally or alternatively, the term “packet routing” or “routing” at least in some examples refers to packet forwarding mechanisms, techniques, algorithms, methods, and/or decision making processes that direct(s) network/data packets from a source node toward a destination node through a set of intermediate nodes. Additionally or alternatively, the term “packet routing” or “routing” at least in some examples refers to a mechanism, technique, algorithm, method, and/or process of selecting a network path for traffic in a network and/or across multiple networks.

The term “path selection” at least in some examples refers to a mechanism, technique, algorithm, method, and/or process to select a network path over which one or more packets are to be routed. Additionally or alternatively, the term “path selection” at least in some examples refers to a mechanism, technique, or process for applying a routing metric to a set of routes or network paths to select and/or predict a most optimal route or network path among the set of routes/network paths. In some examples, the term “routing algorithm” refers to an algorithm that is used to perform path selection.

The term “routing protocol” at least in some examples refers to a mechanism, technique, algorithm, method, and/or process that specifies how routers and/or other network nodes communicate with each other to distribute information. Additionally or alternatively, the term “routing protocol” at least in some examples refers to mechanism, technique, method, and/or process to select routes between nodes in a computer network.

The term “routing metric” or “router metric” at least in some examples refers to a configuration value used by a router or other network node to make routing and/or forwarding decisions. In some examples, a “routing metric” or “router metric” can be a field in a routing table. Additionally or alternatively, a “routing metric” or “router metric” is computed by a routing algorithm, and can include various types of data/information and/or metrics such as, for example, bandwidth, delay, hop count, path cost, load, MTU size, reliability, communication costs, and/or any other measurements or metrics such as any of those discussed herein.

The term “interior gateway protocol” or “IGP” at least in some examples refers to a type of routing protocol used to exchange routing table information between gateways, routers, and/or other network nodes within an autonomous system, wherein the routing information can be used to route network layer packets (e.g., IP and/or the like). Examples of IGPs include distance-vector routing protocols (e.g., Routing Information Protocol (RIP), RIP version 2 (RIPv2), RIP next generation (RIPng), Interior Gateway Routing Protocol (IGRP), and the like), advanced distance-vector routing protocols (e.g., Enhanced Interior Gateway Routing Protocol (EIGRP)), and link-state routing protocols (e.g., Open Shortest Path First (OSPF), Intermediate System to Intermediate System (IS-IS), and the like).

The term “exterior gateway protocol” or “EGP” at least in some examples refers to a type of routing protocol used to exchange routing information between autonomous systems. In some examples, EGPs rely on IGPs to resolve routes within an autonomous system. Examples of EGPs include Exterior Gateway Protocol (EGP) and Border Gateway Protocol (BGP).

The term “forwarding treatment” at least in some examples refers to the precedence, preferences, and/or prioritization a packet belonging to a particular dataflow receives in relation to other traffic of other dataflows. Additionally or alternatively, the term “forwarding treatment” at least in some examples refers to one or more parameters, characteristics, and/or configurations to be applied to packets belonging to a dataflow when processing the packets for forwarding. Examples of such characteristics may include resource type (e.g., non-guaranteed bit rate (GBR), GBR, delay-critical GBR, and the like); priority level; class or classification; packet delay budget; packet error rate; averaging window; maximum data burst volume; minimum data burst volume; scheduling policy/weights; queue management policy; rate shaping policy; link layer protocol and/or RLC configuration; admission thresholds; and the like. In some implementations, the term “forwarding treatment” may be referred to as “Per-Hop Behavior” or “PHB”.

The term “routing table”, “Routing Information Base”, or “RIB” at least in some examples refers to a table or other data structure in a router or other network node that lists the routes to one or more network nodes (e.g., destination nodes), and may include metrics (e.g., distances and/or the like) associated with respective routes. In some examples, a routing table contains information about the topology of the network immediately around a network node.

The term “forwarding table”, “Forwarding Information Base”, or “FIB” at least in some examples refers to a table or other data structure that indicates where a network node (or network interface circuitry) should forward a packet. Additionally or alternatively, the term “forwarding table”, “Forwarding Information Base”, or “FIB” at least in some examples refers to a dynamic table or other data structure that maps network addresses (e.g., MAC addresses and/or the like) to ports. Additionally or alternatively, the term “forwarding table”, “Forwarding Information Base”, or “FIB” at least in some examples refers to a table containing the information necessary to forward datagrams (e.g., IP datagrams and/or the like). In some examples, at minimum, an FIB contains an interface identifier and next hop information for each reachable destination network prefix. In some examples, the components within a forwarding information base entry include a network prefix, a router port identifier, and next hop information.

The term “time to live” (or “TTL”) or “hop limit” at least in some examples refers to a mechanism which limits the lifespan or lifetime of data in a computer or network. TTL may be implemented as a counter or timestamp attached to or embedded in the data. Once the prescribed event count or timespan has elapsed, data is discarded or revalidated.

The term “queue” at least in some examples refers to a collection of entities (e.g., data, objects, events, and the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head″ or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “queue management” at least in some examples refers to a system, mechanism, policy, process, algorithm, or technique used to control one or more queues. The term “Active Queue Management” or “AQM” at least in some examples refers to a system, mechanism, policy, process, algorithm, or technique of dropping packets in a queue or buffer before the queue or buffer becomes full. The term “AQM entity” as used herein may refer to a network scheduler, a convergence layer entity, a network appliance, network function, and/or some other like entity that performs/executes AQM tasks.

The term “queue management technique” at least in some examples refers to a particular queue management system, mechanism, policy, process, and/or algorithm, which may include a “drop policy”. The term “active queue management technique” or “AQM technique” at least in some examples refers to a particular AQM system, mechanism, policy, process, and/or algorithm.

The term “drop policy” at least in some examples refers to a set of guidelines or rules used by a queue management technique or ARM technique to determine when to discard, remove, delete, or otherwise drop data or packets from a queue or buffer or data or packets arriving for storage in a queue or buffer.

The term “data buffer” or “buffer” at least in some examples refers to a region of a physical or virtual memory used to temporarily store data, for example, when data is being to moved from one storage location or memory space to another storage location or memory space, data being moved between processes within a computer, allowing for timing corrections made to a data stream, reordering received data packets, delaying the transmission of data packets, and the like. At least in some examples, a “data buffer” or “buffer” may implement a queue.

The term “traffic shaping” at least in some examples refers to a bandwidth management technique that manages data transmission to comply with a desired traffic profile or class of service. Traffic shaping ensures sufficient network bandwidth for time-sensitive, critical applications using policy rules, data classification, queuing, QoS, and other techniques. The term “throttling” at least in some examples refers to the regulation of flows into or out of a network, or into or out of a specific device or element.

The term “access traffic steering” or “traffic steering” at least in some examples refers to a procedure that selects an access network for a new data flow and transfers the traffic of one or more data flows over the selected access network. Access traffic steering is applicable between one 3GPP access and one non-3GPP access.

The term “access traffic switching” or “traffic switching” at least in some examples refers to a procedure that moves some or all traffic of an ongoing data flow from at least one access network to at least one other access network in a way that maintains the continuity of the data flow.

The term “access traffic splitting” or “traffic splitting” at least in some examples refers to a procedure that splits the traffic of at least one data flow across multiple access networks. When traffic splitting is applied to a data flow, some traffic of the data flow is transferred via at least one access channel, link, or path, and some other traffic of the same data flow is transferred via another access channel, link, or path.

The term “network address” at least in some examples refers to an identifier for a node or host in a computer network, and may be a unique identifier across a network and/or may be unique to a locally administered portion of the network. Examples of network addresses include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.0.0 (2022-04-13) (“[TS38300]”)), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (Ipv4), IP version 6 (IPv6), and the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof.

The term “application identifier”, “application ID”, or “app ID” at least in some examples refers to an identifier that can be mapped to a specific application or application instance; in the context of 3GPP 5G/NR systems, an “application identifier” at least in some examples refers to to an identifier that can be mapped to a specific application traffic detection rule. The term “endpoint address” at least in some examples refers to an address used to determine the host/authority part of a target URI, where the target URI is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service.

The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver.

The term “delay” at least in some examples refers to a time interval between two events. Additionally or alternatively, the term “delay” at least in some examples refers to a time interval between the propagation of a signal and its reception.

The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized.

The term “processing delay” at least in some examples refers to an amount of time taken to process a packet in a network node.

The term “transmission delay” at least in some examples refers to an amount of time needed (or necessary) to push a packet (or all bits of a packet) into a transmission medium.

The term “propagation delay” at least in some examples refers to amount of time it takes a signal's header to travel from a sender to a receiver.

The term “network delay” at least in some examples refers to the delay of an a data unit within a network (e.g., an IP packet within an IP network).

The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted.

The term “delay bound″ at least in some examples refers to a predetermined or configured amount of acceptable delay. The term “per-packet delay bound″ at least in some examples refers to a predetermined or configured amount of acceptable packet delay where packets that are not processed and/or transmitted within the delay bound are considered to be delivery failures and are discarded or dropped.

The term “packet drop rate” at least in some examples refers to a share of packets that were not sent to the target due to high traffic load or traffic management and should be seen as a part of the packet loss rate.

The term “packet loss rate” at least in some examples refers to a share of packets that could not be received by the target, including packets droped, packets lost in transmission and packets received in wrong format.

The term “latency” at least in some examples refers to the amount of time it takes to transfer a first/initial data unit in a data burst from one point to another.

The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel.

The term “goodput” at least in some examples refers to a number of useful information bits delivered by the network to a certain destination per unit of time.

The term “performance indicator” at least in some examples refers to performance data aggregated over a group of network functions (NFs), which is derived from performance measurements collected at the NFs that belong to the group, according to the aggregation method identified in a Performance Indicator definition.

The term “application” at least in some examples refers to to a computer program designed to carry out a specific task other than one relating to the operation of the computer itself. Additionally or alternatively, term “application” at least in some examples refers to to a complete and deployable package, environment to achieve a certain function in an operational environment.

The term “process” at least in some examples refers to an instance of a computer program that is being executed by one or more threads. In some implementations, a process may be made up of multiple threads of execution that execute instructions concurrently.

The term “algorithm” at least in some examples refers to an unambiguous specification of how to solve a problem or a class of problems by performing calculations, input/output operations, data processing, automated reasoning tasks, and/or the like.

The term “analytics” at least in some examples refers to the discovery, interpretation, and communication of meaningful patterns in data.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “data pipeline” or “pipeline” at least in some examples refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The terms “instantiate,” “instantiation,” and the like at least in some examples refers to the creation of an instance. An “instance” also at least in some examples refers to a concrete occurrence of an object, which may occur, for example, during execution of program code.

The term “operating system” or “OS” at least in some examples refers to system software that manages hardware resources, software resources, and provides common services for computer programs. The term “kernel” at least in some examples refers to a portion of OS code that is resident in memory and facilitates interactions between hardware and software components.

The term “packet processor” at least in some examples refers to software and/or hardware element(s) that transform a stream of input packets into output packets (or transforms a stream of input data into output data); examples of the transformations include adding, removing, and modifying fields in a packet header, trailer, and/or payload.

The term “software agent” at least in some examples refers to a computer program that acts for a user or other program in a relationship of agency.

The term “user” at least in some examples refers to an abstract representation of any entity issuing commands, requests, and/or data to a compute node or system, and/or otherwise consumes or uses services.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), Type Length Value (TLV), and/or other like data structures.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information.

The term “type length value”, “tag length value”, or “TLV” at least in some examples refers to an encoding scheme used for informational elements in a protocol; TLVs are sometimes used to encode additional or optional information elements in a protocol. In some examples, a TLV-encoded data stream contains code related to the type of value, the length of the value, and the value itself. In some examples, the type in a TLV includes a binary and/or alphanumeric code, which indicates the kind of field that this part of the message represents; the length in a TLV includes a size of the value field (e.g., in bytes); and the value in a TLV includes a variable-sized series of bytes which contains data for this part of the message.

The term “field″ at least in some examples refers to individual contents of an information element, or a data element that contains content. The term “data frame”, “data field″, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more is representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to to a markup construct including a name-value pair that exists within a start tag or empty element tag. Attributes contain data related to its element and/or control the element's behavior.

The term “reference” at least in some examples refers to data useable to locate other data and may be implemented a variety of ways (e.g., a pointer, an index, a handle, a key, an identifier, a hyperlink, and/or the like).

The term “translation” at least in some examples refers to the process of converting or otherwise changing data from a first form, shape, configuration, structure, arrangement, embodiment, description, or the like into a second form, shape, configuration, structure, arrangement, embodiment, description, or the like; at least in some examples there may be two different types of translation: transcoding and transformation.

The term “transcoding” at least in some examples refers to taking information/data in one format (e.g., a packed binary format) and translating the same information/data into another format in the same sequence. Additionally or alternatively, the term “transcoding” at least in some examples refers to taking the same information, in the same sequence, and packaging the information (e.g., bits or bytes) differently.

The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

The term “stream” or “streaming” refers to a manner of processing in which an object is not represented by a complete logical data structure of nodes occupying memory proportional to a size of that object, but are processed “on the fly” as a sequence of events.

The term “database” at least in some examples refers to an organized collection of data stored and accessed electronically. Databases at least in some examples can be implemented according to a variety of different database models, such as relational, non-relational (also referred to as “schema-less” and “NoSQL”), graph, columnar (also referred to as extensible record), object, tabular, tuple store, and multi-model. Examples of non-relational database models include key-value store and document store (also referred to as document-oriented as they store document-oriented information, which is also known as semi-structured data). A database may comprise one or more database objects that are managed by a database management system (DBMS). The term “database object” at least in some examples refers to any representation of information that is in the form of an object, attribute-value pair (AVP), key-value pair (KVP), tuple, and the like, and may include variables, data structures, functions, methods, classes, database records, database fields, database entities, associations between data and/or database entities (also referred to as a “relation”), blocks in block chain implementations, and links between blocks in block chain implementations. Furthermore, a database object may include a number of records, and each record may include a set of fields. A database object can be unstructured or have a structure defined by a DBMS (a standard database object) and/or defined by a user (a custom database object). In some implementations, a record may take different forms based on the database model being used and/or the specific database object to which it belongs. For example, a record may be: 1) a row in a table of a relational database; 2) a JavaScript Object Notation (JSON) object; 3) an Extensible Markup Language (XML) document; 4) a KVP; and the like.

The term “cryptographic mechanism” at least in some examples refers to any cryptographic protocol and/or cryptographic algorithm. Additionally or alternatively, the term “cryptographic protocol” at least in some examples refers to a sequence of steps to precisely specifying the actions required of two or more entities to achieve specific security objectives (e.g., cryptographic protocol for key agreement). Additionally or alternatively, the term “cryptographic algorithm” at least in some examples refers to an algorithm specifying the steps followed by a single entity to achieve specific security objectives (e.g., cryptographic algorithm for symmetric key encryption).

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

Although many of the previous examples are provided with use of specific cellular/mobile network terminology, including with the use of 4G/5G 3GPP network components (or expected terahertz-based 6G/6G+technologies), it will be understood these examples may be applied to many other deployments of wide area and local wireless networks, as well as the integration of wired networks (including optical networks and associated fibers, transceivers, and/or the like). Furthermore, various standards (e.g, 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-41. (canceled)

42. A compute node, comprising:
memory circuitry to store a traffic engineering (TE) policy; and
processor circuitry connected to the memory circuitry, wherein the processor circuitry is to:
determine a first subset of links including a first number of links in a set of links to be designated as TE links between a first subset of network nodes in a set of network nodes and a second subset of network nodes in the set of network nodes according to a set of conditions;
determine a second subset of links including a second number links between the first subset of network nodes and the second subset of network nodes, wherein the second subset of links are non-TE links;
determine a third subset of links including a third number links between the second subset of network nodes and a set of servers;
cause advertisement of the first subset of links to the set of network nodes;
cause configuration of the TE policy in the set of network nodes, wherein the TE policy defines when data packets are to be routed over one or more paths including the TE links according to a preferred path routing (PPR) protocol; and
after the configuration, cause signaling to the set of network nodes to begin routing data packets according to the configured TE policy.

43. The compute node of claim 42, wherein:
the set of network nodes are part of a network topology,
the network topology includes a leaf layer and a spine layer, wherein the first subset of network nodes belongs to the spine layer and the second subset of network nodes belongs to the leaf layer,
the network topology is shared among best effort traffic flows and high priority traffic flows, and
the TE policy defines the best effort traffic flows to be routed over one or more paths including links in the second subset of links and defines the high priority traffic flows to be routed over TE paths including TE links in the first subset of links.

44. The compute node of claim 42, wherein the set of conditions includes one or more of:
a difference between the second number and the first number is at least a threshold number of links;
a difference between the second number and the first number being greater than or equal to the third number a difference between the second number and the first number same or more than a downstream-port-bandwidth threshold;
metrics of links in the first subset of links being higher than metrics of links in the second subset of links;
the first number being same as a number of switches in the network topology;
an over-subscription ratio of the third number to the difference between the second number and the first number; or
a total capacity of the first subset of links being managed centrally for traffic steering into one or more network nodes in the set of spine nodes, the set of leaf nodes, or one or more network switches in the network topology.

45. The compute node of claim 42, wherein the set of network nodes includes a combination of one or more network elements, and wherein the network elements include one or more of routers, switches, hubs, gateways, access points, radio access network nodes, firewall appliances, network controllers, and fabric controllers.

46. The compute node of claim 42, wherein the processor circuitry is to:
add or insert a path description element (PDE) to one or more data packets belonging to the traffic flow to implement the TE for the traffic flow;
add or insert a Preferred Path Routing (PPR) identifier (ID) into the one or more data packets belonging to the traffic flow to implement the TE for the traffic flow; and
add or insert a PPR-PDE path advertisement into the one or more data packets belonging to the traffic flow to implement the TE for the traffic flow.

47. The compute node of claim 46, wherein the PPR-PDE includes a set (S) flag that indicates that a current PDE is a set PDE and can be used for backup purposes, a link protection (LP) flag that indicates a link protecting alternative path in a path description of the PDE, and a node protection (NP) flag that indicates a node protecting alternative path in a path description of the PDE, and wherein the processor circuitry is to:
compute a next hop (NH) for a PPR-ID based on current PPR when the S flag is set.

48. The compute node of claim 47, wherein the link protecting alternative path and the node protecting alternative path is through a same or different subset of network nodes of the set of network nodes.

49. The compute node of claim 47, wherein the processor circuitry is to:
extract a subsequent PDE in the set PDE;
validate the subsequent PDE; and
process an alternative NH for the subsequent PDE.

50. The compute node of claim 49, wherein the processor circuitry is to:
extract one or both of LP information and NP information from the set PDE; and
insert the extracted LP information and NP information in the alternative NH.

51. The compute node of claim 50, wherein the processor circuitry is to:
form an NH entry for the PPR-ID route, the computed NH, and the alternative NH, wherein the NH entry is a double barrel NH entry in the routing table or the forwarding table; and
add or insert the NH entry to a routing table or a forwarding table.

52. The compute node of claim 42, wherein, to cause advertisement, the processor circuitry is to:
increase metric values for respective links of the first subset of links based on a set of required resources, a set of traffic characteristics, and a set of service level parameters based on capabilities of each network node in the set of network nodes and links along a preferred path.

53. The compute node of claim 42, wherein the network topology is a CLOS network topology or a leaf-and-spine network topology, and the compute node is a PPR control plane entity, a Segment Routing IPv6 (SRv6) data plane entity, a network switch, a cloud compute node, an edge compute node, a radio access network (RAN) node, or a compute node that operates one or more network functions in a cellular core network.

54. A non-transitory computer readable medium (NTCRM) comprising instructions for operating a compute node, wherein execution of the instructions by one or more processors is to cause the compute node to:
determine a first subset of links including a first number of links in a set of links to be designated as traffic engineering (TE) links between a set of spine nodes and a set of leaf nodes according to a set of conditions, wherein the set of spine nodes are network nodes in a spine layer of a network topology and the set of leaf nodes are network nodes in a leaf layer of the network topology;
determine a second subset of links including a second number links between the set of spine nodes and the set of leaf nodes, wherein the second subset of links are non-TE links;
determine a third subset of links including a third number links between the set of leafnodes and a set of servers;
cause advertisement of the first subset of links to the set of spine nodes and the set of leaf nodes;
cause configuration of a TE policy in the set of spine nodes and the set of leaf nodes, wherein the TE policy defines when data packets are to be routed over one or more paths including the TE links according to a preferred path routing (PPR) protocol; and
after the configuration, cause signaling to the set of spine nodes and the set of leaf nodes to begin routing data packets according to the TE policy.

55. The NTCRM of claim 54, wherein:
the network topology is shared among best effort traffic flows and high priority traffic flows,
the TE policy defines the best effort traffic flows to be routed over one or more paths including links in the second subset of links and defines the high priority traffic flows to be routed over TE paths including TE links in the first subset of links, and the set of conditions includes one or more of:
a difference between the second number and the first number is at least a threshold number of links;
a difference between the second number and the first number being greater than or equal to the third number a difference between the second number and the first number is same or more than a downstream-port-bandwidth threshold;
metrics of links in the first subset of links being higher than metrics of links in the second subset of links;
the first number being same as a number of switches in the network topology;
an over-subscription ratio of the third number to the difference between the second number and the first number; or
a total capacity of the first subset of links being managed centrally for traffic steering into one or more network nodes in the set of spine nodes, the set of leaf nodes, or one or more network switches in the network topology.

56. The NTCRM of claim 54, wherein execution of the instructions is to cause the compute node to:
add or insert a path description element (PDE) to one or more data packets belonging to the traffic flow to implement the TE for the traffic flow;
add or insert a Preferred Path Routing (PPR) identifier (ID) into the one or more data packets belonging to the traffic flow to implement the TE for the traffic flow; and
add or insert a PPR-PDE path advertisement into the one or more data packets belonging to the traffic flow to implement the TE for the traffic flow.

57. The NTCRM of claim 56, wherein the PPR-PDE includes a set (S) flag that indicates that a current PDE is a set PDE and can be used for backup purposes, a link protection (LP) flag that indicates a link protecting alternative path in a path description of the PDE, and a node protection (NP) flag that indicates a node protecting alternative path in a path description of the PDE, and wherein execution of the instructions is to cause the compute node to:
compute a next hop (NH) for a PPR-ID based on current PPR when the S flag is set.

58. The NTCRM of claim 57, wherein execution of the instructions is to cause the compute node to:
extract a subsequent PDE in the set PDE;
validate the subsequent PDE; and
process an alternative NH for the subsequent PDE.

59. The NTCRM of claim 58, wherein execution of the instructions is to cause the compute node to:
extract one or both of LP information and NP information from the set PDE; and
insert the extracted LP information and NP information in the alternative NH.

60. The NTCRM of claim 59, wherein execution of the instructions is to cause the compute node to:
form an NH entry for the PPR-ID route, the computed NH, and the alternative NH, wherein the NH entry is a double barrel NH entry in the routing table or the forwarding table; and
add or insert the NH entry to a routing table or a forwarding table.

61. The NTCRM of claim 54, wherein, to cause advertisement, execution of the instructions is to cause the compute node to:
increase metric values for respective links of the first subset of links based on a set of required resources, a set of traffic characteristics, and a set of service level parameters based on capabilities of the set of spine nodes, capabilities of the set of leaf nodes, and links along a preferred path.
